(19) United States
(12) Patent Application Publication
(10) Pub. No.: US 2004/0267676 A1
(43) Pub. Date: Dec. 30, 2004

(54) Method and apparatus for optimizing product distribution strategies and product mixes to increase profitability in complex computer aided pricing of products and services

(76) Inventors: Yan Feng, Los Altos, CA (US); Karen Hsu, Hayward, CA (US); Nandhakumar Palanisamy, San Jose, CA (US); Surekha Ghantasala, San Jose, CA (US); Mangal Sain, New Delhi (IN)

Correspondence Address: CENTRAL COAST PATENT AGENCY, PO BOX 187, AROMAS, CA, 95004, US

(21) Appl. No.: 10/731,541

(22) Filed: Dec. 8, 2003

Related U.S. Application Data
(63) Continuation-in-part of application No. 10/611,471, filed on Jun. 30, 2003.

(51) Int. Cl. G06F 17/60

(52) U.S. Cl. 705/400

(57) ABSTRACT

A software application for creating, monitoring, and optimizing deals calculated by an automated pricing system for calculating pricing for items and item orders has a graphical user interface for accessing and directing the application; a set of advisory factors having rules and attributes associated thereto; a set of related calculating sequences for calculating results using at least one of the advisory factors in sequence; and at least one ranking factor for optimizing results returned by the set of calculating sequences. A user operating through the graphical user interface initiates a set of calculation sequences related by factor to one or more possible options associated with a deal, the calculation sequences cooperating to return a list of data structures for user consideration, the list of data structures ranked according to one or more goal-based attributes.

### CROSS-REFERENCE TO RELATED DOCUMENTS

The present invention is a continuation in part (CIP) of a U.S. patent application Ser. No. 10,611,471 entitled “Improved Method for Complex Computer Aided Pricing of Products and Services” filed on Jun. 30, 2003 and included herein at least by reference.

### FIELD OF THE INVENTION

The present invention is in the field of computer-assisted pricing of goods and services and pertains particularly to improved methods and apparatus for creating and managing deals aided by automated factor and command modules including optimization of enterprise revenue goals through selective product distribution management and product up sell, cross-sell, and substitution options.

### BACKGROUND OF THE INVENTION

The field of computer-aided pricing generally involves inputting a number of variables into a database and then retrieving those variables to apply in one or more pricing schemes provided as calculative sequences, to eventually arrive at a final price for a product or service offered to particular clients of an enterprise. Computer-aided pricing applications have largely replaced human-calculated pricing as a preferred method for establishing current pricing for clients of larger enterprises that offer a variety of products and/or services to a variety of client types.

The need for computerizing pricing sequences has long been established as a preferred method, especially for larger enterprises. Pricing discounts of various sorts, rebates, volume purchasing, contract agreements, special price rollbacks, interest, tax rates, currency conversions, bundled products and the like comprise many of the complexities associated with creative pricing in today's business environment.

With the advent of broad-based client accessibility to self-service portals, typically provided through wide-area-networks like the well-known Internet, pricing systems have been the enabling factor for survival of many organizations. Without these systems in place, many of these organizations would lose considerable time and resources attempting to provide all of their pricing structures in an accurate and timely manner.

While there are pricing systems in the prior art that provide some automated pricing calculation for specific clients, the space required to store data tables containing all of the required factors and variables is exorbitant. Likewise, the time required to access the various tables of data in order to retrieve the “correct” tables for processing pricing for a particular client, while faster and more accurate than human effort, is still very time consuming and process intensive.

The inventor knows of a prior-art system that relieves some of the burden of data storage and data lookup processes by providing a hierarchal tree-method for calculating a correct pricing for a specific client or purchasing organization. This prior-art system is referenced herein as U.S. Pat. No. 5,878,400 issued on Mar. 2, 1999 to Thomas J. Carter; III, hereinafter referred to simply as Carter.

The system of Carter organizes various pricing tables and price adjustment tables for various products and purchasing entities based on which purchasing entity is purchasing which specific product. The invention utilizes de-normalized numbers in tables to relate the requesting purchaser to the product desired. The different types of purchasers and the various types of products offered are organized into hierarchical groups represented by data tables. Working by individual hierarchical levels, of which there may be many, specific price adjustments can be specified for each created level of the organizational groups and for each created level of the product groups.

The system determines final pricing for a purchasing entity and product desired by retrieving the listed price adjustments for that particular purchasing entity as well as all of the listed price adjustments for the listed groups above the particular purchasing entity in the groups hierarchy. Likewise, the price adjustments for a particular listed product are determined by retrieving the price adjustments for that listed particular product as well as the price adjustments for all of the product groups listed above the particular product in the product-group hierarchy.

The system then must sort through all of the retrieved pricing information to isolate the particular pricing adjustments that fit the selected purchaser and product. The final pricing adjustments aggregated are then applied in the form of a pricing sequence to arrive at a final price at which a particular product can be sold to a particular purchasing entity.

While the system does limit the need for much duplication of data over multiple product and purchaser-specific data tables, it still requires much processing in order to drill down the hierarchal price-adjustment structure until the pricing adjustments that match the given scenario are finally identified and isolated to use in calculating the final pricing. An enterprise with a large number of different products, client types, and pricing strategies would find the system of Carter quite process-intensive. Furthermore, the system of Carter fails to provide a solution for creative pricing strategies such as tiered pricing, product or service bundling, or other creative pricing structures.

With the advent of object orientation, including model representation of real data, it has occurred to the inventors that far more complex pricing strategies for varied clients can be applied in a much less process-intensive manner than in the prior-art systems.

An automated pricing system for calculating pricing for items and item orders is known to the inventor and referenced herein under the cross-reference to related documents section. The system has, a sever node connected to a data network for serving pricing information; a pricing application running on the server node for calculating the pricing information served; and a data repository accessible to the server node for storing at least one pricing data model and rules for manipulating the model. The server node receives requests for pricing, accesses rules created for pricing factors used in at least one pricing sequence to price an item or items of the request and uses the pricing application to calculate the correct pricing results including order sub totals and order total amounts for the request based on sorting and/or conflict resolution of the rules accessed for each factor.

The system described above is flexible in that it serves a wide variety of order scenarios such as single item orders, bundle orders, tiered pricing orders, contract orders and so on using a pricing engine that calculates pricing using item pricing and order pricing sequences, pricing factors and factor rules. The system referenced above essentially applies the correct pricing information to products and services or a combination thereof according to a fairly wide range customer, channel, and product categories. Moreover, the system can calculate and report profit margin results per item and per order.

One aspect of the above-described system involves an ability to resolve the correct pricing for in-place contact orders wherein the current pricing parameters, including existing discounts and perhaps cost parameters for the order items are presently different than what existed during a period when a contract was initiated.

Contract pricing relates to an on-going sequence of transactions occurring, typically on a schedule over a pre-determined or, sometimes an open-ended period. In many cases the cost of providing certain products can change, sometimes dramatically, over a period of time. For example, provision of memory devices or other semiconductor-bearing products generally costs more at introduction of the product. The cost of providing the memory devices tends to decrease over time. However, with competition increases, the extractable profit margin also tends to decrease.

Computer products and other electronics devices have similar evolutionary changes with respect to cost and revenue producing factors. Likewise, conditions such as supply availability, material availability, existence of competing products, trends of consumers, and other factors can play roles over time in efficacy of determined prices. Pricing can also be affected seasonally for many products wherein cost rises and drops for providing a same product during certain periods of a year, for example, certain months of the year.

Volatility inherent to the costs of providing certain products offered over a long-term contract at a static price can cause some problems for a provider depending on the factors at work. For example, if a client orders 300 memory devices to be delivered on a schedule of 2 per month for 150 months, and cost of provision of those devices for whatever reason rises significantly during that portion of the contract period, slipping below projected goals. In some cases a roller coaster effect can occur wherein revenue goals for product shipped can rise above and dip below a planned threshold that may also be affected by in-place discounts for certain customers, product categories, customer channels, and the like.

It has occurred to the inventor that management of contracts with multiple scheduled deliveries over time can be enhanced to automatically provide optimized distribution strategies so that margin is increased or remains stable over the total life of the contract in some cases and that any losses (if unavoidable) of revenue are minimized over the life of the contract. It has also occurred to the inventor that revenue may be optimized or at least maintained at or above planned thresholds through automated calculation and results comparison of test sales scenarios related to customer order requests before finalizing sales transactions.

There is also a need for further flexibility for sales administrators in quoting products and services to potential clients. For a complex order submitted to a company for example that has multiple products and services to offer, it is desired that a sales administrator or sales agent have intimate knowledge of both competitors prices and offered discounts related to functionally common products and services. Moreover, knowledge of company products and services that might be offered to replace functionally common products and services ordered by a customer wherein such product and/or service replacement might increase revenue, profit margin, or enhance customer satisfaction, for example, faster delivery, is desired.

A drawback to maintaining this type of product and service knowledge on the part of a sales representative working in a complex sales environment is that pricing attributes, discounts, product availability, competitor pricing, and other factors are constantly evolving and changing requiring exhaustive and time consuming computer search queries and validation routines to facilitate optimum sales activity and expediency to the client.

Therefore, what is further needed in the art is a method and system including apparatus for managing sales transactions and constructing presentation-ready deals aided by an automated pricing engine such that current product and service knowledge including discounts, competitor pricing, and other factors are rendered as calculable variables which can be used to produce both pricing results and optimization suggestions particular to given order or quote scenarios. A system such as this could be used to maximize revenue and provide suggestions for increasing profit or minimizing costs related to differing order scenarios. The system could provide optimum product distribution strategies over multiple shipping periods; alert to product up-sell and cross-sell opportunities and would generally help to maintain revenue efficacy for a broad range of transaction types involving a broad range of customer and product categories.

### SUMMARY OF THE INVENTION

In an automated pricing system for calculating pricing for items and item orders, the pricing system having a server node for serving pricing information, a pricing application for calculating the pricing information served, and a data repository for storing at least one pricing data model and rules for manipulating the model, a software application is provided for creating, monitoring, and optimizing deals. The software application has a graphical user interface for accessing and directing the application; a set of advisory factors having rules and attributes associated thereto; a set of related calculating sequences for calculating results using at least one of the advisory factors in sequence; and at least one ranking factor for optimizing results returned by the set of calculating sequences.

In a preferred aspect a user operating through the graphical user interface initiates a set of calculation sequences related by factor to one or more possible options associated with a deal, the calculation sequences cooperating to return a list of data structures for user consideration, the list of data structures ranked according to one or more goal-based attributes. Also in a preferred aspect the software interface is accessible through the Internet network using a Web-browsing application.

In all aspects each advisory factor within the set of advisory factors emulates a possible option for optimizing a deal. In a preferred aspect the set of advisory factors include an up-sell factor, a cross-sell factor, a competitor factor, and a maximize factor. The calculation sequences include at minimum an item sequence and an order sequence, the item sequence containing an advisory factor and the order sequence containing the at least one ranking factor, which performs the ranking according to a goal-based attribute.

In an alternate aspect of the present invention the set of calculation sequences include at least one advisory sequence that is not an item or an order sequence. In one aspect the goal-based attributes for ranking include revenue-based goals, profit margin-based goals, cost-based goals, inventory-based goals, budget-based goals and competitive-based goals. In all aspects the at least one ranking factor can be set to optimize or minimize according to a goal-based attribute.

In preferred aspects the returned list of data structures represents possible up-sell product substitution options ranked to maximize revenue or margin for an enterprise. In these aspects the returned list of data structures include complete item and order pricing information for each substitution option.

In one aspect the ranking factor is used to distribute product quantities over multiple shipping periods of a contract order according to a goal-based attribute. In one aspect of the invention the returned list of data structures represents possible cross-sell product addition options ranked to maximize revenue or margin for the enterprise. In another aspect the returned list of data structures represents corresponding competitor products and pricing along side of enterprise products and pricing, the data structures ranked according to most competitive products.

In yet another aspect the returned list of data structures is a product distribution strategy over multiple shipment periods of a contract the distribution strategy ranked by maximizing revenue, margin, or by minimizing cost of provision of the products for each period.

In a preferred aspect of the invention the graphical user interface enables displayed side-by-side value comparison of two or more scenarios resulting from one or more factor sequences executed to return data structures, the data structures optionally selected to create the scenarios being compared. In this aspect the graphical user interface supports request and generation of graphics of the form of graph and chart representations of various compared scenarios.

In one aspect of the invention deals are contracts with multi-shipping periods, which are monitored for one of competitor pricing parameters per shipping period per item having competitor pricing data or monitored for product distribution optimization per item per shipping period, the product distribution strategy ranked according to a goal-based attribute.

According to another aspect of the present invention a method for optimizing the parameters of a deal scenario is provided for use in an automated pricing system for calculating pricing for items and item orders, the pricing system having a server node for serving pricing information, a pricing application for calculating the pricing information served, and a software application for creating monitoring and optimizing deals.

The method includes the steps of (a) through a graphical user interface, highlighting the deal scenario; (b) through the same interface, activating a deal optimization option from a menu of options provided for the purpose; (c) executing an advisory factor command as a result of the selection of step (b); (d) using the correct item and order sequences, calculating at least one separate scenario according to the factor rules; and (e) displaying the at least one calculated scenario in the graphical user interface for consideration of further options.

In a preferred aspect in step (a) the deal scenario has at least the items of the scenario, the prices of the items, the quantities of the items, and the order totals of the scenario. Also in a preferred aspect in step (a) the graphical user interface is accessible through the Internet network using a Web-browsing application. In one aspect in step (a) the deal scenario is one of a one-time order or a contract order with complete pricing parameters for item, and order totals including discounts.

In a preferred aspect of the method in step (b) the deal optimization options include one of optimizing product distribution, substituting up-sell products, adding cross-sell products, finding bundle products, and finding competitor products and pricing. Also in a preferred aspect in step (c) the advisory factor is one of an up-sell factor, a cross-sell factor, a competitor factor, or a maximize factor. In all aspects of the method in step (c) the advisory factor is contained in the associated item sequence and returns results that are ranked by a ranking factor used in the associated order sequence.

In an alternate aspect of the method in step (c) the advisory factor is used in it's own advisory sequence containing only advisory factors. In a preferred aspect in step (d) the separate scenario is the highest ranked of more than one scenario returned from calculation.

In all aspects of the method in step (d) the correct item and order sequences are defined for item as the one containing the advisory factor and for order as the one containing the ranking factor. In one aspect of the method in step (c) the advisory factor is up-sell and in step (d) the calculated scenarios represent different scenarios of up-sell possibilities. In another aspect of the method in step (c) the advisory factor is cross- sell and in step (d) the calculated scenarios represent different scenarios of cross-sell possibilities. In yet another aspect in step (c) the advisory factor is competitor and in step (d) the calculated scenarios represent the original scenario using applicable competitor products and pricing. In still another variation of the method in step (c) the advisory factor is maximize and in step (d) the calculated scenarios represent product distribution strategies over multiple shipping periods.

In all aspects in step (d) a ranking factor is included in the order sequence, the ranking factor for ranking results according to a specified goal-based parameter. Also in all aspects in step (e) further options include product editing, discount editing, final editing and save scenario.

### BRIEF DESCRIPTION OF THE DRAWING FIGURES

FIG. 1 is an architectural over view of the pricing system of the present invention.

FIG. 2 is a block diagram illustrating a pricing model according to an embodiment of the present invention.

FIG. 3 is a block diagram illustrating the function of price sequencing according to an embodiment of the present invention.

FIG. 4 is a block diagram illustrating relationship between the pricing engine and a rules base according to an embodiment of the present invention.

FIG. 5 is a process flow chart illustrating steps for building a pricing model according to an embodiment of the present invention.

FIG. 6 is a process flow chart illustrating steps for applying rules to factors before calculating prices according to an embodiment of the invention.

FIG. 7 is an elevation view of a main user-interface screen for practicing the present invention.

FIG. 8 is an elevation view of a sub-interface for creating a new factor according to an embodiment of the present invention invoked from the main interface of FIG. 7.

FIG. 9 is a process flow diagram illustrating basic steps for setting up scope pricing according to an embodiment of the present invention.

FIG. 10 is a screen shot of a bundle creation and editing interface accessible through main interface 700 of FIG. 7.

FIG. 11 is a process flow chart illustrating steps for qualifying bundle detection rules for a bundle detection factor.

FIG. 12 is a process flow chart illustrating steps for qualifying bundle adjustment rules for a bundle adjustment factor.

FIG. 13 is a process flow diagram illustrating basic steps for setting up a tiered pricing scenario.

FIG. 14 is an architectural overview of a communications transaction environment practicing deal management according to an embodiment of the present invention.

FIG. 15 is a plan view of a browser interface displaying a deal management login page according to one embodiment of the present invention.

FIG. 16 is a plan view of a start page displayed after logging in to the login page of FIG. 15.

FIG. 17 is a plan view of a deals view page accesses by selecting the deals option in FIG. 16.

FIG. 18 is a plan view of a browser screen illustrating a deals pending page and displayed by selecting create deal in FIG. 17.

FIG. 19 is a plan view of a screen displaying an account view as a result of interaction with option 1805 of FIG. 18.

FIG. 20 is a plan view of a screen illustrating a scenario list of deal scenarios.

FIG. 21 is a plan view of a screen 2100 illustrating a detailed account of terms of an associated scenario displayed as a result of interaction with terms of FIG. 20.

FIG. 22 is a block diagram illustrating advisory components that are used in deal management according to an embodiment of the present invention.

FIG. 23 is a block diagram detailing some advisory components according to an embodiment of the present invention.

FIG. 24 is a block diagram illustrating extended functionality of pricing sequences according to an embodiment of the present invention.

FIG. 25 is a block diagram illustrating processing of an up-sell request according to an embodiment of the present invention.

FIG. 26 is a plan view of a deal management screen illustrating a base scenario deal view and options.

FIG. 27 is a plan view of a deal management screen for finding available substitute products in an up-sell scenario.

FIG. 28 is a plan view of a screen shot displaying candidate products for product replacement in an up-sell scenario according to an embodiment of the present invention.

FIG. 29 is a plan view of a screen displaying selected candidate substitution products for an up-sell substitution scenario.

FIG. 30 is a plan view of a screen displaying a validation message 3001 related to the submitted validation request of FIG. 29.

FIG. 31 is a plan view of a screen displaying the saved substitution scenario of FIG. 30.

FIG. 32 is a plan view of a screen for performing a side-by-side comparison of 2 deal scenarios according to an embodiment of the present invention.

FIG. 33 is a plan view of a screen illustrating a product-by-product view of the summary scenario of FIG. 32.

FIG. 34 is a plan view of a screen displaying an interactive interface containing selective comparison options.

FIG. 35 is a plan view of a screen illustrating some other options available to a user through the deal management interface.

FIG. 36 is a screen illustrating an interface for performing final deal edits according to an embodiment of the present invention.

FIG. 37 is a plan view of a screen displaying an updated list of scenarios.

FIG. 38 is a block diagram illustrating a relationship between an advisory factor and associated rules according to an embodiment of the present invention.

FIG. 39 is a block diagram illustrating a relationship between an advisory factor 3901 and associated rules according to an embodiment of the present invention.

FIG. 40 is a block diagram illustrating processing of a competitor request according to an embodiment of the present invention.

FIG. 41 is a process flow diagram illustrating steps for factor and rule creation according to an embodiment of the present invention.

FIG. 42 is a plan view of a screen for analyzing a base scenario according to an embodiment of the present invention.

FIG. 43 is a plan view of a screen illustrating an optimization of product distribution strategy for a specific period analyzed.

FIG. 44 is a plan view of a screen illustrating a competitor pricing view of a portion of a long-term contract.

FIG. 45 is a process flow chart illustrating calculation steps for calculating a competitor sequence.

### DESCRIPTION OF THE PREFERRED EMBODIMENTS

The inventors provide an improved system for automatically configuring complex pricing scenarios for enterprise-offered products and services. The methods and apparatus of the invention are described in enabling detail below.

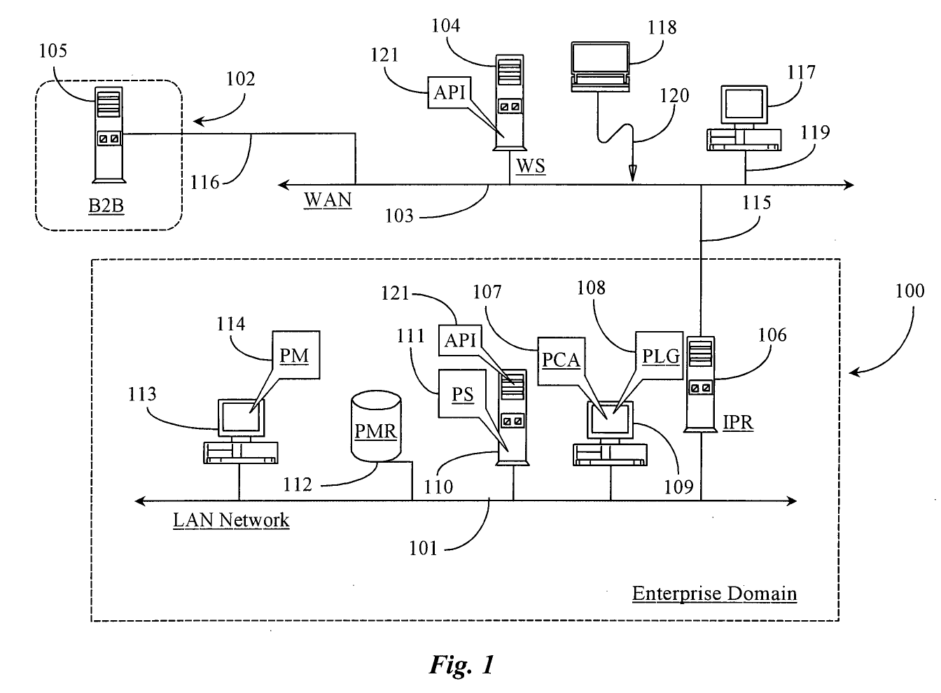

FIG. 1 is an architectural overview of the pricing system of the present invention An enterprise domain, illustrated herein as domain 100 is illustrated in this example as the host of the pricing system of the present invention. Domain 100 also referred to in this specification, as enterprise 100, can be any type of enterprise that engages in the selling of products and/or services to clients. In this case clients refer to any entity, be it a business or private consumer that might purchase a product or service from enterprise 100.

Enterprise 100 can be implemented physically as a business having a contact or communication center and/or department for sales and general management. Enterprise 100, in this example, has a local-area-network (LAN) 101 provided therein and adapted for transfer control protocol/Internet protocol (TCP/IP) and any other required protocols to enable LAN 101 to serve as a corporate, public, or private wide-area-network (WAN), illustrated in this example as a WAN 103. WAN 103 may be a sub-network to the well-known Internet network, or considered to be the Internet network as a whole.

LAN 101 of enterprise 100 has an Internet protocol-capable data router (IPR) 106 connected thereto and adapted to provide routing services between the physical domain of enterprise 100 and any external client-access points implemented on WAN 103. IPR 106 has access to WAN 103 by way of a network access line 115. A server node 110 is provided within domain 100 and is connected to LAN 101. Server 110 is enabled for practice of the present invention by a pricing server (PS) application 111. PS 111 is the main computational component of the software of the present invention and serves pricing results according to requests made internally accessing via LAN 101 and externally via WAN 103, network line 115 and LAN 101. Pricing server is adapted in a preferred embodiment to perform run-time transaction-type processing.

A desktop node 113 is provided within enterprise 100 and is connected to LAN 101. Node 113 has a pricing management (PM) application 114 provided therein as an executable software application. PM 114 is adapted to enable an administrator operating from node 113 to manage various aspects of a pricing model provided to represent the model of an enterprise pricing structure. PM 114 running on node 113 enables an administrator to manage pricing rules, pricing framework, product and service categories, and client categories.

A second desktop node 109 is provided within enterprise 100 and is connected to LAN 101. Node 109 has a pricing configuration application (PCA) 107 provided therein as an executable application. Pricing configuration application 107 logically represents any enterprise front-end applications that require pricing information to be complete. Node 109 also has a price-list generator (PLG) 108 provided therein as an executable application that enables an administrator operating from node 109, or an automated system application to generate on-demand price lists and pricing reports for products and/or services. It is important to note herein that the software of the present invention does not have to be implemented in distributed portions on more than one server or node in order to practice the present invention. The inventor illustrates a distributed implementation in order to logically separate functions of application modules only. For example, PLG 108 and PM 114 may reside on a single machine. All of the so-far mentioned software components may, in fact, reside on a single machine. PCA applications 107 may be resident applications used internally or third-party applications used by clients to access pricing information from external nodes such as WAN based severs or remote desktop systems.

A data repository 112 is provided within enterprise 100 and is connected to LAN 101. Repository 112 is adapted to store at least one pricing model used by the enterprise and all of the associated data related to the model. Component PM 114 is used to create and update at least one pricing model stored in repository 112. PS 111 responds to client requests for pricing information and accesses one or more pricing models from repository 112 in order to obtain the parameters and variables that enable the server to calculate the correct pricing results according to implemented rule and send a response containing requested pricing information back to the requestor entity.

WAN 103, which may be the well-known Internet network, has a business-to-business (B2B) communication server 105 connected thereto by way of a network access line 116. B2B server 105 logically represents a business server maintained by any business domain illustrated herein as a rectangular block labeled with the element number 102. Server 105 is adapted to communicate with pricing server 110 within domain 100 in an automated fashion in order to initiate and complete transactions between business entities, one of which is enterprise 100 in this example.

Server 110 has an application program interface (API) 121 provided thereto as part of server software 111. API 121 is, in a preferred embodiment, Java-enabled to translate business and pricing information between various markup languages that may be used by requesting applications to request pricing information. API 121 can be a single API or a set of APIs depending on the requirements of the system. The system of the present invention is not limited by platform or operating system type and is adapted to translate a wide variety of Web-based and network-based markup languages like Hypertext Markup Language (HTML) based, Extensible Markup Language (XML) based, Wireless-Markup Language (WML) based, and other commonly used languages. The communication ability of the system of the present invention to other platforms and languages includes telephony-based languages like Computer-Telephony-Integration (CTI) based including interaction ability with Interactive-Voice-Response (IVR) systems, Voice over Internet Protocol (VoIP) systems and other voice-enabled automated systems. In this way business clients and independent enterprise customers can access real-time pricing information for virtually any type of order or purchase requirements through a variety of interfacing systems.

WAN 103 has a Web server 104 connected thereto and adapted as a client-access point to services provided by enterprise 100 and is thus assumed to be enterprise hosted. Clients access services offered by enterprise 100 through Web server 104. Web server 104 like server 110, has one or more APIs 121 provided for the purpose of interfacing between various client applications and PS 111. Client access to server 104 is logically represented herein by a client node 117 and a client node 118 connected to WAN 103. Client node 117 represents a client that has access to server 104 through a traditional wired Internet connection brokered by an Internet service provider (ISP) as is generally known in the art. Client node 118 represents a client that has access to server 104 through any wireless service provider from a Laptop computer or another network-capable device. Client node 118 makes access by way of a wireless link 120 and client node 117 makes access by way of a network connection 119. In a preferred embodiment, clients of type 102, 118, and 117 may connect on-line and access real time pricing information through WS 104 (clients 118, 117) or directly through server 105 (client 102) from pricing server 111. Upon receiving a request for pricing, server 111 accesses one or more pricing models from repository 112 according to request parameters and calculates the correct pricing including special discounts, contract prices, and the like according to prevailing enterprise rules. Server 111 sends a response with correct pricing back to the requesting client.

In one embodiment of the present invention PS 111 is Web-based and distributed to a Web-server like server 104 for access by clients 118, 117, and 105. Moreover, clients may be provided with a client application or browser-plug-in that communicates with PS software when requesting pricing information. A goal of the present invention is to provide a more-flexible pricing engine that can produce complex pricing information faster using less computational resources and storage space than prior-art pricing systems.

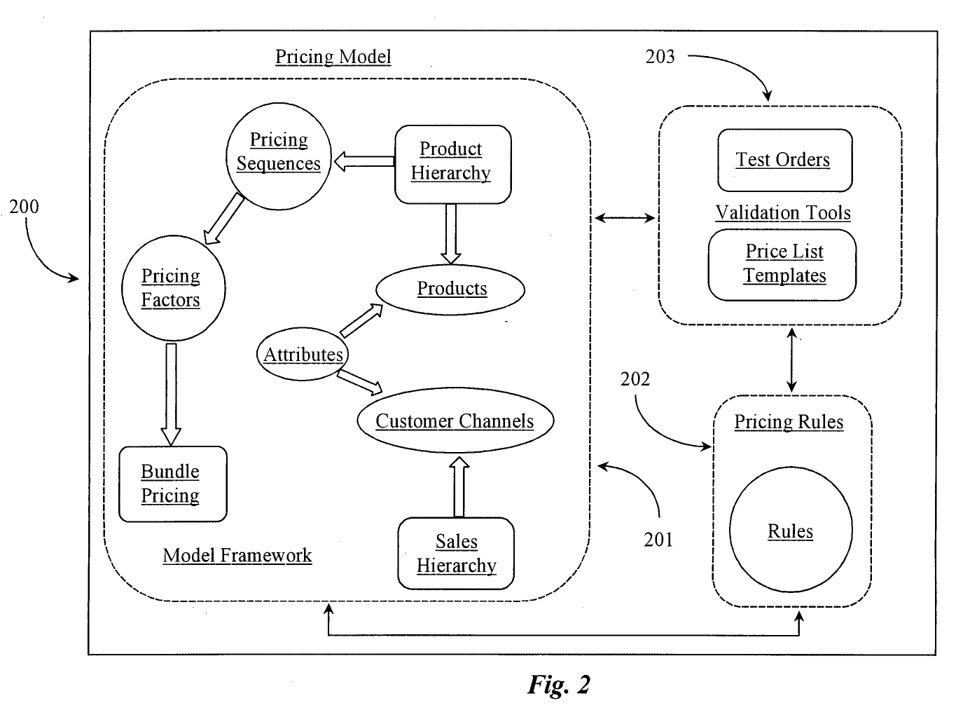

FIG. 2 is a block diagram illustrating a pricing model 200 according to an embodiment of the present invention. Pricing model 200 is a data model that follows a model framework illustrated herein as model framework 201 (enclosed by dotted rectangle) and is executable according to specific rules that are related to specific pricing scenarios. Model 200 can import pricing attributes and rules from existing enterprise models and can be updated and configured using newly defined attributes and information. Model framework 201 of model 200 includes a product hierarchy structure and a sales hierarchy structure illustrated herein by appropriately labeled blocks.

A sales hierarchy defines the structure and groupings of customer types and channel categories. Channels are the client-grouping vehicles and customers or clients are assigned to specific channels. Channels, more particularly define clients by categories. For example, a channel “educational” may define client types who purchase products for the education industry. A channel “Web” might be used to define clients who make purchases from Web-based portals. A channel “Business Partners” might define business clients who provide co-branded services to their clients using the methods and apparatus of the present invention to obtain discount pricing of products and services for resale. Channels may be any type of logical grouping of clients and clients may be included in more than one defined channel.

A product hierarchy defines the structure and groupings of enterprise products and services by categories. A product category might be “Server Hardware/Software”. Another category might be “Desktop Hardware/Software”. Still another product category might be “Cables and Interfaces”.

Products, clients, and channels have specific attributes assigned to them that define what pricing adjustments will apply to pricing sequences used to calculate product and/or service pricing. Attributes can include physical descriptors and time-based indications. For example, a shipping weight for a particular product is an attribute of that product A timetable covering a blanket purchase order negotiated with a specific client is an attribute of that client. Therefore, attributes define certain details about certain products, services, channels, and customers of the enterprise that weigh in when calculating specific pricing information.

Model framework 201 includes pricing factors. A pricing factor defines a pricing element or a pricing adjustment that is part of a pricing sequence. Examples of pricing factors include base price, cost, list price, local uplift, and so on. Model framework 201 includes pricing sequences, which are compilations of selected pricing factors. A pricing sequence is simply a list of factors that are executed in sequence to return a pricing result.

Model framework 201 includes bundles, which are definitions of certain product/service combinations that have special pricing considerations that are typically different when the products are provided separately. Bundling is commonly used by many enterprises as convenient vehicles for selling products and services. A computer, printer, monitor, scanner, and certain software can be provided as a bundled product attached to a specific service package making the service also part of the bundled product.

Model 200 uses pricing rules illustrated herein as rules 202 in order to resolve pricing requests. Pricing rules apply to general and specific combinations of products/services, customers, and channels. Pricing rules are created and are stored in a rules base that is part of the pricing model that is accessed by the pricing server component described with reference to FIG. 1 above. One or more pricing models 200 and associated rules are, in a preferred embodiment, stored in an object-relational, or other object-supported database. Through rules-based manipulation of the pricing model clients receive real-time pricing information in an automated fashion. One advantage that the system of the present invention has over prior-art systems such as the system of Carter described with reference to the background section is that when calculating pricing, only the rules for the specific factors in a sequence are navigated to determine specificity in pricing rather than the adjustments for all of the entire product and sales hierarchies above the specified product and customer indicated in an order for pricing. Only the rules specific to pricing request attributes are applied in calculation.

Pricing model 200 has validation tools 203 provided for the purpose of validating portions of the model and for generating templates for use in creating client, bundle, or category specific pricing lists for publishing. Test orders can be created and used to test the accuracy of specific portions of model 200 and are treated by the pricing model framework 201 as normal client-originated requests. Pricing templates are broad-based requests for pricing information and are specific to client type, channel, or category and can include bundle-pricing information and contract pricing information.

Model 200 can, in one embodiment, be configured as a generic but extensible pricing model wherein each request causes the system to build a version of the model that fits the parameters of the request. The pricing engine (analogous to server application 111 of FIG. 1) uses the model version that completely defines the client, channel, and product category, to generate the requested pricing results.

One with skill in the art of object-oriented presentation will appreciate that the system of the present invention not only decreases the need for storing tuples in numerous repetitive data tables, but reduces computation required of prior-art systems in drilling down to specific client and products ordered by considering everything in the trees above the position of the client and product in the tree. More detail regarding the computation process will be detailed later in this specification.

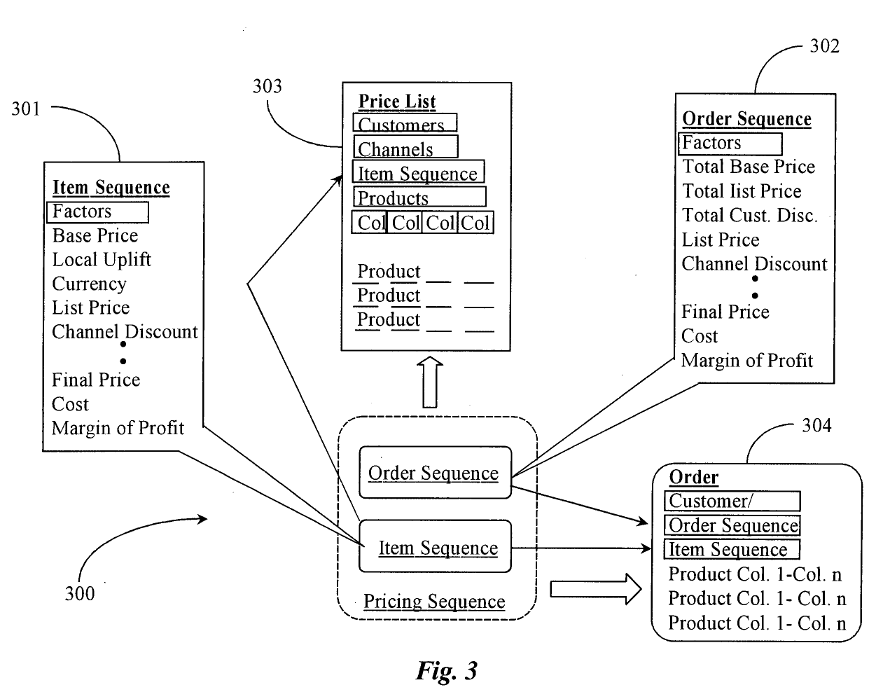

FIG. 3 is a block diagram illustrating the function of price sequencing according to an embodiment of the present invention. A pricing sequence 300 is illustrated in this example and comprises 2 types of sequences that are used to calculate pricing for an order. The 2 sequence types are labeled herein as an Order Sequence and an Item Sequence. Each type of sequence uses pricing factors. For example, an item sequence 301 is illustrated in some detail and has the listed factors Base Price, Local Uplift, Currency, List Price, Channel Discount, Final Price, Cost, and Margin of Profit. Note that the listed factors in sequence 301 are line item specific and are calculated for each item that pricing is requested for. Note also that the last 2 listed factors of sequence 301 are for internal use. They demonstrate an ability of the system to provide internal-use information like calculating a gross or net profit margin from a calculated cost figure.

An order sequence 302 is illustrated as the other type of pricing sequence and is used in the calculation of orders containing more than one product. Under factors listed in sequence 302 there is a Total Base Price, a Total List Price, a Total Customer Discount, a List Price, a Channel Discount, a Final Price, a Cost and Margin for Profit. It is noted herein that an item sequence is used to calculate pricing for a single item while an order sequence is used to calculate the sum totals of all of the line items of an order providing a “Total” figure. Singular discounts may also apply to an order such as a channel discount. Item sequence 301 is also used to produce line item price lists, such as illustrated price list 303 for clients. Price list 303 contains a heading for indicating which customer or customers the list applies to, which channel or channels to apply, the line item sequence or sequences used to process the items on the list, and the actual list of products and the itemized pricing figures adjacent to the appropriate items for pricing. Order sequences are always used to process customer orders such as illustrated order 304.

In a preferred embodiment of the present invention pricing requests can comprise actual requests for pricing initiated by clients prior to order placement and actual client orders where the pricing information is simply used internally for billing the processed orders. In the later case, typically the line item pricing, discounts amounts, and order totals are displayed for clients to view at the time of transaction.

A simple 3-step process for calculating orders and/or pricing requests starts when the “pricing engine” analogous to application 111 described with reference to FIG. 1 receives a pricing request as a first step. The pricing application then accesses and fires rules in a second step to determine values of factors used in the pricing sequence or sequences. At step 3 the pricing engine serves the calculated pricing results back to the requestor in the case of a simple request for pricing and/or uses the results for billing an actual order.

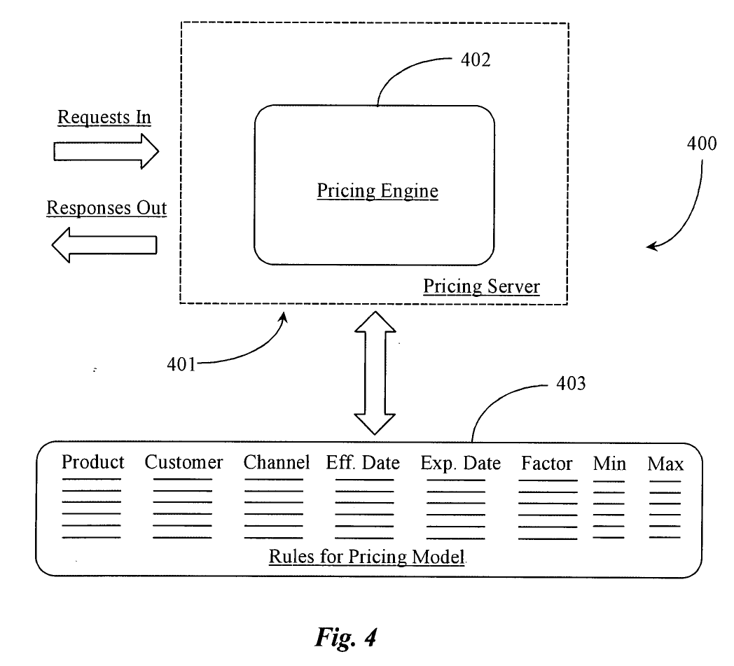

FIG. 4 is a block diagram 400 illustrating relationship between the pricing engine 402 and a rules base 403 according to an embodiment of the present invention. Diagram 400 logically illustrates the 3- step method mentioned above. Pricing engine 402 is analogous to application 111 described with reference to FIG. 1. A pricing server 401 encapsulates engine 402 and is analogous to server 110 described with reference to FIG. 1. Engine 402 executing from pricing server 401 is adapted to accept incoming requests for pricing, which may include actual orders for products and/or services.

Incoming requests are illustrated herein by an arrow labeled Requests in. Incoming requests for pricing may be queued for engine 402 in a variety of different ways. The actual form of incoming requests will depend in part on the enterprise system environment and channels of operation. The system of the invention can be adapted to all known communications methods for placing orders and requests for pricing to an enterprise. Telephony IVR interaction, Web-form submission, e-mail orders, voice-assisted attendant orders, electronic fax orders, and orders submitted through special graphical user interface (GUI) components represent requests filtered through various interfaces that are fulfilled in automated fashion without human input. Telephone orders, telephone fax orders, and standard mail orders, can be intercepted by human operators and fulfilled with a pre-step of human assisted data entry. Once all of the required parameters of an order or pricing request are available to the system, the system can calculate the pricing and close the transaction, in case of an order, or submit a price quote in the case of a request-for-quote.

Once a request having all of the proper parameters is registered within engine 402, a rules base, illustrated in this example as rules base 403 is consulted. Engine 402, relying on server network communication capability between server 401 and rules base 403, causes a search for all of the rules that are applicable to the recognized parameters of the order or pricing request being processed. Rules base 403 is analogous to a rules base as part of a pricing model stored within PMR 112 described with reference to FIG. 1. Rules base 403 may, in one embodiment, be held separately from any pricing models and model tuples. Rules base 403 contains all of the created rules that the pricing model uses to resolve pricing. Rules can be created that apply to specific products, customers, and channels. Rules may be time sensitive and have effective dates and expiry dates. Rules may be created for specific pricing factors, and to volume orders having minimum order number and maximum order number ranges.

Although not illustrated in rules base 403, rules may also be created for special situations like contract dates, tiered pricing, scope pricing, and bundle pricing. An important aspect of the present invention is that engine 402 accesses rules base 403 for a request being processed and considers only those rules found that apply to the pricing factors of a pricing sequence and that match parameters present in the request. Therefore, rules contained in rules base 403 that have nothing to do with the factor value being determined are not accessed at all. Furthermore, no pricing sequences are finalized for calculation until the rules that apply have been processed for specificity. In other words, if a set of rules for a factor in a pricing sequence is found that applies to a particular product listed in the request, those rules are processed according to all of the other parameters also contained in the request until only a single applicable rule remains for the product listed. Rules found for each of the other parameters are processed accordingly until the specific rules are found that exactly fit the request More about conflict resolution of rules in pricing is provided later in this specification.

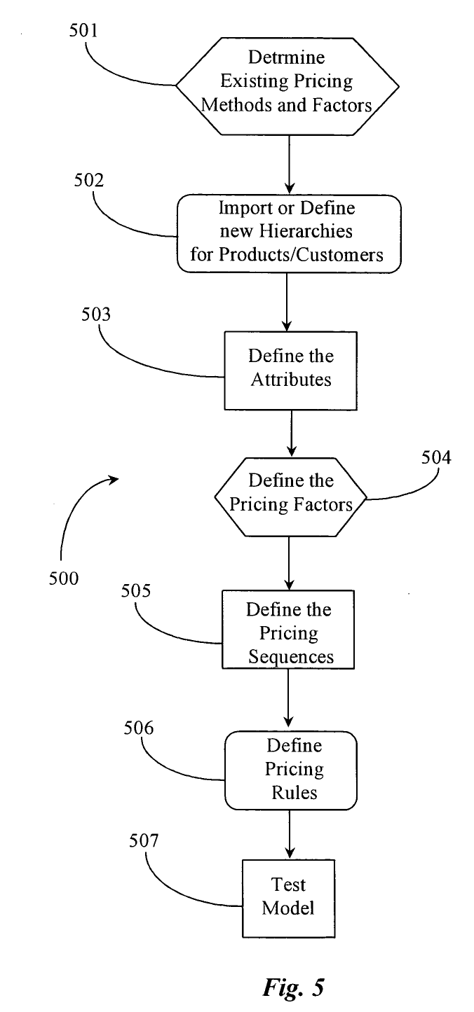

FIG. 5 is a process flow chart 500 illustrating steps for building a pricing model according to an embodiment of the present invention. As previously described above, a pricing model is used for the purpose of enabling automated pricing calculations based on an applicable set of rules. In order to create a viable pricing model an enterprise must define and create the various components of the model. Chart 500 illustrates the basic steps of the process. At step 501, a user determines what existing pricing methods and pricing factors are currently used in that enterprises existing pricing scenario. In some cases, an enterprise may already have some basic pricing system of prior-art, which may already have a hierarchal structure for customers and products with certain pricing adjustment formulas and sequences that are currently used. All of these components that will be re-used in some way are isolated.

At step 502, the user may import all or some of the old product and sales hierarchies, if they exist, into a pricing manager application analogous to PM 114 described with respect to FIG. 1 above. PM 114 is able to translate the data format used to store the former data into a data format suitable to the pricing model. API language translators are available to and known to the inventor that can import the necessary data into the format required for model representation of the sales and product hierarchies. In one embodiment the sales channel (if used), and product hierarchies are created from scratch. In still another embodiment, some of the existing data is imported for convenience but significant re-structuring and possible addition of new categories is practiced. Data can be selected and imported into the PM application or keystroke methods typically available to computer interfaces. In case of old legacy storage systems, a suitable middleware can be installed to provide access and efficient use of the previously stored data. In addition, the pricing model can be generated from existing data.

Sales/channel and product hierarchies enable reduction in the number of rules considered for any specific pricing requirement. The flexibility built into the pricing model enables assignment of individual products into one or more product categories and individual customers or channels into one or more customer/channel categories in the trees. An enterprise has the ability to reorganize any part or all of a hierarchy and can make “group updates” into a hierarchy without repetitive entry.

Once the hierarchical structure of customers/channels, and products/services are set up, at step 503 the user defines all of the attributes and assigns them to their applicable customers, products, and channels. Attributes are the conditional variables that the pricing factors will consider when a pricing sequence is executed. More particularly, an attribute is a changeable numeric or alphanumeric property of an object (object orientation). An attribute can be modified to represent different values as may be required. Attributes are created by defining the attribute definition and association rules and then by assigning a default value to each attribute. A user may associate one or more attributes to specific customers, specific channels, or to specific products. Because attributes are “object properties” they, of course are not assignable to object groupings (categories).

At step 504, the user defines the pricing factors that will be used in pricing sequences. The pricing factors are the building components for the pricing sequences used to calculate item and order pricing. A pricing factor performs a mathematical or logical operation. Some factors are computational factors whose values are simply used as input for another factor in a pricing sequence. In typical pricing scenarios a first factor defined, say for a particular product might be a base cost or a base-pricing factor. The user can name such a factor simply as Base Cost or Base Price and assign a value to the factor. Note that the first factor of every sequence must have an assigned value to enable the sequence. Other factors will have values determined by rule. More detail about creating a factor will be described later in this specification.

At step 505 the user defines all of the pricing sequences that will be used to calculate prices. There are actually 3 types of pricing sequences that apply to pricing scenarios. Two of these, item sequences and order sequences were described briefly above with respect to the text description of the example of FIG. 4. The third type of pricing sequence is an item/order sequence. An item sequence is used to produce line item pricing such as required for price lists and customer orders. An order sequence is used to produce order totals and summaries. An item/order sequence is a single combined sequence used to calculate both line item pricing and order summary calculations. It is important to note that while many different item and order sequences may be created from factor combinations, most enterprise pricing models will rely basically on a default sequence of each type.

At step 505 the user defines all of the pricing rules that will be used to determine which values pricing sequences will use in calculation. As previously described, PM uses rules to determine which values will be assigned to pricing factors of pricing sequences. A pricing rule is applied to a specific pricing factor. Pricing rules may include an effective date range; a specific set of one or more sales categories and/or a specific customer; a specific set of one or more sales categories and/or an individual channel; a specific set of one or more product categories and/or a specific product; and a numeric minimum and maximum range or an alphanumeric value. More than one rule may be assigned to a specific pricing factor. The only time a rule assigned to a pricing factor is considered during a pricing sequence is when the conditions of the rule are consistent with the parameters listed in the pricing request being processed.

There are different types of rules that might be created for different types of pricing scenarios such as standard pricing rules, scope pricing rules, and bundle pricing rules. Rules can have more than one condition making it a compound rule that is assigned to more than one position on a hierarchy of product, customer or channel. The specificity of rule conflict resolution determines which values to use for the factors in any given pricing sequence. For example, if a pricing request comes in for a computer monitor abc, a printer 123, and a computer processing unit xyz, there may be individual rules pertaining to each of those products sold alone, and a special rule for those specific products sold together (bundle). In this case, the bundle rule might override the other product-specific rules. The invention does not have to consider any rules whose conditions do not match parameters of the request or that apply to any other factors aside from the factor that a value is being determined for. This fact makes the drill-down to specificity much more efficient than prior-art pricing systems. At step 507, the user may use the validation tools available with the pricing software to generate test pricing and order scenarios to test the accuracy and integrity of the pricing model in operation.

An innovative aspect of the present invention is that rules selected for setting the value of a factor when pricing a particular request are executed only if the rule constraints of the particular rule identified for the factor match the parameters listed in the request for pricing at a highest specificity. A unique process of conflict resolution is practiced to eliminate candidate rules from consideration.

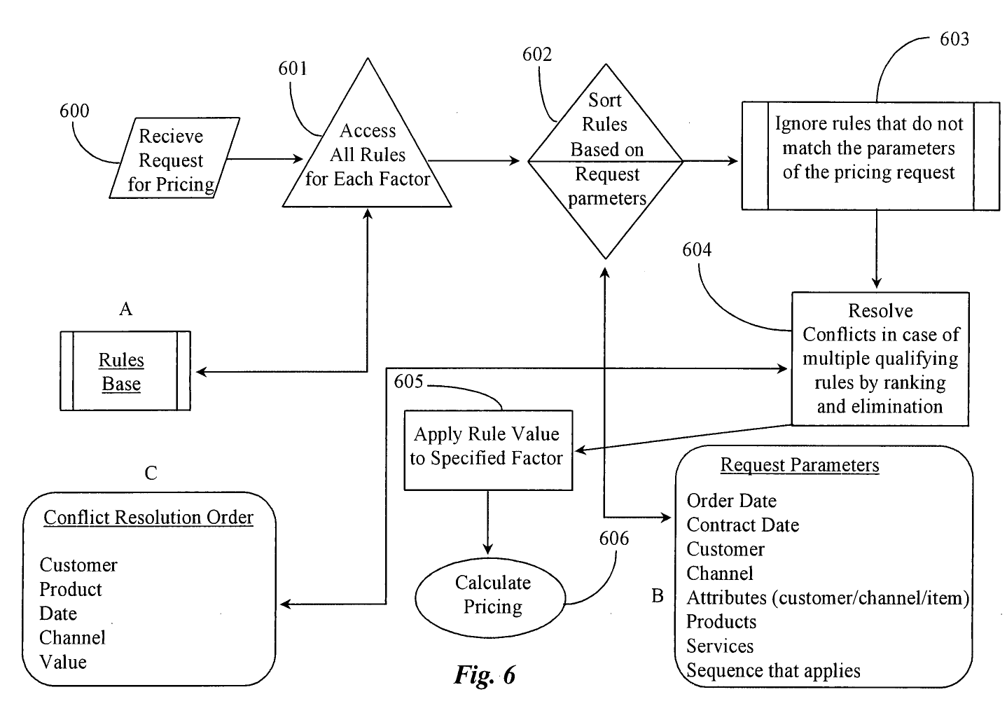

FIG. 6 is a process flow chart illustrating steps for applying rules to factors before calculating prices according to an embodiment of the invention. At step 600 a request for pricing is received for processing. The request can be an actual client-placed order, a request for quote, a request for generating a price list, or a test request for model validation. The request is received by a PS application analogous to application 111 described with reference to FIG. 1 above.

At step 601, the PS application accesses a rules base, illustrated herein as a rules base “A” drawn in association with step 601 and searches for and identifies all rules that exist for each factor of the first pricing sequence used to calculate the line item pricing for the products and/or services listed in the request. It is important to note herein that in a preferred embodiment PS software determines which pricing sequence to use before rule identification because the rules are used to determine the values for the factors of the pricing sequences. Typically, an item sequence will be the default first sequence of a pricing request.

At step 602, the PS application sorts the rules for the first factor of the sequence and subsequent factors in a pricing sequence based on matching rule conditions against parameters indicated in the pricing request data. Possible request parameters of the pricing request received at step 600 are illustrated in this example as a request parameter list “B” drawn in association to step 602. Request parameters will logically include a date of request, which may be an order date if the request is a client order. If the request is associated with a previously drawn contract a contract date will be one of the request parameters. The customer originating the request will be identified. If the request is a test or an internal request, the customer parameter will reflect the request originator.

If the request is an order and channels are defined in the pricing model sales hierarchy than the request will identify the customer channel. Customer, channel, and item attributes can be made part of the request if applicable during run time after the request is received. An order quantity of a same item is an attribute. The request will identify and list the products and or services to be priced. The request will be assigned one or more pricing sequences by default, however other pricing sequences can be applied at run time based on resident request parameters or run-time attributes.

Referring now back to step 602, only rules for a factor that apply to all of the request parameters are extracted for conflict resolution. Other rules that did not have conditions that applied to all of the request parameters are ignored at step 603, which is another enhancement over prior-art systems. Steps 602 and 603 are repeated for all rules of each factor in a given pricing sequence in lieu of certain exceptions described further below. Factor rule sorting is based on examining rule constraints or conditions and matching those constraints or conditions against request parameters contained in the request being processed. Two exceptions to step 602 exist, the first one being that if a factor specifies an attribute override then instead of accessing rules for that factor, the pricing engine (PS 111, FIG. 1) accesses the value pre-assigned to the attribute indicated and assigns that value to the factor and then moves to the next factor. The other exception is that if the factor is a computational factor, there are no factor rules existing for that factor and its value is derived from computing the two previous factor values in the sequence (value derived “from factor 1 and from factor 2”). Such a factor must have two previous factors listed in the sequence.

It is noted herein that multiple rules may be created for a single pricing factor. In the case of multiple rules, such rules apply to the specified factor under certain conditions built into the rule definitions. For example rule conditions for application to any particular factor can be based on one or a combination of products and their specific locations in the product hierarchy, customers, channels, effective and expiry dates, contract dates, order dates, and conditional variables. The ability to apply multiple rules to a pricing factor enables much more flexibility for pricing different scenarios than prior-art systems do. For example, customer-specific pricing differences can be applied to a same product. Same products can be priced differently from one another based on the particular product categories to which they belong. Pricing differences of same products may also be based on date purchased, date required, contract date agreements and so on.

It should be noted herein that for conflict resolution, there is provided a default conflict resolution order list that is adapted as a template used to resolve specificity of rules qualifying for a given factor. The list is illustrated herein as Conflict Resolution Order “C” drawn in association with step 604 described further below. The default order of parameters for conflict resolution are Customer; Product/Service; Date; Channel; Attribute; and Value. The last parameter is a tie-breaking parameter for any number of rules greater than one rule of a set of rules that all qualify at a same specificity to set the factor value according to all of the conflict resolution parameters.

Referring now back to step 603, rules that are found for a given factor that do not apply, at least generally, to all of the pricing request parameters of a particular request being processed are eliminated from consideration or ignored. Only the factor rules that contain or apply to all the parameters contained in the request for pricing are aggregated for conflict resolution. This fact reduces the amount of computing resource that is dedicated to the process, as not every rule that applies to the factor is considered as a candidate factor rule capable of setting the factor value. All candidate factor rules for conflict resolution have rule conditions that roughly match the stated parameters in the pricing request.

The exact level of granularity for initial rules sorting against parameters can be configured when rules are defined for the factors. For example, in a low level of granularity all of the rules for a given factor that are found to at least contain all of the condition fields that match with the request data fields may be considered to qualify for conflict resolution. In a preferred embodiment the request data has at least an order date, a customer I.D., a channel I.D., product I.D. and optionally, a product category I.D., and any attributes like quantity ranges.

Therefore, any rules for a particular factor that qualify after sorting in step 602 are resolved against each other using the above-mentioned conflict resolution order as a template. The goal is to resolve down to a single most specific rule to apply to the considered factor.

At step 604, if there exists more than one rule after sorting for a given factor, those rules are analyzed and ranked according to specificity of their conditions matching the request parameters using the conflict resolution order according to the default order of parameters stated in list “C”. It may be that only one rule for a considered factor passes the processes of steps 602 and 603. In that case step 604 is not required and the process skips to step 605 where the value of that rule (being most specific) is assigned to the factor. Comparison is made by drawing the node paths of the condition against the node path of the matching parameter of the request. The rules are compared for the first parameter of conflict resolution order “C” and then again for the second parameter and so on down the list.

Any logical ranking system may be employed. In one embodiment a simple ranking system of real numbers is used wherein simple numbers like 1, 2, 3 and so on are employed. In this case, 1 is a highest ranking (closest specificity to parameter while 3 is a lowest ranking of the just-mentioned ranking numbers. Tokens, binary numbers, or other numeric criteria may also be used. During comparison the node paths specified in each parameter of a request are compared against the associated node paths specified in the rule conditions of each compared rule according to the order stated in list “C”. This means that the remaining rules applying to a given factor after step 603 are first compared for “customer” specificity to the specificity of “customer” contained in the request. If for example there are 4 rules and 1 rule specifies a root node “All”, one rule specifies a customer category “re-sellers”, 2 rules specify “Jack” as a customer, and the request path for customer specifies “Jack”, then the first rule receives a ranking of 3, the second rule receives a ranking of 2 and the remaining rules receive a ranking of 1. The rules ranking 3 and 2 are eliminated from consideration, however the remaining rules are tied and must be compared now according to the next listed conflict parameter, which is product. The process repeats for all of the conflict resolution parameters until there is only one rule left.

In one embodiment, there may be no rules that, for example specify the exact customer listed in the request, but there are rules that specify, perhaps the customer category “Re-sellers” and the root node of the customer hierarchy “All”. In this case, the rules specifying “Resellers” would get a ranking of 1 and the rule specifying “All” would get a ranking of 2 because “Resellers” is positioned in the sales hierarchy closest to the specified customer “Jack”, if Jack is categorized as a reseller.

If in step 604 there are multiple rules that receive the highest rankings for both customer and product, then they are compared for specificity according to date as it applies to rule effective and expiry date ranges. For example, assume that the order date parameter of the request is Apr. 25, 2003. Assume 2 remaining tied rules wherein one of the rules has an effective date of Apr. 20, 2003 and an expiry date of Apr. 30, 2003. The other rule has an effective date of Apr. 20, 2003 and an expiry date of Apr. 15, 2003. Both rules have date ranges that include the order date of the request, however the rule with the more constrained range is assigned a ranking of 1 and the other rule a ranking of 2 breaking the tie for the parameter date. If there are 2 rules having date ranges that are equal in length wherein the request date falls within both ranges, then the rules remain tied and the next conflict resolution parameter of “Channel” is used to compare the rule specificity. The system assigns a higher priority to a rule with only one open ended range end for date compared to a rule with both range ends open. However rules that are open ended on opposite range ends when compared remain tied.

Additional rules for specificity apply when a factor specifies a conditional alphanumeric attribute or a numeric attribute like volume. In the first case a rule is qualified for the factor if the alphanumeric value in the rules exactly matches that found in the request and conflict resolution is not required. In the second case rules are sorted by maximum and minimum ranges for a numeric attribute listed in the pricing request and the range that is the most constrained receives the highest ranking similar to date range processing.

It may be the case that two or more rules succeed to the last parameter of the conflict resolution order parameter listed as “Value” in list “C”. In this case a factor definition flag set to highest or lowest value for tied rules in conflict resolution is applied to break the final tie. By default the system selects the rule having the highest value.

At step 605 the value specified by the last remaining rule is assigned to the factor. If there were 2 or more rules that were tied wherein the assigned values had to be decided by a pre-set value determination of lowest or highest value, then the rule with the lowest or highest value is assigned to the factor at step 605 depending on a flagged indication found in the factor definition.

It will be apparent to one with skill in the art of data conflict resolution that the exact steps of the process represented herein may vary somewhat in description and granularity without departing from the spirit and scope of the present invention. For example, conflict resolution may, in one embodiment, ensue until each rule has been thoroughly compared according to every parameter on the conflict resolution list “C” before any ranking is assigned. In this example a ranking and elimination sequence occurs once for each factor of list “C” until rules are eliminated by receiving a ranking of lower than a highest ranking rule in the same set for comparison.

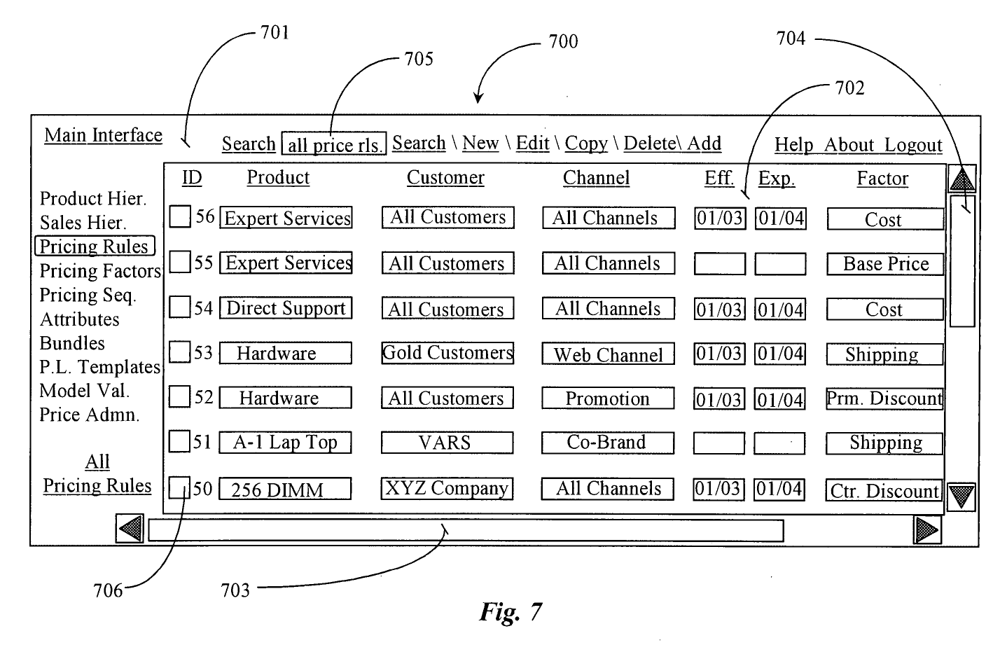

FIG. 7 is an elevation view of a main user-interface screen 700 for practicing the present invention. Screen 700 is a main user interface for enabling management of the various components of the invention. Screen 700 is the user interface for PM software 114 running on desktop 113 described with reference to FIG. 1 of this specification. Screen 700 can be provided as a LAN-based or Web-based application wherein authorized users make access by performing a login procedure from a login screen. Screen 700 has a resident face 701 and a transition window 702.

Face 701 has a list of selectable options arrayed generally in a column on the left side of the main interface. Reading from top to bottom from the list, the selectable options are Product Hierarchy (Product Hier.), Sales Hierarchy (Sales Hier.), Pricing Rules, Pricing Factors, Pricing Sequence (Pricing Seq.), Attributes, Bundles, Pricing List Templates (P.L. Templates), Model Validation Tools (Model Val.), and Pricing Administration (Pricing Admin.). In this example, the selectable option Pricing Rules is highlighted causing display of “All Pricing Rules” in transition window 702.

Resident screen face 701 has a search function field 705 and selectable control icons New, Edit, Copy, Delete, and Add. Screen face 701 also has a Help option, an About option, and a Logout option arrayed at top right of the screen face. Transition window 702 displays all of the pricing rules that have been defined for a particular pricing model. Interface 700 has scroll functions 704 and 703 for vertical and horizontal scrolling. Rules 50 through 56 are displayed in this example.

Each rule has an ID number and specifies a Product and Customer to which the rule applies. Each rule also specifies a Channel or Channel category. Some of the rules have effective dates and expiry dates indicated. Each rule identifies a particular factor to which it applies. Using main interface 700, rules can be copied, deleted, edited and added. Navigation through the list of selectable options and selection of those options cause transition window 702 to display new interactive window contents associated with the selected option. All pricing management functions are accessible and enabled through interaction with main interface 700.

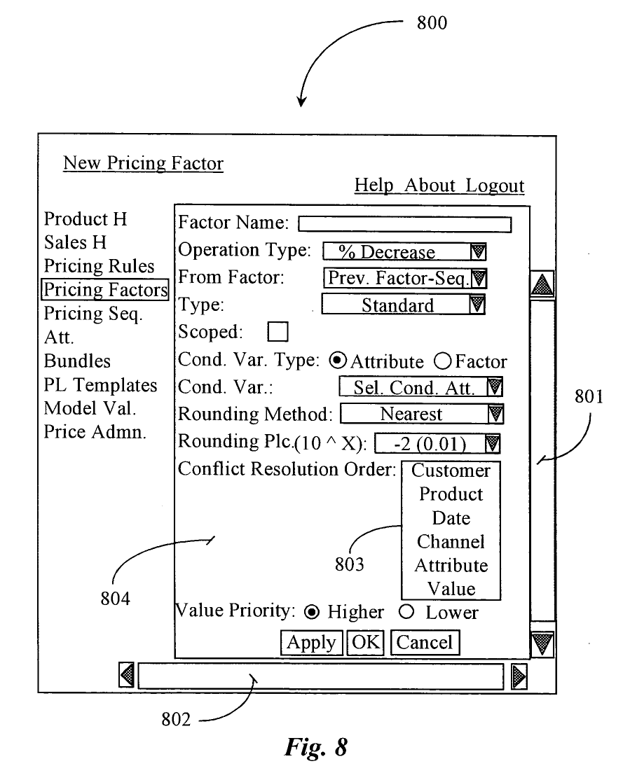

FIG. 8 is an elevation view of a sub-interface 800 invoked from interface 700 for creating a new factor according to an embodiment of the present invention. Interface 800 can be identical to interface 700 described above in terms of the resident portion of the interface. For example, the list of selectable options described with reference to interface 700 on resident face 701 is also represented on the face of interface 800 in this example. The search function and control functions described with reference to face 701 of interface 700 may also be present in this example although they are not illustrated.

Interface 800 has a transition window 804 that is displaying a form for creating a new pricing factor. Scroll functions 801 and 802 are provided for scrolling window content as previously described. The form or layout of window 804 begins at the top with a field for entering a name (Factor Name) for the new factor. A next field is an entry field with drop-down options enabling a user to select an Operation Type for the new factor. In this example a % decrease is displayed in the entry box.

A next entry field (From Factor) is provided to select an associated factor in the sequence. In this case the previous factor in the sequence (Prev. Factor-Seq.) is selected from a drop-down menu. A next entry field is provided to enable selection of a factor Type from a drop-down menu. In this case the type is Standard. A check box is provided for the user to set an indication of Scoped to the factor if it will be used in a scope pricing calculation.

An option field for selecting the type of condition variable for the factor is provided (Cond. Var. Type) with the options of Attribute and Factor. A next entry field enables the user to select the variable condition (Cond. Var.) from a drop-down menu. A next entry field (Rounding Method) enables the user to select the mathematical rounding method for results from a drop-down menu. In this case—2 (0.01) is selected.

A field box 803 is provided to display the current order of conflict resolution parameters. In this case the default order is displayed with the first parameter used on top of the list. A next selection field (Value Priority) enables a user to set the tie-breaking value preference to Higher or Lower. At the end of the form there are selectable options for Apply, OK, and Cancel. Using interactive form 804, a user can create, copy, edit, or delete factors.

Selection of other selectable options arrayed on the left face of interface 800 causes to appropriate transition windows to display the required interactive forms and content associated with user selection.

It will be apparent to one with skill in the art that graphical design of interfaces 700, 800, and all subsequent display, screens, interactive forms, and so on is strictly a matter of design preference of which there may be many variations.

Product-Scope Pricing

Although product-based pricing is the default set-up for the software of the present invention, product-scope pricing rules can be created for applying different prices for a same product offered in different categories. Extending the pricing model for product-scope pricing involves 3 basic steps.

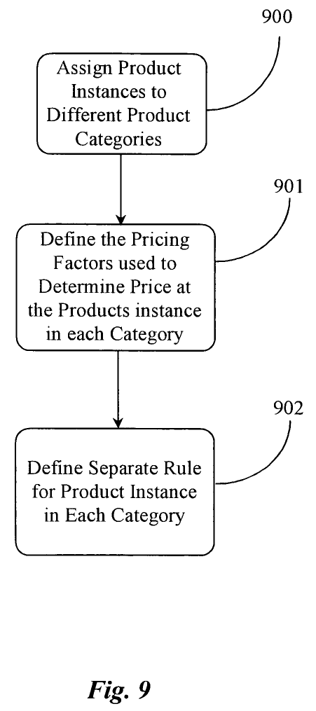

FIG. 9 is a process flow diagram illustrating basic steps for setting up scope pricing according to an embodiment of the present invention.

At step 900 a particular product, which may be a service, is assigned to appropriate product categories. Each category will occupy a different level on the product hierarchy. It is assumed that an instance of the product will have a different price for each of the categories.

At step 901, the appropriate pricing factors are defined based on the product locations in the product hierarchy. The factor scope flags are set in this step to on or checked, as is the case of the form described with reference to FIG. 8.

At step 902, the user creates a separate rule particular to each instance of the product at the different hierarchical location paths assuming different pricing will be the case for the product instance in each separate category. When creating a rule for the product instance, selecting the appropriate product instance from the tree automatically loads the correct path information into a “scope field” associated with the rule.

Contract Pricing

Contract pricing enables price calculation based on prices that were in effect at some point in the past. For example, assuming that current rules exist for assigning the base price of a product in the current year. A contract-type rule can be created for a specific customer that is currently in effect, but sets the base price of the particular product to the price that was in effect during the contract date specified in the pricing request. In creating the rules for contract pricing, a contract date is added to the rule for each factor used so that when the rule is fired the input value for the rule will be calculated based on rules in effect at the time of the specified contract date.

To further illustrate assume that an item pricing sequence of factors are as follows:

| Factor | Operation Type | From Factor | From Factor 2 |
|---|---|---|---|
| Base Cost | Value Override | N/A | N/A |
| Base Price | % Increase | Base Cost | N/A |
| Cust. Disc. | Multiplication | Base Price | Value from Rule |
| Margin | Subtraction | Base Price | Base Cost |

The rules for the factors in the sequence are:

[Rule ID 1 Factor Name Base Cost Product P4 1.5 Customer All Channel All Eff. Date Jan. 01, 2002 Expiry Date Dec. 31, 2002 Contract Date None Value 1400]

[Rule ID 2 Factor Name Base Cost Product P4 1.5 Customer All Channel All Eff. Date Jan. 01, 2003 Expiry Date Sep. 30, 2003 Contract Date None Value 1500]

[Rule ID 3 Factor Name Base Price Product P4 1.5 Customer All Channel All Eff. Date Jan. 01, 2002 Expiry Date Dec. 31, 2002 Contract Date None Value 15 ]

[Rule ID 4 Factor Name Base Price Product P4 1.5 Customer All Channel All Eff. Date Jan. 01, 2003 Expiry Date Dec. 31, 2003 Contract Date None Value 15]

[ Rule ID 5 Factor Name Cust. Disc. Product P4 1.5 Customer All Channel All Eff. Date Jan. 01, 2003 Expiry Date Dec. 31, 2003 Contract Date None Value 0.90]

[Rule ID 6 Factor Name Cust. Disc. Product P4 1.5 Customer Nexisl Channel All Eff. Date Jan. 01, 2003 Expiry Date Dec. 31, 2003 Contract Date Jan. 01, 2002 Value 0.90]

For an order having the following parameters:

Order Date Feb. 23, 2003 Contract Date Jan. 01, 2002 Customer Nexisl Channel N/A Item LX Laptop p4 1.5 QTY 1

First the base cost is figured as of Feb. 23, 2003 order date and assigns the more specific value of rule 2 (1500) as the base cost value. The next item in the pricing sequence is base price as of the order date of Feb. 23, 2003. The pricing engine assigns a 15% increase based on the most specific rule 4 applied to the from factor value 1500 to render a value of 1725.

The next item in the sequence is customer discount. Because rule 6 contains a contract date as does the order, the pricing engine saves the previously calculated results for base cost and base price in memory. Then the pricing engine recalculates the base price “From Factor” of rule 6 based on the contract date and qualifies rules 1 and then 3 to arrive at a new base price. The base cost value of rule 1 is 1400 so the engine calculates the new base price using 1400 from rule 1 and the value from rule 3 (15) to render 1610. The engine then assigns the value from rule 6 (.90) for multiplication arriving at a customer discount value associated with the contract pricing of 1449. For the margin factor of the sequence, the engine fetches the previously stored values for base cost and base price and calculates a normal 225 value for margin as if the sale was conducted according to the current date pricing formulas.

Bundled Pricing

Bundled pricing refers to pricing products based on other products ordered with them as a package or bundle of products. Companies often bundle popular items with less popular items in order to “move” the less popular items that otherwise might not get ordered. Typically, a buyer receives more favorable item pricing if they order a bundle instead over ordering the same items separately. For example, if products A, B, and C are ordered together, the buyer may get a better item price for item C than if he had purchased it separately from items A and B.

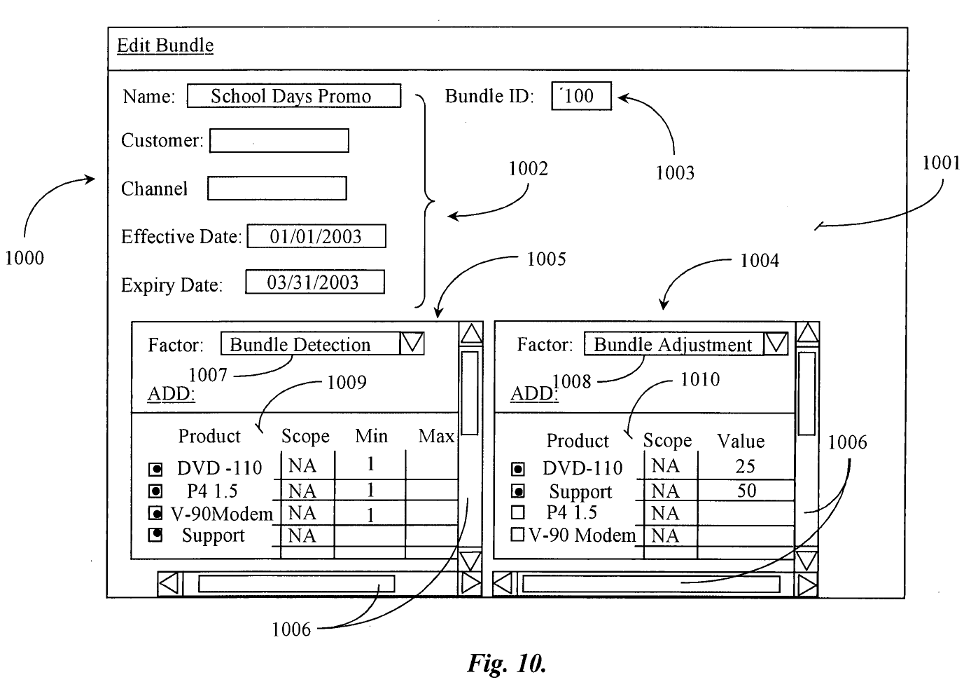

FIG. 10 is a screen shot 1000 of a bundle creation and editing interface accessible through main interface 700 of FIG. 7. Interface 1000 can be invoked through interaction with the selectable option “Bundle” from the option list of interface 700 of FIG. 7. Interface 1000 has a resident face 1001 containing fields 1002 for entering the Name, Customer(s), and Channel(s) to which the bundle will apply, and the Effective and Expiry dates of the bundle. A field 1003 is provided for listing a bundle ID, in this case ID 100.

Interface 1000 has an editing window 1005 for specifying specific products and quantities for the bundle. A second editing window 1004 is provided for the purpose of specifying the particular adjustment values that are applied to the specific products that will receive pricing adjustments.

There are two special purpose factors that are created for bundling. These are a bundle detection factor and a bundle adjustment factor. A bundle detection factor specifies the minimum and maximum quantity constraints in the rules for each product or product category specified in the bundle. Referring now back to FIG. 8 (form for creating a factor), a created factor is specified as a bundle detection factor when its “operation type” field is set to “Bundle”. This action automatically sets the condition variable type field to “Quantity”.

Referring now back to FIG. 10, window 1005 has a field 1007 for selecting which bundle detection factor to use when creating a bundle. A scrollable screen 1009 is provided within window 1005 for enabling selection of which enterprise products to include in the bundle and for specifying the minimum and maximum purchase quantities required for bundle pricing qualification. In this example there are 4 products in a column for products that are selected as part of the bundle. A minimum quantity of 1 is specified for each product selected to be in the bundle. Support has no quantity attribute because it is a service. The service support however is included and customers are required to purchase the support service in order to receive bundle pricing in this example. Screen 1009 is a scrollable screen in this example using scroll control bar 1006.

Interface 1000 has an editing window 1004 provided for the purpose of identifying the products of the bundle that will receive value adjustments and for specifying those values. Window 1004 has a field 1008 for selecting the appropriate adjustment factor to use with the particular bundle factor selected in window 1005. The bundle adjustment and bundle detection factors are a cooperating pair. Window 1004 has a scrollable edit screen 1010 having a product column, a scope column, and a value column. The products of the bundle selected for the bundle in screen 1009 are selected only if they are to receive a value adjustment. In this case the products DVD-110 and Support are selected. The scope column is not applicable in this example because this bundle is for product-based pricing and not for scope-based pricing. For each selected product, its adjustment value is input into the value column.

The pricing engine uses the bundle adjustment factor to determine the type of price adjustment and which factor in a pricing sequence to apply the adjustment. The pricing rules created for this factor specify the adjustment amounts to apply to the qualifying products. Referring now back to FIG. 8, when the bundle adjustment factor is defined to use the bundle detection factor, the operation type field (see FIG. 8) must be set to any of the appropriate arithmetic operations, % decrease, % increase, addition, subtraction, multiplication, or division.

The type field of the bundle adjustment factor must be set to “Bundled”, and the condition variable field must be set to factor and specify the associated bundle detection factor to use. Bundled pricing may be practiced for either product-based pricing (scope flag off) or product-scope pricing (scope flag on).

Referring now back to FIG. 10, the adjustment value of 25 is assigned for DVD-110 for this particular bundle and the value of 50 is set for the support services included in the package. The values will apply to the particular operation type of the selected adjustment factor listed in field 1008.

In the case of bundle creation, the pricing engine can automatically generate the pricing rule sets that will apply to the bundle. The pricing engine only creates rules based on what is entered (rules) in the Pricer manager. So no rules are automatically created-only ones defined in Pricer manager. Multiple rules may be created to use the same bundle adjustment/detector pair of factors. In a preferred embodiment one pair is used to handle the entire bundle pricing needs of the enterprise. However that is not to say that more than one factor pair cannot be used to define a bundle.

Each bundle rule created for a bundle detector/adjustment pair specifies the bundle ID. The bundle ID is used to identify a set of bundle rules for the operation of qualifying rules and for the operation of resolving rule conflicts between different groups or sets of bundle rules. The bundle ID is assigned to the “value” field in bundle detection rules and to the “Min/Max” fields in the bundle adjustment rules. Refer to FIG. 4 element 403 (pricing rules) to identify the appropriate data fields for the bundle ID.

Each bundle rule also specifies customers that qualify to receive the bundle; channels that qualify for the bundle; effective and expiry dates for offering the bundle; the products and/or product categories that must be included in a pricing request to qualify for receiving the bundle pricing; and the pricing adjustments that are to be applied to each product in the bundle that will receive adjustments. Since all of these parameters are known to the system before the rules-sets are generated, the pricing engine can generate all of the rule sets for each pricing factor. Again, no rules are “automatically” created. They are defined in Pricer manager and translated by the Pricer engine.

Conflict Resolution (Bundle)

There can be many sets of bundle rules created for a single bundle detection factor as previously described above. All of the rules created for a particular bundle detection factor have the same assigned value, which is the bundle ID value. For example given a bundle with ID 100, all rules for that bundle will have the ID 100 assigned in the appropriate rule fields.

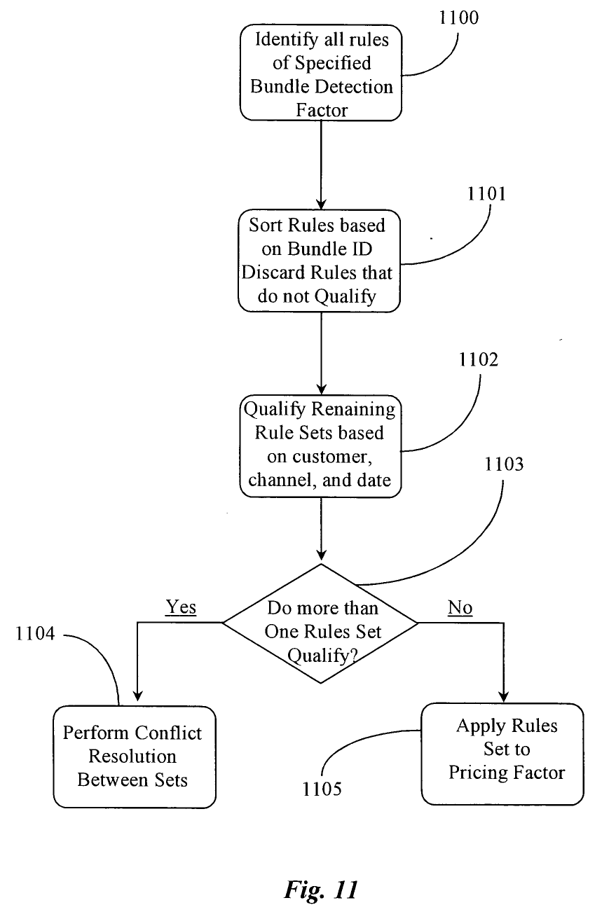

FIG. 11 is a process flow chart illustrating steps for qualifying bundle detection rules for a bundle detection factor. At step 1100, the pricing engine identifies all of the rules for a particular bundle detection factor that include the specific bundle item that the engine is pricing including if applicable, any of the item's ancestor categories in the product hierarchy.

At step 1101, the pricing engine sorts through the rules based on the bundle IDs assigned to each rules value field and discards any rules specifying products and quantities that are not included in the order being priced.

At step 1102 the pricing engine qualifies the remaining rule sets based on customer, channel, and date specifications. Within each set of remaining rules the values for customer, channel, and date must match the order values or the entire rules set is discarded.

At step 1103, it is determined whether one set of rules or more than one set of rules with the same bundle ID has qualified to set the factors value. If at step 1103 there are more than one qualifying set of rules, then at step 1104 the pricing engine performs conflict resolution between the sets of rules using the conflict resolution order specified in the factor. It is noted herein that conflict resolution in the case of bundling is performed only on different sets of rules for different bundles and not within a set of rules for any given bundle detection factor.

If in step 1103 there are not more than one set of rules that qualify then the pricing engine applies the set of rules to the pricing factor at step 1105. In this step the pricing engine assigns the bundle ID value of the winning rules set to the bundle detection factor.

In conflict resolution for bundles, the pricing engine skips resolving conflicts between rules sets based on product because several products can qualify for a bundle. It also skips conflict resolution based on attribute because all bundle detection rules are based on a quantity attribute. Customer, channel, date, and value are the criteria for conflict resolution for bundle detection factors. If conflict resolution does not provide a tie breaker after applying the customer, channel, and date criteria then the value criteria is used to break the tie according to what value state that the detection factor is set to (higher or lower). Which ever is true, the pricing engine assigns the highest or the lowest value (Bundle ID). If there are no rules sets that qualify then the pricing engine simply assigns 0 as a value for the detection factor. After the process as described herein is complete including any required conflict resolution, the pricing engine performs rule qualification and, if required, conflict resolution for the associated bundle adjustment factor.

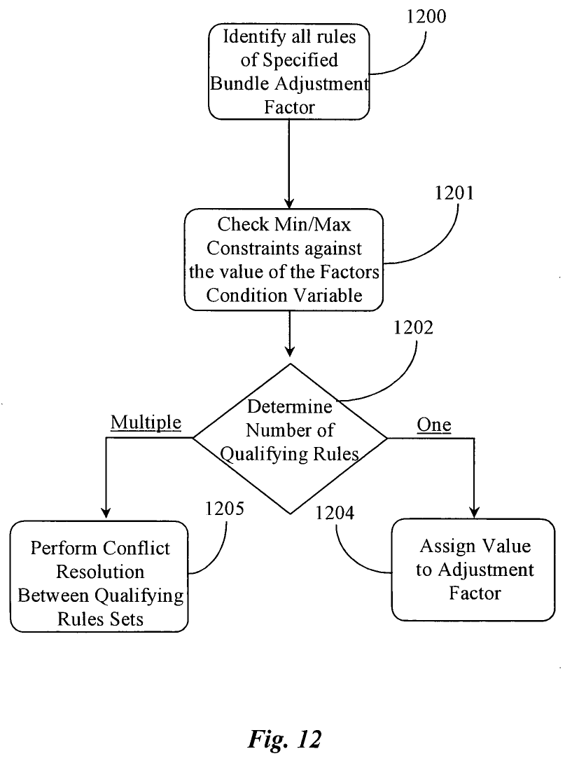

FIG. 12 is a process flow chart illustrating steps for qualifying bundle adjustment rules for a bundle adjustment factor. At step 1200 the pricing engine first identifies all of the rules for the adjustment factor that include the particular product, or product categories as described for detection factors with reference to the process order of FIG. 11 step 1100. At step 1201 the pricing engine checks the Max and Min constraints of each rule against the value of the specified condition variable of the factor, which is the value assigned to the associated detection factor.

At step 1202 the pricing engine quantifies the number of matching rules. If at step 1202 only one adjustment rule is found to exactly match the value of the bundle detection factor then at step 1204 the pricing engine assigns that value to the bundles adjustment factor. It is noted herein that the bundle detection rules should be qualified first as described above with reference to FIG. 11.

At step 1202 if more than one adjustment rule is found that matches the bundles detection factor value then the process resolves to step 1205 for conflict resolution. Conflict resolution is performed according to the factors specified in the conflict resolution order of the factor.

In conflict resolution of rules for an adjustment factor, the pricing engine does not resolve conflicts based on attribute because the attribute assigned to all of the rules for the bundle adjustment factor is the same (the associated bundle detection factor value). The pricing engine does perform conflict resolution based on customer, product, channel, date, and value.

If no rules qualify to set the adjustment factors value then depending on the definition of the adjustment factor the pricing engine “assigns either the value from the previous factor in the pricing sequence”, or the value of the bundle adjustment factors specified “from factor”. It is noted herein that the value of the “from” factor could be the previous factor in the sequence.

Tiered Pricing

The software of the present invention, in addition to enabling product-scope pricing and contract pricing, also enables tiered pricing, sometimes termed “stair-step” pricing in the art. Tiered pricing involves breaking down the quantities ordered for a product item and pricing the item based on those quantities fitting into specific quantity ranges. It is a vehicle that allows volume-discounting structures.

Using the previous contract pricing example of an LX P4 1.5 Laptop computer assume that there will be a volume discount of 5% for the first 9 computers ordered, a 10% discount for an additional 15 computers ordered on the same order, and a 15% discount for the next 25 or more computers ordered.

According to a preferred embodiment, the pricing engine (PS 111 FIG. 1) uses a weighted algorithm for computing such tiered pricing. If an order for 30 computers arrived using the tiered pricing structure listed above, the weighting algorithm renders a % figure that reflects a weighted average over all of the computers. The method is continued below.

| Quantity | | Discount (%) | |
|---|---|---|---|
| 9 | * | 5 | = 45 (value) |
| 15 | * | 10 | = 150 (value) |
| 6 | * | 15 | = 90 (value) |

The sum total of the discount values multiplied by the individual volume values for each discount is 285 (45+150+90). The sum total is then divided by the total quantity of computers ordered (30). The average value for each computer on the order then is 9.5. The average value is represented as a percentage of discount reflecting a percent average of discount for the total number of computers ordered or 9.5%.

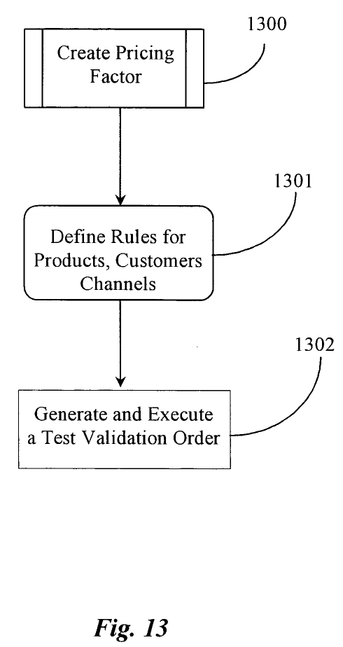

FIG. 13 is a process flow diagram illustrating basic steps for setting up a tiered pricing scenario. At step 1300, a pricing factor definition is created for the factor that will be involved in the tiered pricing structure. For the example above, the factor created is a volume discount factor. The process of creating a factor is generally followed as discussed with reference to FIG. 8 above using the appropriate interactive form 804 and the offered fields. One with skill in the art can generally follow the order of field in form 804 of FIG. 8 to visualize this example.

Part of step 1300 is selecting the operation type of the factor, in this case, % Decrease. Specifying the “From Factor” as “The previous factor in sequence” is appropriate. Condition variable “Type of Attribute” must be selected with the condition variable being quantity. “Tiered” must be displayed in the Factor Type field. Specify the remaining factor fields as normally required.

At step 1301 the rules for the factor are defined for the appropriate products, customers, and/or channels. For the purposes of this example, the following rules are created:

1. Volume Discount; LX P4 1.5; All; All; Jan. 01, 2002; Dec. 31, 2002; Qty range Min.=0 and Max 9 with a Value of 5 (assigned during run time).

2. Volume Discount; LX P4 1.5; All; All Jan. 01, 2002; Dec. 31, 2002; OTY range Min.=10, Max=24, with a Value of 10.

3. Volume discount; LX P4 1.5; All; All; Jan. 01, 2002; Dec. 31, 2002; Qty. Min.=25; Max=infinity, with a Value of 15.

All of the just-listed rules are identical to each other except for differences in values and attribute ranges (quantity ranges).

At step 1302 a text order reflecting a stated quantity of computers is generated as a test validation tool. Note that no conflict resolution occurs; rather the pricing engine fires all of the rules for that particular factor (volume discount) and determines the weighted value as previously described. However, in an unusual case where rules may have conflicting ranges such as perhaps, a rule missing an intermediary range; ranges between rules that overlap; or ranges that are open ended on one end of the range, a type of conflict resolution takes place. For example, the range conflicts are resolved by an additional master rule that governs priority setting for tiered rules.

To further illustrate, if one of a set of rules is missing an intermediate range not covered by any other rule in the set and no value in another range rule can be set for that range rule than the pricing engine assigns a 0 value for that particular missing range according to a master rule. If a missing range as described above can be covered in another rule that has an open end on one side of its range, than the missing range is covered by the value of the rule that covers it by open ended instance either at the MAX or MIN side of the range. As such rules with an open ended range side take priority over any rules that are totally open ended with respect to range. For rules that have overlapping ranges, the rule with the smallest range takes precedence according to master rule.

The pricing system of the present invention can be practiced in an automated fashion over a local, or wide area network including the Internet network and any sub networks connected thereto. A wide variety of platform interfacing systems can be adapted through API to send pricing requests to and receive pricing results from the pricing system of the present invention including but not limited to Web portals, Wireless Gateways, CTI-Telephony Switches gaining access through network bridging techniques; Web servers; Alternative Computing Platform GUIs, and so on. The methods and apparatus of the present invention apply not only to product-based pricing, but also scope-based pricing, contract-based pricing, tiered pricing, and bundle pricing scenarios. Likewise, the system of the invention can be adapted for different client needs like automated business-to-business pricing communication, internal operative requirements for list generation and reporting, client to business pricing communication for automated order placement, and so on.

In one embodiment of the present invention, the system is adapted for provision of automated pricing based on client-configured models for items that can be accessorized in different ways. For example, a client operating an enterprise-provided product/service configuration application from a remote interface can create and submit various configurations of a product like an automobile for example, and receive the updated pricing information for the product in its various configurations. An example would be to configure an automobile with basic features including color, engine type, etc. and receive a price based on the specific configuration and then to add certain offered accessories like a sun roof navigation system, etc. and receive the updated pricing for the automobile having the specific accessories.

Deal Management

According to another aspect of the present invention a unique user interface application is provided that relies on a special set of factors and rules to extend automated pricing to provide certain optimization of product distribution strategies and other deal related advisories.

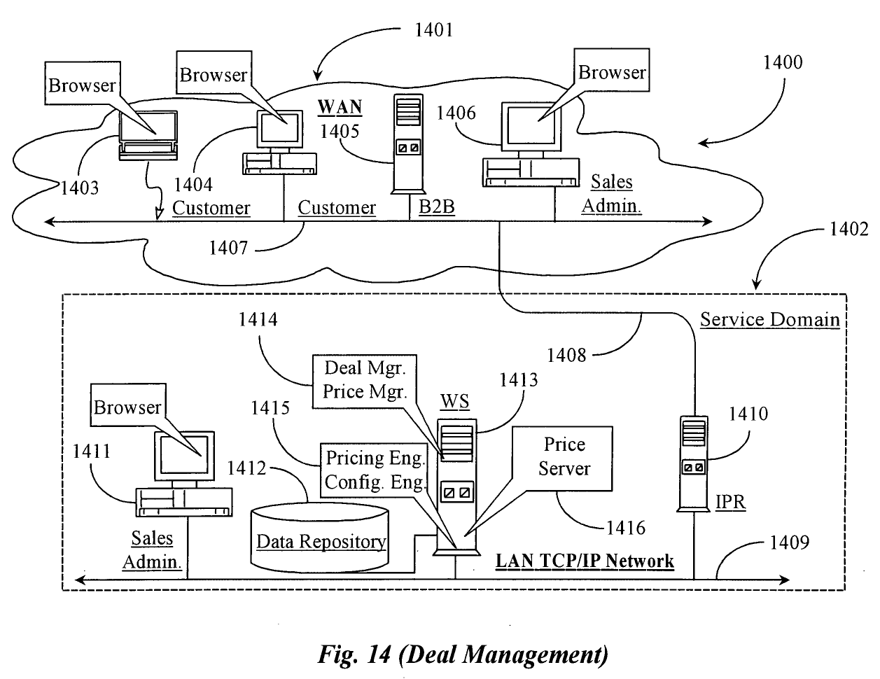

FIG. 14 is an architectural overview of a communications transaction environment 1400 practicing deal management according to an embodiment of the present invention. Transaction environment 1400 includes a wide-area-network (WAN) 1401 analogous in description to the WAN architecture defined by Internet backbone 103 described with reference to FIG. 1 above. WAN 1401 is in a preferred embodiment, the well-known Internet network including any applicable sub-networks. WAN 1401 has a backbone 1407 illustrated as a double arrow extending through the cloud icon representing WAN 1407. Backbone 1407 includes al of the lines equipment and access points making up WAN 1401 as a whole. Therefore there are no geographic limits to the reach of transaction environment 1400.

A service domain 1402, which may also be thought of as an enterprise domain offering products and services is illustrated in functional association with WAN 1401 by way of a data access line 1408 extending from backbone 1407 to an Internet Protocol-capable Router (IPR) 1410 illustrated within domain 1402. Domain 1402 has a local-area-network (LAN) 1409 disposed therein and adapted to facilitate TCP/IP and other Internet network protocols. When LAN 1409 has communication access to WAN 1401, the two networks may be considered as one network (The Internet) in this example. Therefore server nodes connected to LAN 1409 within domain 1402 may be assumed to be We-based servers or otherwise adapted to the type of WAN that domain 1402 has access and connection to.

Service domain 1402 has a Web server (WS) 1413 illustrated therein and shown connected to LAN 1409 for communication and access. WS 1413 serves electronic information and is adapted to serve the information as HTML and/or other known mark-up languages. WS 1413 replaces WS 104 described with reference to FIG. 1 above in terms of being a client access point for services. WS 1413, in this case is a Web-server operating from an active LAN network, however it is not required to be LAN connected in order to practice the present invention. Server 1413 may instead be provided directly connected to WAN 1401 and accessible from domain 1402 through access line 1408.

WS 1413 has an enhanced a management software application 1414 provided therein and executable there from by remote access. Application 1414, in this case, includes all of the functionality described with reference to the Pricer Manager application (PM) 114 provided to node 113 of FIG. 1 above and is enhanced with a user interface application adapted to enable deal management and construction. Both management interface applications are indicted by label (Deal Mgr. Price Mgr.) in box 1414. It is noted herein that the price mgr. Portion of application interface 1414 is enhanced over PM 114 described with reference to FIG. 1. It is also noted herein that software 1414 may be separated in terms of the portion used to manage deals and the portion used to manage pricing with out departing from the spirit and scope of the present invention. Integration is illustrated herein as a matter of convenience in operating function only.

WS 1414 has in addition to interface 1414, a price server application 1416 and an integrated pricing and configuration engine 1415 provided thereto and executable there from by remote access. Application 1415 is analogous to PCA 107 and PS 111 described with reference to FIG. 1 above accept that in this example pricer server functionality represented by server application 1416 is illustrated separately. In actual practice any form of compartmentalization can be practiced in terms of pricing products and services, configuring product orders, and serving pricing result in the form of generated quotes to clients or the a sales administrator.

WS 1413 has a data repository 1412 accessible thereto either by way of LAN 1409 or direct line connection as illustrated in this example. Repository 1412 logically represents all of the data storage requirements of the system of the present invention. Data models, pricing rules, attributes, factors, product, customer, and customer channel data, etc is stored in repository 1412. Repository 1412 can be part of a legacy system or one or more new scalable servers. There are many possibilities.

The software of the present invention applications 1414, 1415, and 1416 is a software suite that can be manipulated by customers, sales personnel and administrators through various interfaces. For example, deal mgr, and price mgr. (1414) can be operated as separate but linked applications or as a single integrated application. Considerations for users provide the preferred embodiment of operation as separate applications requiring login procedures. Further login procedures may be segregated for differing types of users such as customer login, sales login, or administrative login. Likewise, the segregation will provide differing views and functionality for each type user.

A desktop computer 1411 is illustrated within domain 1402 and is connected to LAN 1409 for communication. Computer 1411 is adapted as a workstation used by either a sales representative or by a sales administrator. A representative as defined herein is one who functions in the capacity of a sales agent facilitating sales of the enterprise. An administrator is defined herein as one who functions in the capacity of managing the efforts of sales agents. Station 1411 has access to WS 1413 physically over LAN 1409 using a standard Web-browsing application illustrated herein as a block labeled Browser associated with desktop 1411. WS 1413 is Web-based in this example and a Web-browser is the most common tool for access using normal Internet TCP/IP protocols. Although Web-based access is illustrated as a preferred example, it should not be construed as a limitation.

The browser associated with station 1411 may in one embodiment be enhanced with a client-plug-n application designed to enable access to only a specified portion of the functionality of the software based in WS 1413. In another embodiment security and restriction to certain functionality is achieved through login procedures and SSL connection and no plug-in is required for full operability.

Operating from station 1411 a sales representative, for example, accesses application 1414 to monitor existing deals and to create new deals for eventual presentation to potential clients. A sales administrator, on the other hand, would likely manage and create pricing elements and may have supervisory views into the activity records of the sales administrator. The actual operability level afforded to an agent or to an administrator can be tailored in virtually any fashion.

A desktop computer station 1406 is illustrated within WAN 1401 connected to backbone 1407. Station 1406 is adapted as a sales/administration station as described with reference to station 1411 within service domain 1402. The provision of station 1406 is intended to illustrate that sales and administrative personnel can gain access to the software of the present invention based on WS 1413 from a location remote to service domain 1402, more particularly through typical Internet-access conventions. Person operating station 1406 would gain access to server 1413 in the same fashion as on operating station 1411. However, station 1411 could still gain access to server 1413 if line 1408 or router 1410 for some reason suffered a fault or performance degradation resulting in loss of connectivity between LAN 1409 and Internet 1401.

A customer computer station 1403 is illustrated within WAN 1401 and is connected to backbone 1407 by way of a wireless carrier. Station 1403 can be a Laptop computer or another type of Internet-capable or network-capable communications device like a PDA, a cellular telecommunications device, or another device having a browser application and network-access capability. A customer computer station 1404 is illustrated within WAN 1401 and is connected to backbone 1407 by way of typical Internet line access using modem dial-up, cable modem, ISDN, or DSL, which are al well-known network access conventions.

Customer stations 1403, 1404 and sales/administration station 1406 all use Web-browser applications to access server 1413 to interact with the system of the present invention. However, customer stations just mentioned would access order configuration and pricing information enabled for Web service by software suite portion 1425 and 1416, more particularly server 1416 actually serving the information. Sales/Administration personnel represented by stations 1406 and 1411 use Web browser functionality to access information and manipulate information enabled by software suite portion 1414 and 1416, server 1416 actually serving the information.

A business-to-business (B2B) server 1405 is illustrated within WAN 1401 and is connected to backbone 1407. B2B server 1405 is adapted as an automated business portal through which a client business can conduct transactions with enterprise domain 1402 through an API (not illustrated), which is analogous to API 121 described with reference to FIG. 1. API functionality and design enables any business having on-line access to set-up automated transaction processing and recording with domain 1402. Long contract arrangements forged between to companies would be an example of the type of transacting performed in server 1405. A sales agent or administrator operating from station 1406 or from station 1411 can access application 1414 to administer and, in some embodiments, fine tune such long term periodic transacting to maximize goals of the providing enterprise and or to better meet the goals of the receiving or client enterprise.

A goal of the present invention is to primarily provide sales agents and administrators with semi-automated and automated tools for optimizing quoting capability and response time, product distribution strategies over multiple periods, product selection strategies, and product discount strategies. The new functionality is enabled by a novel set of pricing factors termed advisory factors or deal factors by the inventor that are designed to function in cooperation with exising pricing factors to extend the capability of the system of the invention to provision of optimized deal scenarios, and product placement and distribution strategies based primarily on certain goals of the provider enterprise related to revenue, profit margin, cost reduction, customer budget concerns, and inventory management issues.

Advisory factors, unlike standard pricing factors, do not have numerical return values and cannot be used as from factors in a sequence for another factor. Rather, they return a set or list of data structures that advise a sales agent or administrator of some option or a set of options available for optimizing a deal scenario whether it is a discount option, a product selection option, a product substitution option, or a product distribution option. Advisory factors including rules and attributes associated with them form the underlying functionality that enables a deal management interface, which is described in various examples to follow.

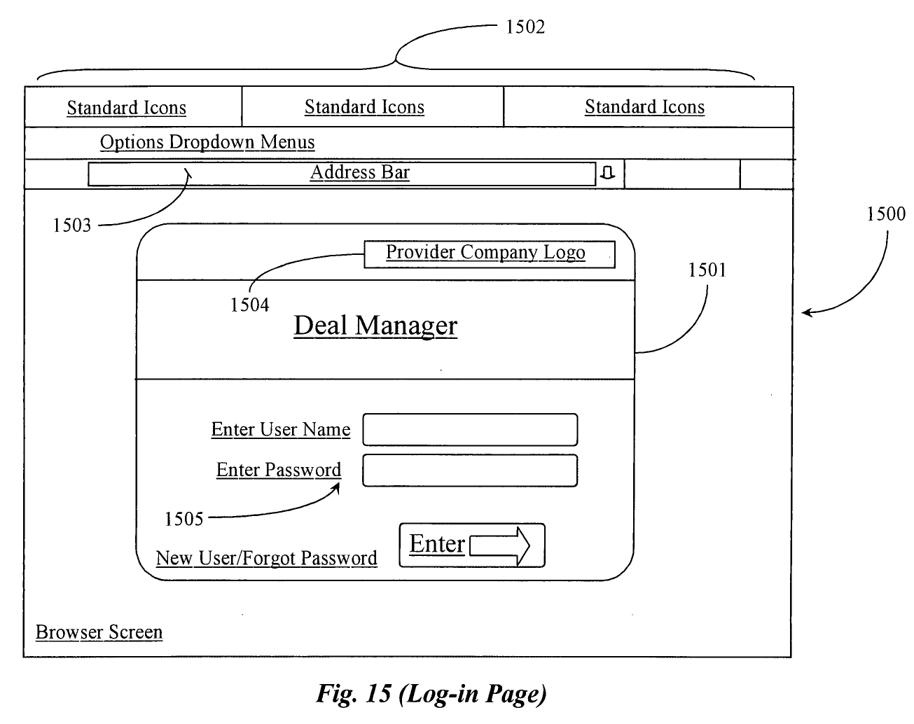

FIG. 15 is a plan view of a browser interface 1500 displaying a deal management login page 1501 according to one embodiment of the present invention. In a preferred embodiment screen 1500 is a browser screen shot typical with an HTML display, however, other Web-based display languages may also be used such as WML among other well-known display mar-up languages. The browser hosting screen 1500 may be any of the well-known programs for navigating the network like Internet Explorer™, Netscape Navigator™ and others. As such, there are standard icons providing functionality illustrated herein as standard icons 1502 typically known to browser applications. Also, the standard and well-known drop-down-menu options are represented herein by label as Options Dropdown Menus under icons 1502. Also typically provided is a navigation address bar illustrated herein as address bar 1503 for typing in and then navigating to URLs.

In this example, a provider login page 1501 is illustrated and primarily labeled herein as Deal Manager. Page 1501 represents a UI login interface provided to access software functionality provided by deal management software 1414. Page 1501 has a placeholder 1504 for configuring a provider company logo that displays when the page loads. Login page 1501 has field boxes 1505 for entering name and password information. It is noted herein that a login screen or page like 1501 may differ in appearance for differing users like sales personnel and administrative users. Users (sales, administrators) operating stations 1406 and 1411 access login page 1501 to login for the purposes of managing or administering deals. Typical of standard login pages, a new user/forgot password option is provided and an enter link for accessing after information is provided. SSL or other security connections protocols may be assumed to be in effect.

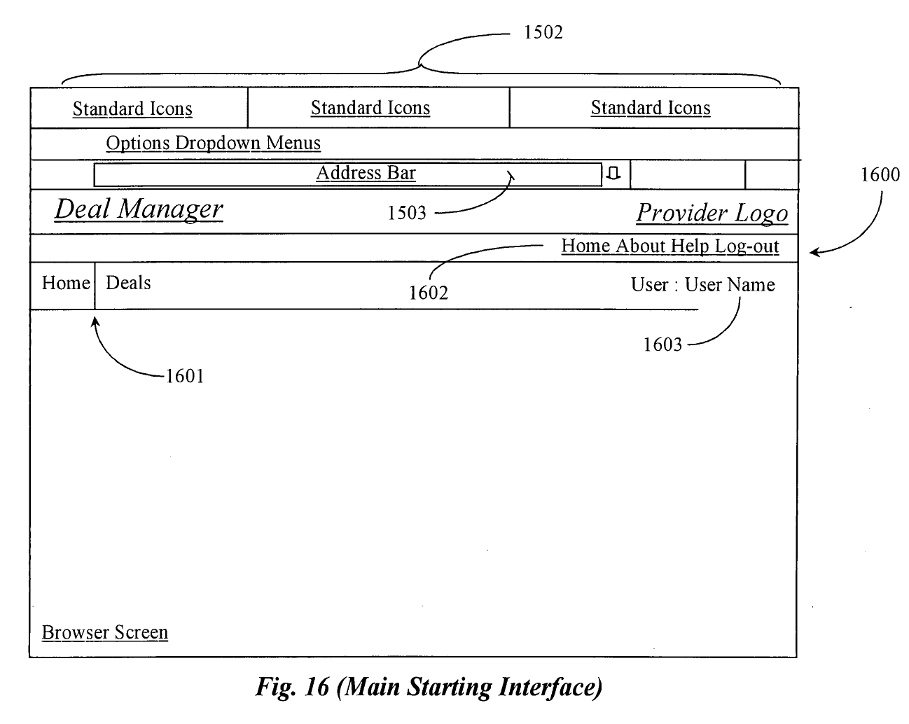

FIG. 16 is a plan view of a start page 1600 displayed after logging in to page 1501. Screen 1600 has standard icons and dropdown menus 1502, and address bar 1503, which are visible and accessible throughout interaction with the deal management service portion of the software of the invention. Page 1600 has a selection option 1601 linking to a home page (Home) and a deals page (Deals). Selection options 1602 comprising options for navigating to home, about, help are provided as well as an option for logging out. While working with the deal management service a user name 1603 appears indicating the current user logged in to the service. By selecting the “Deals” option a user has access to deals information.

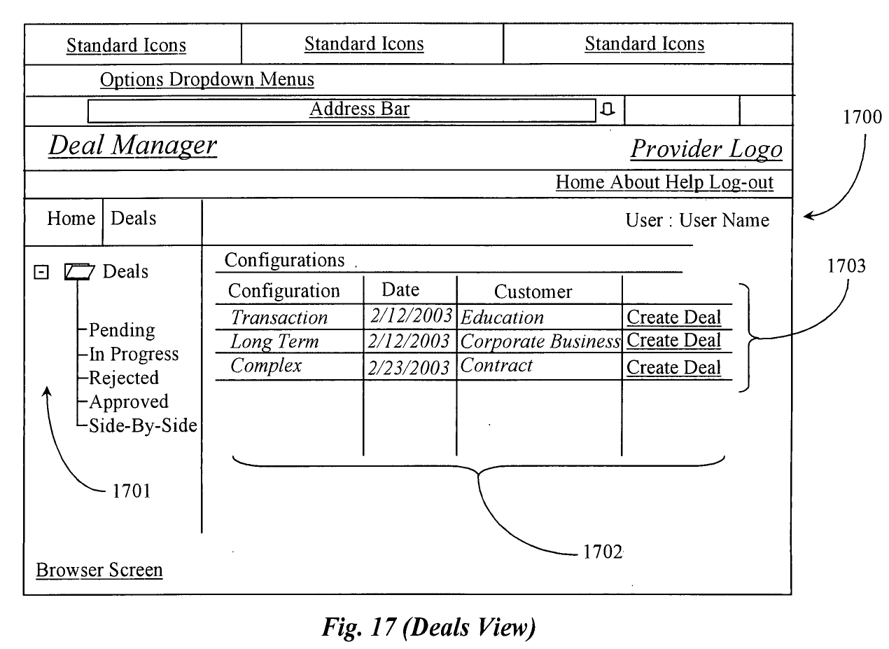

FIG. 17 is a plan view of a deals view page 1700 accesses by selecting the deals option in FIG. 16. Deals view 1700 is a divided page illustrating a deals navigation tree 1701 at far left and a deals list window 1702 displaying basic summary information about deals listed. Navigation tree 1701 contains options for viewing pending deals, deals in progress (still being worked on), rejected deals, approved deals, and an option for viewing deals configurations side-by-side in comparison.

Depending upon the option selected from navigation tree 1701, deals information is displayed for view in window 1702. Deals information displayed in window 1702 is organized as an information block containing columns 1703 and rows 1704. The information shows configurations, which may be though of as deals in progress. The basic summary information includes column headings configuration, date, customer, and an option for create deal. Each row 1704 described one deal in the system. For example, in the first row the configuration is labeled Transaction entered on Feb. 12, 2003, under a customer channel of Education. The next listed configuration is Long Term entered on Feb. 12, 2003 under the customer channel of Corporate Business. The next listed deal is labeled Complex entered on Feb. 23, 2003 under the customer channel Contract. A column 1705 at far right has selection options (one per row) for creating a deal (Create Deal).

In this view there are only 3 configurations listed however one with skill in the art will appreciate that there may be many more configurations listed depending on the deals category selected from tree 1701. Standard horizontal and vertical scroll bars may be provided if there are more deal configurations listed than will fit in one screen area. By activating create deal associated with the desired configuration, more detailed information is called up for display.

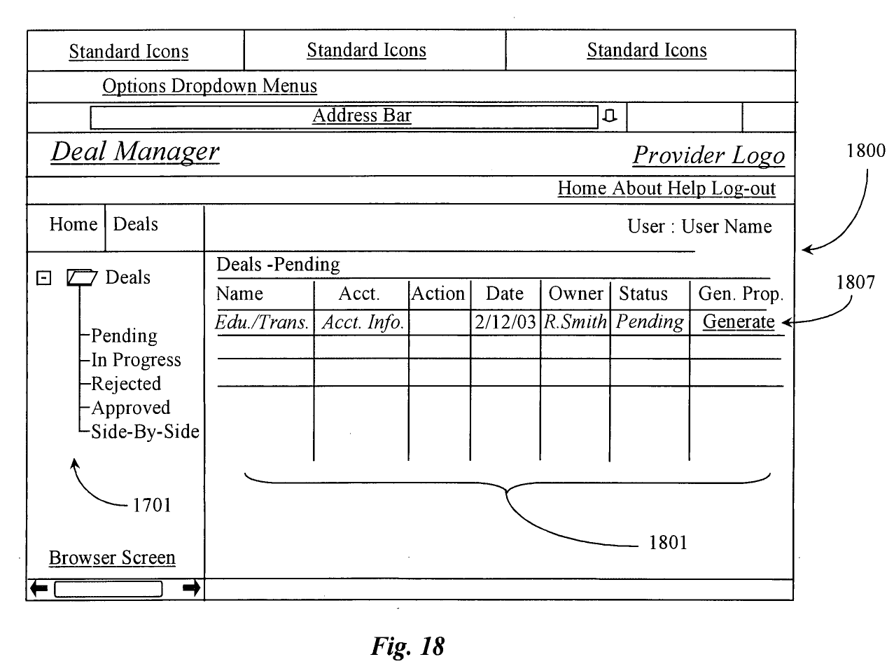

FIG. 18 is a plan view of a browser screen 1800 illustrating a deals pending page and displayed by selecting create deal in FIG. 17. Activating create deal causes display of an information block defined by columns 1801 and rows 1802. In this case a configuration education/transaction is illustrated. The name field (1804) is interactive and activation of field 1804 causes a new window (not illustrated) that displays more detailed scenario data. A second column 1801 has an interactive selection option 1805 labeled account information. By activating this field more detailed account information of the pending deal “education/transaction” is accessed and displayed in a new window. A next column is labeled Action and shows any actions that have been taken related to the deal. The Date column is redisplayed. A column listing the owner or author of the deal is provided as well as a status column, which indicates “status pending” in this particular view.

A user presented with this view can activate options 1804 or 1805 to call up new windows (not illustrated) having editable information fields. A final column 1801 is provided having a selection option 1803 for deal generation, which when activated generates a deal proposal complete with all of the information required to facilitate the deal.

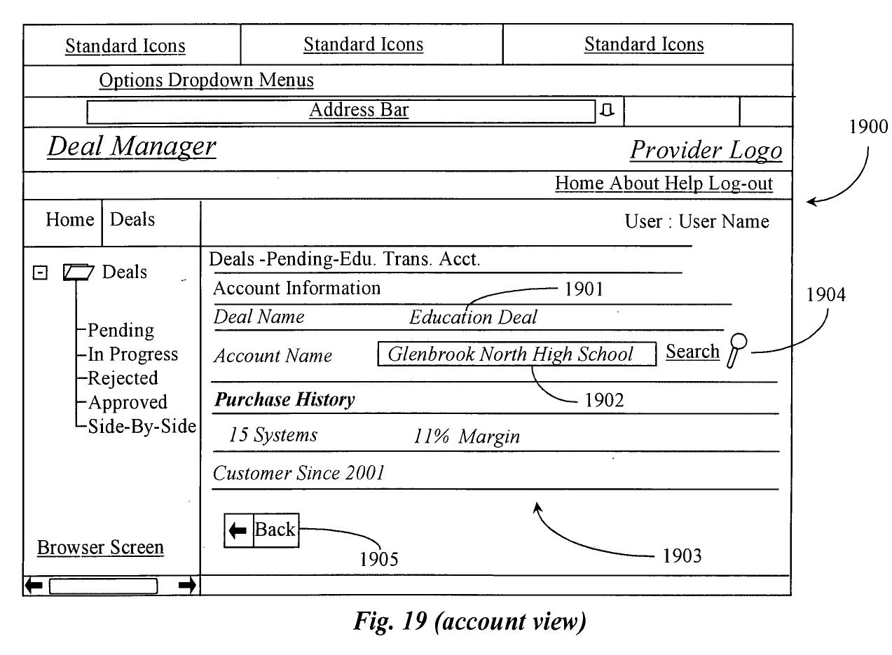

FIG. 19 is a plan view of a screen 1900 displaying an account view as a result of interaction with option 1805 of FIG. 18. Screen 1900 follows a chain of interaction encompassing Deals view, Pending Education deal, Transaction, and Account. A screen area 1903 is dedicated for displaying account information headed by a label Account Information. Under account information is a deal name (Education Deal) 1901. A next field 1902 displays the account name (Glenbrook North High School). An adjacent search option 1904 is provided for searching other education transaction deals.

A field Purchase History is provided wherein it is indicated that Glenbrook High has purchased 15 systems at an 11% margin for the seller and that they have been a customer since 2001. After viewing account information a user can use a provided back button 1905 or the standard browser back icon to get back to a previous interface.

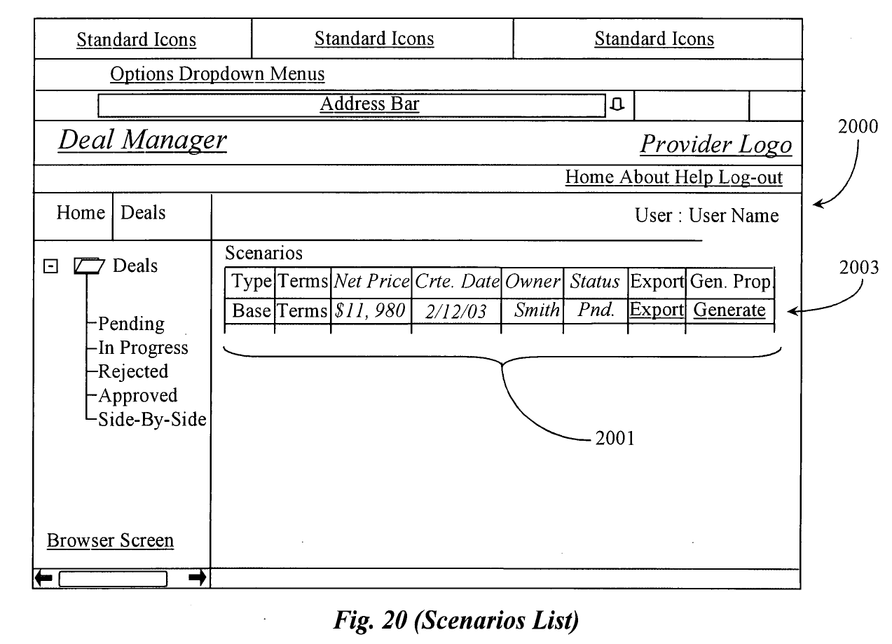

FIG. 20 is a plan view of a screen 2000 illustrating a scenario list of deal scenarios. Screen 2000 displays an information block of columns 2001 and rows 2003 describing deal scenarios. Under the label scenarios columns 2001 list the type of scenario; the terms for the scenario; the net price for the products ordered under the scenario; the creation date of the scenario (Feb. 12, 2003); the owner or author of the scenario (Smith); and the status of the scenario (pending). A next column of columns 2001 contains a selection option labeled Export.

The export option mentioned in the above paragraph enables a user to export the deal information parameters to another application for further analysis or comparison. One such application is the well-known Microsoft Excel™ application. Once the information is exported other operations can be performed on the data using the normal Excel commands and options. A generate deal option is also provided in the final column. Each row 2003 defines one deal scenario. In this example there is only one scenario, a base scenario, listed for one pending deal “Education Transaction”. However, there may be scenarios of other pending deals listed as well as more than one optional scenario of a same deal. If more than one scenario is listed they can be compared side-by-side by selecting the side-by-side comparison option in the deals tree. At least the first two columns of columns 2001 are interactive selectable options wherein if selected call up windows containing more detailed information. For example, activating “Base” scenario causes access and display of the base scenario details and selecting terms causes display of the current terms of the scenario.

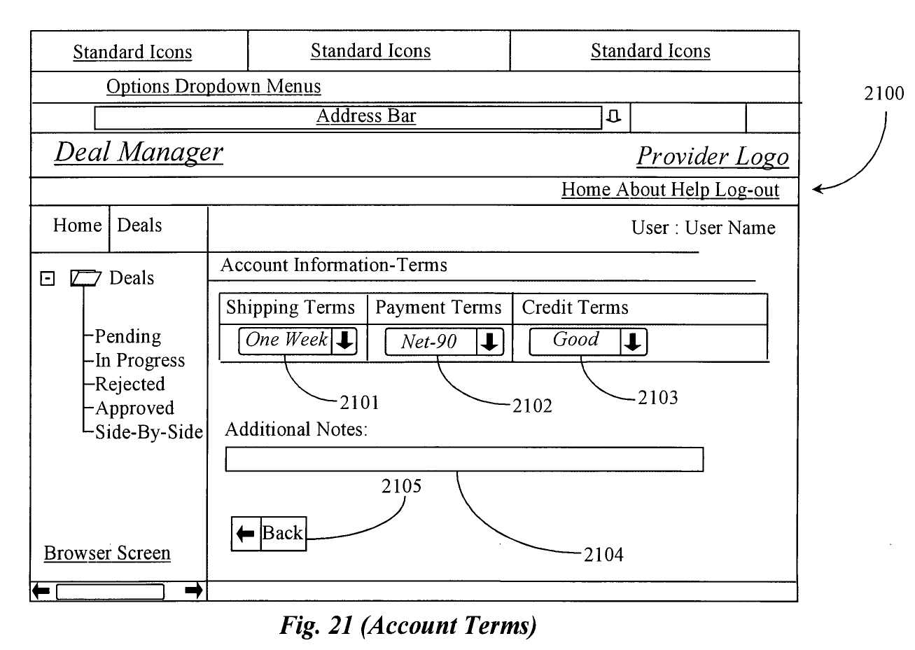

FIG. 21 is a plan view of a screen 2100 illustrating a detailed account of terms of an associated scenario displayed as a result of interaction with terms of FIG. 20. Under account information terms, there are three categories of terms presented in dropdown menus. These are a dropdown menu 2100 for listing shipping terms; a dropdown menu 2102 for listing payment terms; and a dropdown menu 2103 for listing credit terms. For example, for the deal pending with Glenbrook High, the shipping terms are one week, the payment terms are net 90 days, and the credit terms are good with the client indicating that they have no problems with payment An additional text entry field 2104 labeled herein Additional notes, provides a mechanism for entry and future display of any special comments or notes that should be recorded and viewable in the terms view page. A back button 2105 is provided for navigating back to the previous interface.

It is noted herein that some of the information attributes visible in various deal management views are manually entered into the system during deal creation or administrative functions. Many of the attribute values such as net price for example are calculated values provided by a pricing server analogous to server application 1416 described with reference to FIG. 14 above. Some of the terms information like credit history information already exists in a repository analogous to repository 1412, also described with reference to FIG. 14 above. However, if the client or channel is new, information may be first entered into the system through the deal management interface and then can be recalled using the same interface.

A special set of factors are introduced into the pricing schema by the inventor to enable and enhance management of deals that are pending, being created or deals that are already in progress (deals monitored during lifetime of the deal). The introduced factors are categorized as deal factors because they are generally considered after basic pricing factors have been executed and pricing information has been served. The deal factors define certain deal options for scenarios that may be available as deal presentation options or, perhaps, product distribution options for deals that are already in place and active.

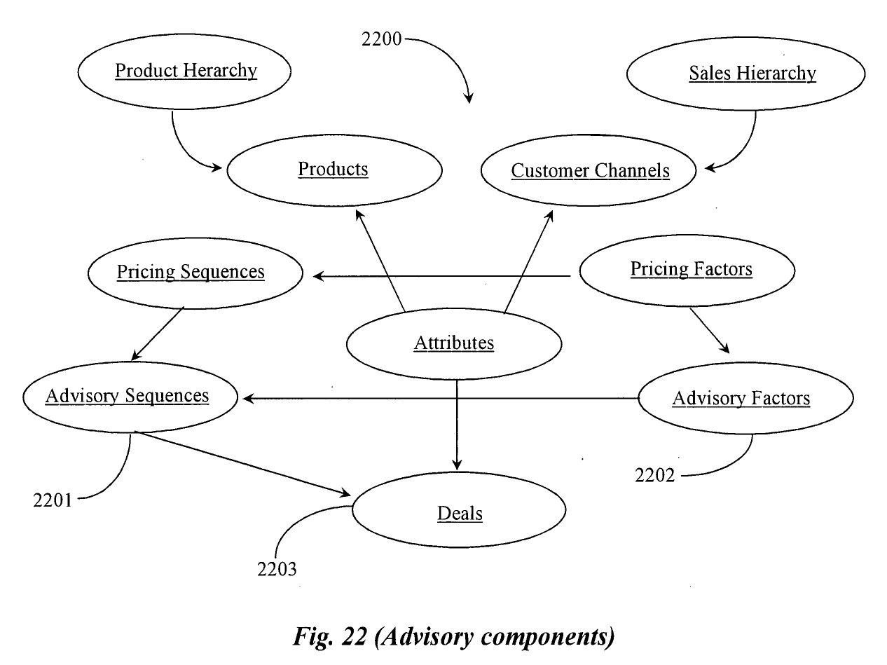

FIG. 22 is a block diagram 2200 illustrating advisory components that are used in deal management according to an embodiment of the present invention. A pricing model previously described with reference to FIG. 2 above, which defines the basic components involved in pricing, is extended in this example with components provided to enable deal management. The basic model includes a sales hierarchy including customer channels and customers, and a product hierarchy of company products. Pricing sequences including item sequences, order sequences use the basic pricing factors and attributes applied to customers, customer channels, and products to automatically figure orders and quotes including discounts based on rules, which are resolved through conflict resolution to insure correct pricing is served for a particular quote or an order.

In this example, a new type of factor 2202 is provided herein and termed and advisory factor. Advisory factors 2202 are a type of pricing factor, however they do not return any numerical values and cannot be used as from factors in a pricing sequence to figure pricing. Advisory factors 2202 do not participate in conflict resolution of applicable rules. For an advisory factor all rules that apply to the factor are fired. An advisory factor returns a list of data structures that are listed according to some ranking factor to aid a sales person or sales administrator in deal creation and management. Depending on the type of factor, the data structures represent options or suggestions for enhancing a deal.

Advisory factors 2202 are also termed deal factors by the inventor and are used, in a preferred embodiment, at the end of an item pricing sequence. In one embodiment they are used in their own separate sequences illustrated herein as advisory sequences 2201. The attributes component of the model is extended to include attributes that are applied to deals. In practice, pricing information is figured for a possible deal being worked on and then options for the pending deal are realized through implementing various advisory factors that indicate deal scenario possibilities and options for maximizing revenue, profit margin, or realizing other company or even customer objectives. More detail on advisory components is provided below.

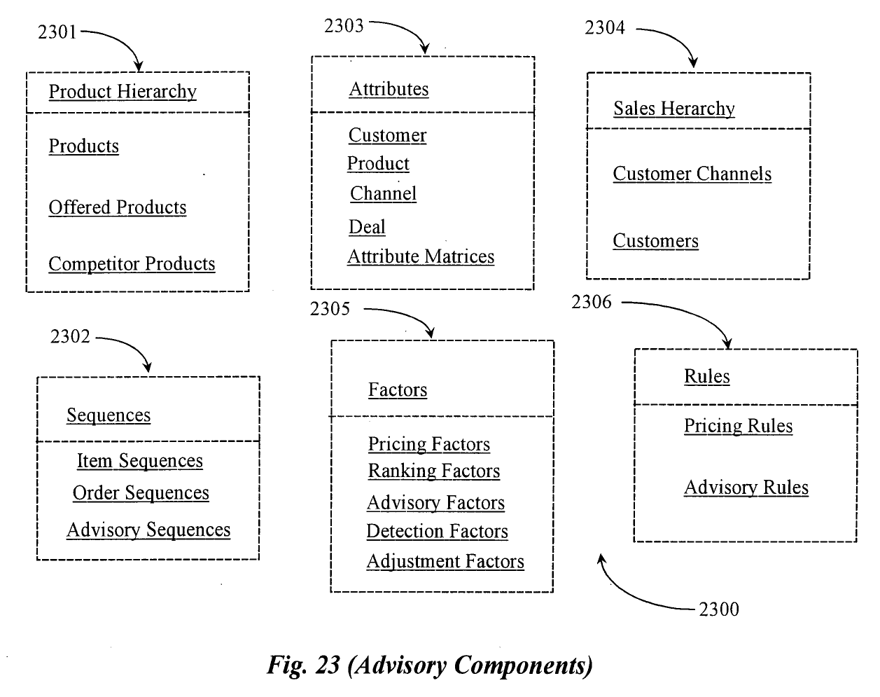

FIG. 23 is a block diagram 2300 detailing some advisory components according to an embodiment of the present invention. A block illustrated herein as a product hierarchy 2301 includes products that are optionally categorized as offered products offered by an enterprise and competitor products known as products offered by one or more competitors of the enterprise. A type of advisory factor termed a competitor factor is provided and used in deal management to return a structured list of competitor products and the associated pricing schemas and information along with corresponding company-offered products of a same or similar functionality and pricing structure. The purpose here is to provide a sales agent, for example, a ready knowledge of competitor product prices and discount structures to use in consideration of company discount strategies when constructing a deal or managing shipping parameters of a contract already in place and active.

A block 2203 labeled attributes is illustrated herein and contains standard customer, product and customer channel attributes. New functionality for managing deals includes introduction of deal attributes and attribute matrices. Deal attributes are associated with deal scenarios and are associated generally with advisory factor types that define deal options. An attribute matrix is a set of multiple attributes that can be consulted during a pricing or advisory sequence using less processor resource than would be the case of processing each sequence according to a single attribute.

A sales hierarchy block 2304 is illustrated herein and includes the standard customer channel and customer identification tree. A sequence block 2302 is illustrated in this example and defines standard item and order sequences described further above. Sequence operation is enhanced by introduction of the advisory sequence. It is noted herein that advisory factors may also be used in item and order sequences (depending on factor type) without existence of an advisory sequence. However, advisory factors may also be applied in a separate sequence containing only advisory factors.

A block 2305 is illustrated in this example and lists factors designed for pricing. The list includes pricing factors, which are applied to items and orders in normal pricing. A factor termed a ranking factor is provided and adapted to cause return of advisory data structures based on some goal-based attribute. A list of possible substitute products related to a substitution bundle deal option, for example, may be presented in a particular order based on a ranking factor of maximize or minimize wherein the goal-based attribute is one of profit margin, revenue, or some other derived goal.

Advisory factors, or deal factors, provide options in constructing deals. One type of advisory factor is an up-sell/substitution factor. An up-sell factor returns a list of one or more products or product combinations that can be substituted for one or more ordered products or combination of products wherein the replacement product or products represent a higher end scenario. One simple example would be a 15″ standard computer monitor and service package could be upsold to a 17″ flat-panel computer monitor and associated service package. The more expensive and higher end 17″ monitor replaces the 15″ monitor in the deal scenario.

Detection and substitution factors associated with detecting available deal types and product combination types (bundles) are provided as well as adjustment factors, which apply to price adjustments. Like pricing factors, advisory factors and associated rules are created using a pricing manager application analogous to the price manager portion of software application 1414. It is noted herein that the UI for pricing management is, in a preferred embodiment, separate from the UI for deal management. In one embodiment, the Web-based pages served are interlinked across interfaces so that a sales administrator, for example, could navigate between the deal management application and the pricing management application without logging out of the Web-based service.

A block 2306 labeled Rules has pricing rules that apply to pricing factors. The rules base relied upon by the present invention is extended to include advisory rules that relate to associated advisory factors. Pricing rules undergo a conflict resolution process before they are fired based on the common attributes contained in the rules and in an associated order. Advisory rules do not undergo conflict resolution because they return ranked data structures representing deal options or product distribution options. All rules associated with a particular advisory factor that have matching attributes to a deal scenario in terms of parameters like quantities, identified products or product combinations and shipping dates are fired. The user receives the results and can choose to apply or not to apply any of the resulting data structures.

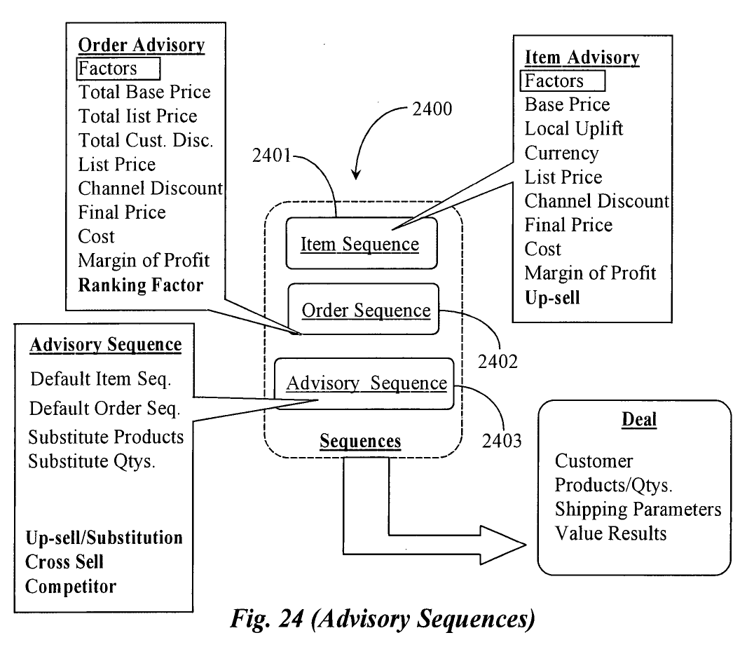

FIG. 24 is a block diagram illustrating extended functionality of pricing sequences 2400 according to an embodiment of the present invention. There are basically three types of sequences used in processing items, orders and for returning deal options. These are an item sequence 2401 previously described for processing single items, an order sequence 2402 previously described for processing an order of more than one priced item and calculating totals, and an advisory sequence, which is not required to practice the present invention, but may be used instead of embedding one or more advisory factors into a standard or default item sequence.

Item sequence 2401 is illustrated in expanded form listing factors including one advisory factor up-sell. The listed factors used in calculation for each item include base price, local uplift, currency, list price, channel discount, final price, cost of provision, margin of profit, and up-sell possibilities. Up-sell calculating involves return of a list of up-sell possibilities and associated quantities and pricing, which may depend in part upon one or more values returned in an item sequence. Therefore it is performed in the sequence after the original item has already been calculated. Any item of the related deal scenario that has one or more up-sell possibilities is previously mapped to the up-sell product or product combination in the up-sell (advisory) rules created by a user.

Order sequence 2402 is illustrated in expanded form listing factors including one ranking factor. The listed factors include total base price, total list price, total customer discount, total list price, any channel discount, final price, cost of provision, margin of profit, and a ranking factor. An advisory factor cannot be used as a from factor in an item sequence.

The up-sell factor can be an up-sell with substitution or a cross-sell factor. Up-sell with substitution replaces one or more original items considered with one or more higher-end replacement products. In a more complex scenario a particular bundle of products might be mapped to a similar bundle of replacement products provided at a higher price to a customer, but also bringing more value or higher performance to the customer that chooses the up-sell option. An up-sell/substitution may involve just one item or more than one item including any associated service packages.

A cross-sell factor involves adding a product to one or more products the added product provided at a greater than normal discount, for example, to help move the added product or to help sell the original products. For example, if products A, B, and C are purchased together then product D can be added to the order wherein product D is discounted at a greater than usual discount.

In this example, item sequence 2401 is considered an advisory up-sell sequence because of the presence of the advisory factor up-sell. Related order sequence 2402 is considered a ranking sequence because it contains a raking factor that will be used to rank the order of the up-sell possibilities returned for the deal. The ranking type is either maximize or minimize and the ranking attributes would be revenue, cost, profit margin, inventory levels, or some other derived attribute. In practical terms the ranking of return results of an executed advisory factor is based on the goal of ranking.

Advisory sequence 2403 is illustrated in expanded form and contains the default item sequence, the default order sequence, any required parameters like mapped substitute products (up-sell/substitution), and the required quantities of those substitutions. The options for the type of advisory sequence can be up-sell/substitution, cross-sell, or competitor. The listed advisory factors should not be construed as a limitation to the present invention as other types of advisory factors might be conceived to aid in maximizing some enterprise or customer goal related to a particular transaction scenario.

An advisory factor uses the default or an identified item to accomplish recalculation of price and discounts using product and/or service grade substitutes for example if the factor is a substitution factor. As a sales agent manipulates scenarios in the creation of a complex deal he or she can run the totals related to the different scenarios and terms and see what effect each scenario will have on profit margin or total revenue. So for an order scenario of more than one item, all of the original items are calculated using the item sequence then the order sequence is calculated. The replacement candidates identified by the advisory factor up-sell in this example are re-calculated in the item and order sequences to produce the final pricing results for the up-sell scenario.

A ranking factor is applied if there are more than one “advisory result possibility” in a list of returned data structures. A ranking factor can be set or flagged to maximize or to minimize. The operation relates to the organization of returned results. For example, in a substitution deal, maximizaton may be applied to return the best result for maximized profit margin followed by the next best result and so on. Minimization might be used in a case where the attribute goal is set to cost. In this case the best result for minimizing cost to the company is returned first followed by the next best result and so on.

Each data structure returned by an advisory factor lists all of the appropriate parameters related to the scenario to which it applies including recalculated item and order pricing, suggested discount structures, resulting margin, revenue, and cost figures if applicable. In this way a user may experiment with the differing scenarios and see how compilation of each scenario may affect company goals such as profit margin. In one embodiment personal compensation structures of the user may also be calculated in each different scenario.

The process illustrated in diagram 2500 begins in one embodiment, with a request 2501 initiated by a user operating a deal manager interface. It is assumed that the user is putting together a deal for a client who has presumably requested a quote for certain products at certain quantities of those products.

The user can request standard pricing and discount information on the original products by executing the pricing model, which runs the standard item and order sequences. After calculation, the user may whish to determine if there are any up-sell scenarios that can be offered by the company. With the original products and quantities displayed in the deal management UI, the user can initiate a request to find a substitution as labeled in step 2501.

An up-sell input block 2502 illustrates the required parameters of the initiated request. Reading now from top down in block 2502 the request must contain all of the products in the deal scenario and the matching requested quantities. All dates of the scenario including shipping dates for partial shipment or contract shipment, order dates or periods, and so on.

The customer channel is identified and the customer is identified. All desired attributes pertaining to products, customers, and customer channels must be provided. A customer channel attribute might be education channel receives a 2% overall discount. A customer attribute might be a requested 3% discount in return for prompt payment. A product attribute might be minimum order of 5 each.

At step 2503, the pricer engine receives the request either directly or through an API depending on the location and platform of the user. The engine processes the request by accessing rules from rules base 2504. The rules map to data held in repository 2505 as illustrated herein by a double-bracketed arrow associating the two repositories. The engine, running the appropriate item and order sequences fires the rules having matching attributes and accesses the appropriate data and recalculates the item and order totals based on the applicable conditions.

Engine output block 2506 summarizes the output of engine processing of the initial request. Reading now from top down in block 2505, the engine outputs a list of all matching substitute products and the acceptable matching quantities. It is noted herein that a particular requested quantity for an item does not have to exactly match a quantity of replacement parts. An advisory rule may have a quantity range specified that the requested quantity falls within. The same is true for dates. In some cases there may be no quantity restrictions at all. The attributes are user designed and can be very flexible.

The engine also provides all of the corresponding item sequence values for the replacement parts identified and the substitution order total values for each substitution scenario. Also provided are the applicable ranking factors of the deal so that the user knows which suggestions have priority. For example, if no appreciable benefit exists for either the company or the client, or both then it does not make sense to offer a substitution deal to the client. It will be apparent to one with skill in the art that advisory factors differ from one another in purpose. Therefore the exact information required to successfully process advisory scenarios that can be presented to customers might also differ according to the factor used. In this case of up-sell, all the applicable rules are fired to return all possible scenarios that exist. A particular requested item can have multiple up-sell substitution options, which may also be affected by bundle rules in a more complex scenario.

In one embodiment of the present invention the deal management interface initiates a substitution detection routine by default to automatically determine if there are any options available. In this case a user does not have to manually initiate a find substitution request to the pricing engine.

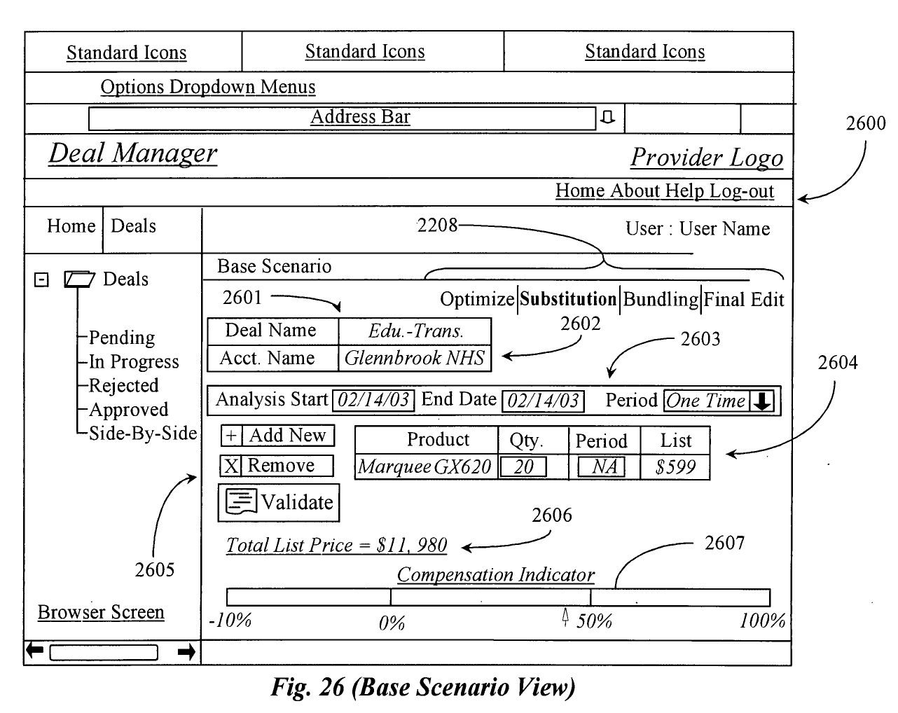

FIG. 26 is a plan view of a deal management screen 2600 illustrating a base scenario deal view and options. Screen 2600 displays a base scenario for a customer deal. A customer information block 2601 is displayed under the label Base Scenario titling the larger display window. Block 2601 has a display line for Deal Name (education-transaction). A similar information block 2602 is displayed and indicates the Account Name (Glennbrook NHS).

An analysis date block 2603 is displayed in the larger display window and has an entry field for begin date (Feb. 14, 2003 and an end date (Feb. 14, 2003). An entry field for Analysis Period is also provided to block 2603. The analysis period indicated is one time or on Feb. 14, 2003. It is noted herein that the analysis period is selected from a drop down menu, which may include options longer than one time or day, for example, 6 months, 1 year, 2 years etc. For contract orders the longer analysis periods would be applicable. An analysis period is the period that a deal is monitored. Of course a one-time order with a single shipping date is analyzed only for a period sufficient to optimize the deal.

A product information block is displayed in the larger window and lists the product as a Marquee computer system GX620 (exemplary). A quantity of 20 systems is requested. An entry field for period is marked as not applicable (NA) because it is a one time order not shipped in portions over a period of time. The item list price for each system is displayed as $599. An Add/Remove interactive option block 2605 is displayed in the larger window and enables a user to add or remove products from this scenario. A validation option is provided as part of interactive option 2605 to enable a user to verify price, availability, and so on.

A total list price for the entire order scenario is displayed as a pricing information line 2606 indicating a total list price for the order scenario of $11,980. Screen 2600 illustrates an order scenario, which has not been optimized or presented to a client. The order scenario of this example represents a pending deal that is being managed for optimization before finalizing the deal and presenting the deal to a customer as a proposal.

A compensation indicator 2607 is provided to indicate to a user the percentage of compensation that the current scenario would provide for the company if finalized in current form. For example, compensation indicator 2607 may indicate a 35% gross margin of profit on an order. In one embodiment, a compensation indicator may indicate a percentage of commission paid to a user creating the deal. In still another embodiment, the compensation indicator is tunable to different values. For example a user may request the percentage of net profit as opposed to gross profit. In another example, a user may request an indication of cost percentage. Tuning compensation indicator 2607 to display differing values assumes that there is an interactive selection mechanism provided that has options for display. Such a mechanism can be a series of check entry boxes labeled for the different values or some other icon that has more than one selectable tab which links to the associated indicator. There are many possibilities.

An array of selectable options 2608 is provided near the top portion of the larger window of screen 2600. The options include optimize, substitution, bundling, competitor, and final edit. Note that the option substitution is bolded indicating for exemplary purpose that the user intends to find replacement product candidates offered by the company that can be offered in an up-sell scenario. Activating the option substitution will bring up a new screen.

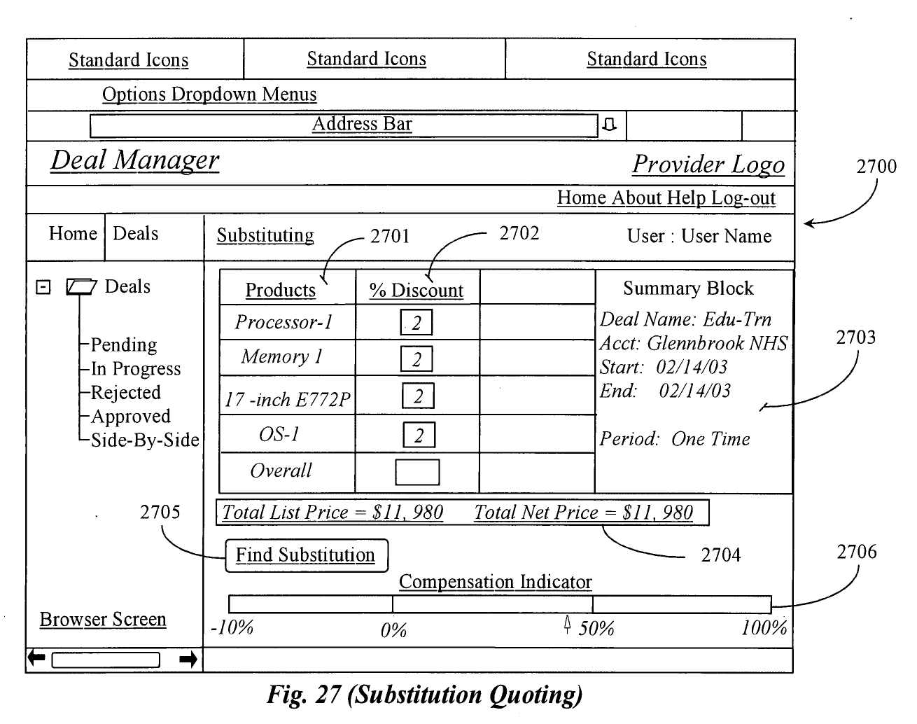

FIG. 27 is a plan view of a deal management screen 2700 for finding available substitute products in an up-sell scenario. Screen 2700 displays a list of requested products associated with the Marquee computer system of screen 2600 listed in a column 2701 labeled Products. Column 2701 lists a processor-1, a memory-1, a 17″ E772P monitor, and an operating system (OS)-1. A column may also be provided for corresponding quantities requested although none is illustrated in this example.

Adjacent to column 2701 is a column 2702 listing the requested line item discounts adjacent to each item listed in the first column. In this example, the client has requested a 2% discount for all of the items listed. Following the list of items in column 2701 an indication of overall discount for the group of items is displayed and an entry box located in the next column and adjacent to the indication is provided for the user to enter a discount percentage. It is noted that the customer requested discounts for each line item have also been entered into field entry boxes provided. The line item discounts are attributes. A third column adjacent to the first 2 columns is blank assuming a pre-substitution find scenario.

An information summary block 2703 is displayed to the right of the product and attribute columns for the purpose of convenience reminding the user which deal he or she is working on. In the summary block there is a display line for deal name, account name, start date (start of order period), end date (end of order period), and period length. In this case the request is a one-time order.

A pricing totals window 2704 is displayed beneath the above described columns and summary block. Window 2704 is populated, in this example, with a total list price for all of the requested items according to the quantities requested and discounts applied. A total net price is also provided. In this case the list and net price is the same price of $11,980 carried over from the example of FIG. 26 screen 2600. Compensation indicator 2706 is analogous to compensation indicator 2607 described with reference to FIG. 26.

An interactive option 2705 illustrated in the form of an icon labeled Find Substitution is provided for the user to initiate processing for substitute product candidates. Activating the find substitution option 2705 will return candidate products in a new screen or window.

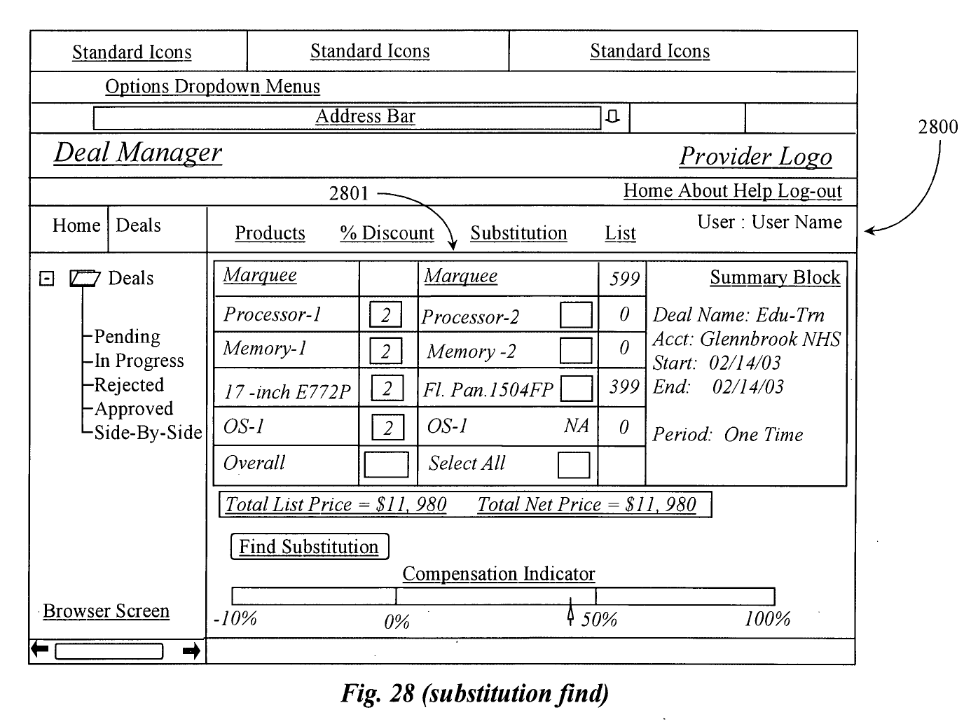

FIG. 28 is a plan view of a screen shot 2800 displaying candidate products for product replacement in an up-sell scenario according to an embodiment of the present invention. Screen 2800 has the same first column of original Marquee products and the requested line item discounts for those products as displayed in respective columns of screen 2700 of FIG. 27 above. A column 2801 labeled Substitution is illustrated adjacent and to the right of the first 2 columns listing original Marquee products and requested discounts. Column 2801 lists a processor-2, a memory-2, a flat panel 1504FP monitor, and the same OS-1. At this point the possible replacement products are simply displayed based on the applicable ranking factor. Therefore the optimum substitutions available for the products listed in the Product column are the corresponding candidates listed in the Substitution column. Next to each product candidate is a check entry box for selecting or deselecting the corresponding product for analysis. A user has the option of selecting any one, combination of or all of the candidate products by checking the adjacent check boxes. A “select all” check box is provided for convenience.

A list pricing column 2802 labeled List is illustrated adjacent and to the right of column 2801. Column 2802 provide line item list prices for each listed substitute candidate product in this scenario. It is noted herein that the flat panel substitution product has a list price of 399 dollars each. It is also noted herein that processor-2 and memory-2 have no pricing information associated with them. This could mean that these replacement candidates are currently unavailable or that the price must be fetched using the default item sequence again during processing. OS-1 in the original products column does not have a replacement operating system so it is listed again with the notation NA or not applicable. Pre-knowledge of a price increase of 399 for the up-sell flat panel monitor is, in one embodiment, simply an indication that this product is the main up-sell replacement product for the product group comprising a Marquee system. Making a selection of any one, combination of or all of the candidate substitution products brings up a new screen with a validation option to insure that all of the selected substitutions are valid.

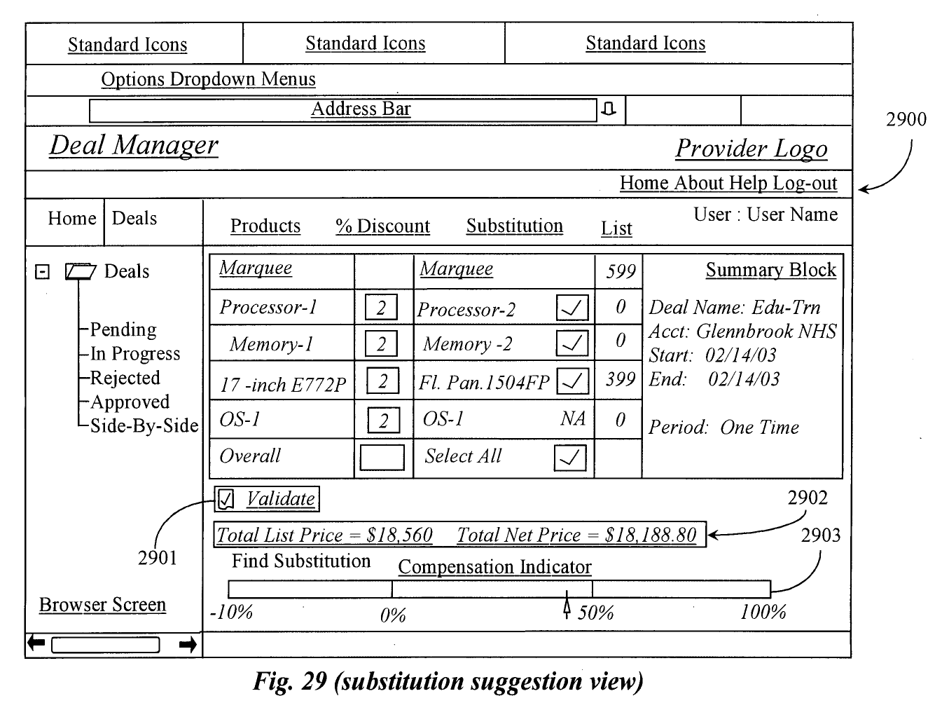

FIG. 29 is a plan view of a screen 2900 displaying selected candidate substitution products for an up-sell substitution scenario. Screen 2900 is similar to screen 2800 in terms of visual content of FIG. 28 above except for a few minor differences. For example, all of the returned candidate substitution products listed in column 2801 are illustrated as selected and have been priced in terms of a replacement order scenario. A pricing window 2902, analogous in construction to window 2704 described with reference to FIG. 27 above, illustrates a new total list price of the substitution scenario and a new total net price of the substitution scenario. The new list price for 20 systems with the substituted products is $18,560 ($11,980+$6,580). A lower net price is indicated as $18,188.80. The lower net price indicates the pricing after all discounts are calculated, as would be the case of an actual order.

An interactive icon 2901 is provided in the larger window of screen 2900 for validating the current order suggestion. A validation step is optionally performed to ensure that all of the products are available for shipping and that all of the pricing is correct and consistent with the current pricing model of the enterprise. A compensation indicator 2903 is illustrated as displayed in the larger window of screen 2900. Indicator 2903 is analogous in construction to indicator 2706 described with reference to FIG. 27. The percentage level of compensation actually indicated might have changed according to the new substitution scenario calculated.

When the user activates validation option 2901 the current order scenario including availability and, in some cases pricing is validated against error. This action brings up a new screen, which will indicate that all or some, or perhaps none of the substitutions are valid.

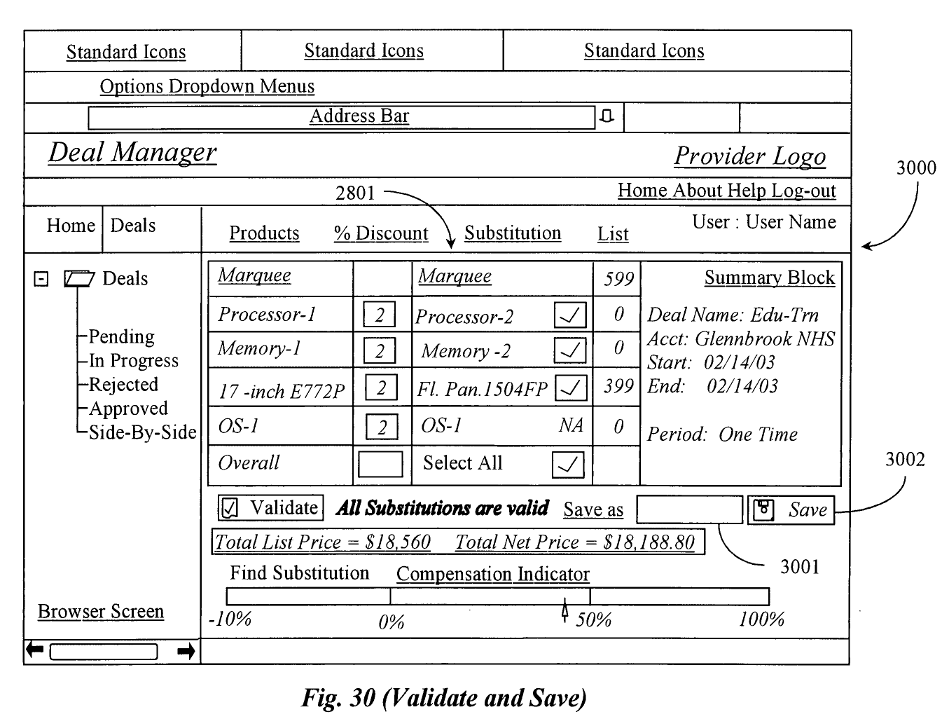

FIG. 30 is a plan view of a screen 3000 displaying a validation message 3001 related to the submitted validation request of FIG. 29. Screen 3000 is similar in content to screen 2900 of FIG. 29 above except for the appearance of validation message 3001 (Bold Type), which indicates that all of the substitutions are valid. Validating the scenario lets the user know that all of the parameters relating to the scenario are correct and that this scenario can be saved as a deal scenario. Also varying from the screen of FIG. 29, an interactive save icon 3003 along with a save as entry field are provided in the larger window area of screen 3000 for the purpose of naming and saving the configuration as a scenario. The saved scenario will appear next to the basic scenario as a deal option to consider for presentation.

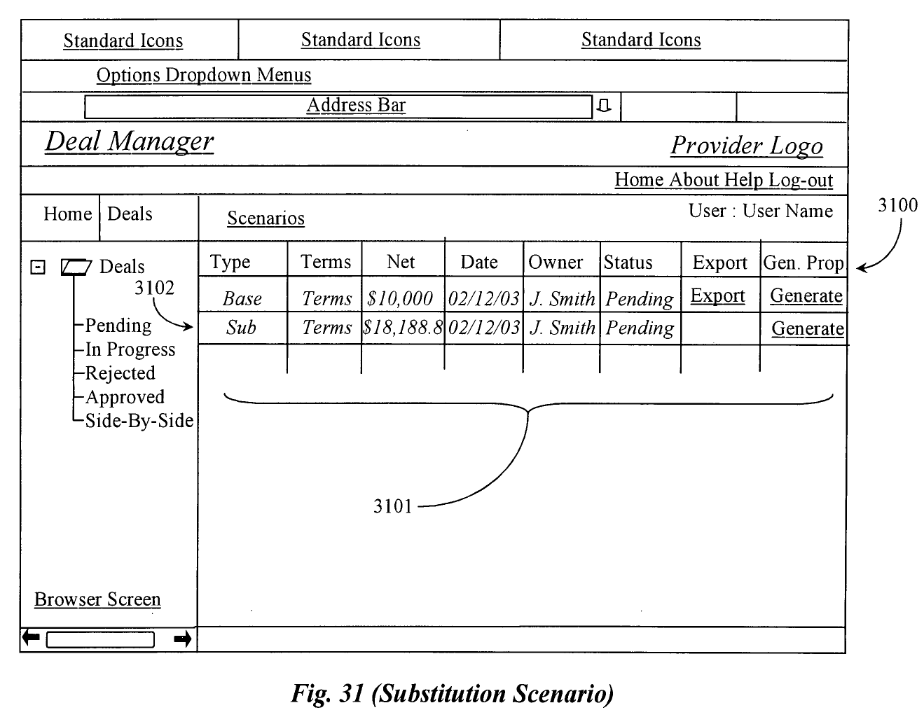

FIG. 31 is a plan view of a screen 3100 displaying the saved substitution scenario of FIG. 30. Screen 3100 is similar to screen 2000 described with reference to FIG. 20 above. For example illustrated columns 3101 are analogous to columns 2001 described with reference to FIG. 20. In this exemplary view a row 3102 is illustrated and populated with summary information of the substitution scenario saved previously as illustrated in FIG. 30 above. Information columns 3101 include Type (scenario name), Terms, Net (net price), Date, Owner or Author, and Status. The last 2 columns at far right contain interactive options for Export data and for Generate Proposal. It is noted herein after application of discount that the net price for the base scenario has changed to $10,000 from $11,980. These numbers are exemplary only and may again change during further processing or re-calculation of discounts etc.

The saved scenario is named Sub, an acronym for substitution scenario. Both the base scenario and the substitution scenario can be compared against each other based on any ranking attribute such as revenue, profit margin, etc. It is noted herein that a user can apply different advisory factors using a request initiation format that causes processing of a starting scenario according to the advisory factor intent and then save each scenario for comparison and further analysis before selecting one for final edit and presentation. All saved scenarios are accessible from a scenario list analogous to screens 3100 of FIG. 31 or 2000 of FIG. 20.

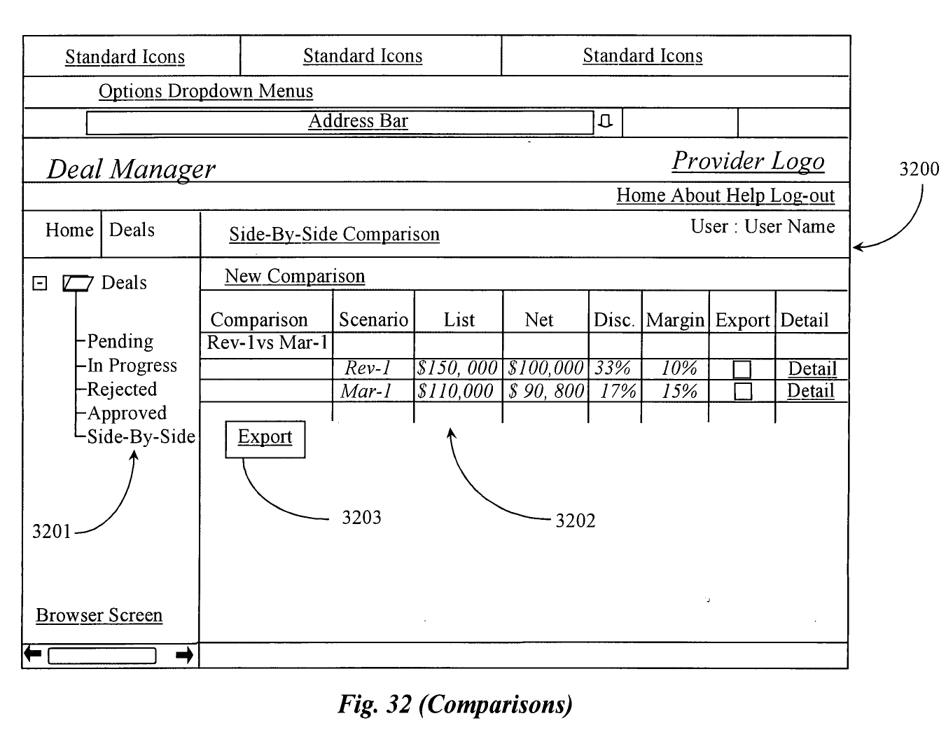

FIG. 32 is a plan view of a screen 3200 for performing a side-by-side comparison of 2 deal scenarios according to an embodiment of the present invention. If there are two or more saved deal scenarios, they can be compared to each other side-by-side. Screen 3200 has an interactive comparison option 3201 located at far left in the deals navigation tree. The option is the last available option in the list and is labeled Side-By-Side.

The larger window of screen 3200 contains a comparison summary view arranged in columns and rows 3202. Columns of view 3202 include Comparison type (Revenue-1 vs. Margin-1), the Scenario type (selected for comparison), List price (total), Net price (total), Discount percentage (averaged), and Margin (% of total). The last 2 columns of view 3202 contain interactive options of Export and Detail. In the export column there are check entry boxes (one for each scenario defined by a row). By checking an export selection box a user can pre-mark a scenario for export to a processing software application like Microsoft Excel™ for example. An interactive selection icon 3203 illustrated within the larger window of screen 3200 and labeled Export initiates the export function for those scenarios having their check entry boxes in the column Export marked.

Two scenarios, a scenario maximized according to revenue, and one maximized according to margin are illustrated in this example. The basic comparison fields identified by columns of view 3202 reflect total figures for each scenario and are directly comparable in this view. For example, the total list price of $150,000 for the scenario revenue is directly comparable to the total list price of $110,000 for the scenario margin. The rest of the comparable fields are populated with the appropriate figures for comparison. It is noted herein that the margin for profit attributed to the second scenario is 15%, 5% more than the first listed scenario. However the total revenue of the first scenario is greater than the total revenue of the second scenario by $9,200.00. A user may elect to view a more detailed product-by-product comparison.

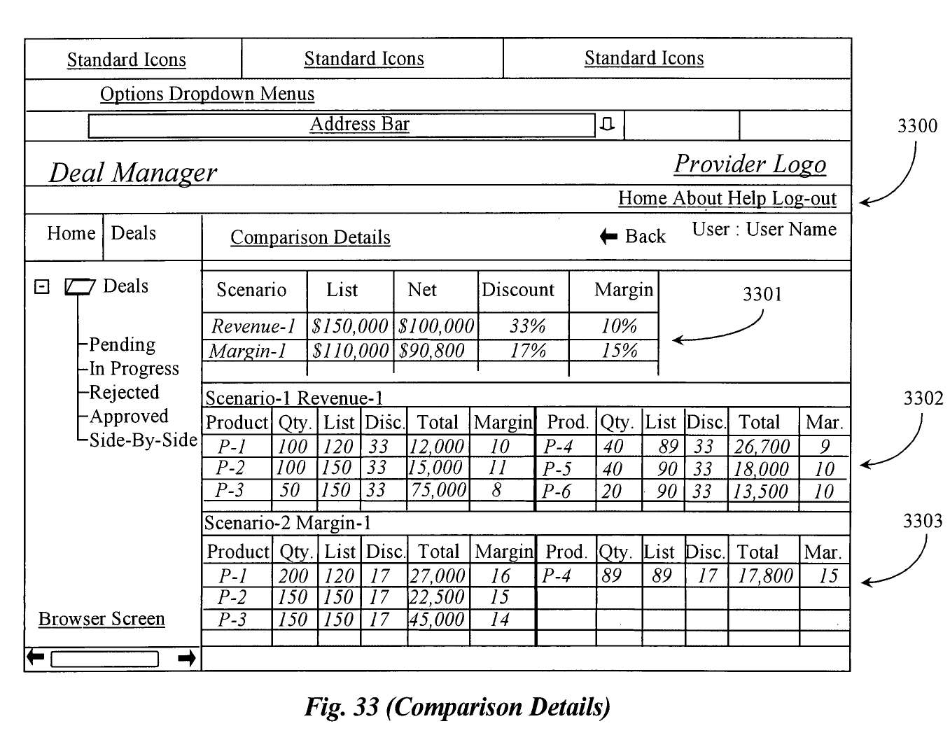

FIG. 33 is a plan view of a screen 3300 illustrating a product-by-product view of the summary scenario of FIG. 32. Screen 3300 has a short summary block 3301 illustrated within the larger window, block 3301 analogous to view 3202 of FIG. 32 above minus the interactive option of Export and Detail. A detailed information block 3302 arranged in columns and product rows is provided for detailing the individual parameters by product. For example, a first column labeled product lists products P-1 through P-6 of scenario 1. It is noted herein that due to limitation of drawing space, the detailed view columns are reproduced in adjacent order further to the right in order to render all of the product information visible in the window. In a preferred embodiment scroll capability (not shown) is provided for the larger window of screen 3300 so that exceptionally large orders can be viewed.

The attribute columns of detailed block 3302 lists the Qtys. of each product (P-1 through P-6), the list price of each product, the line item discount for each product, the total list pricing for the quantities listed, and the percent of profit margin for each listed product.

Screen 3300 similarly has a detailed block 3303 for scenario 2 or the second listed scenario. The attributes for block 3303 are the same as for block 3302 wherein the columns define the comparable product attributes and the rows define products listed.

It is noted herein that the first listed scenario has 6 products listed while the second listed scenario only has 4 products listed. It might be that the first scenario represents a cross-sell scenario wherein 2 products were added to the total number of requested products. It is also noted that the product quantities listed in the second scenario are different than the product quantities listed in the first scenario for the same products. The numbers reflected in this example are exemplary only.

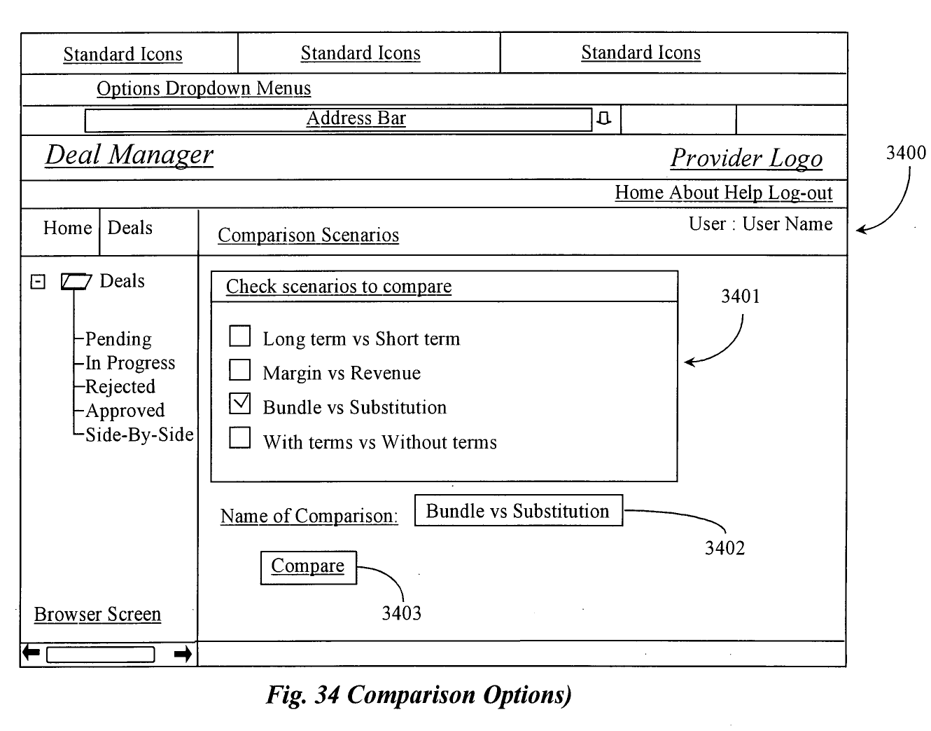

FIG. 34 is a plan view of a screen 3400 displaying an interactive interface 3401 containing selective comparison options. Screen 3400 can be used to decide which comparisons of scenarios to perform. Interactive interface 3401 contains 4 types of comparison options. These are long term vs. shot term scenarios, margin scenarios vs. revenue scenarios, bundle scenarios vs. substitution scenarios, and term-based scenarios vs. no-term scenarios. It is noted herein that there may be more or fewer types of comparison options listed in interface 3401 without departing from the spirit and scope of the present invention. The inventor lists 4 separate types of comparison for explanative purposes only.

It is also noted herein that a margin scenario is a deal scenario that has been optimized according to margin while a revenue scenario is a deal scenario that has been optimized for revenue. More detail about optimizing a deal scenario according to a goal-based attribute will be provided later in this specification. Each listed option for comparison has an associated check entry box located next to it. By checking one of the entry boxes a user marks an option and then activates a provided interactive icon illustrated herein as icon 3403 labeled Compare. A text entry field 3402 is provided and populated with the selection Bundle vs. Substitution based on the check box marked next to the appropriate option.

In this example, it is assumed that at least 2 deal scenarios have been created and saved for a client, a substitution scenario and a bundle scenario. When comparing the different scenarios related to a client proposal, editing options are provided as well as a final edit to any selected scenarios for proposal generation and presentation to a client. It is noted herein that more than one comparison operation type can be performed on two or more deal scenarios each operation utilizing a different comparison option without departing from the spirit and scope of the present invention. In one embodiment a user might run 2 scenarios for optimization with the default option to perform the appropriate comparison without requiring that the user choose which type of comparison to make. There are many automation possibilities for bundling separate but logically sequenced operations.

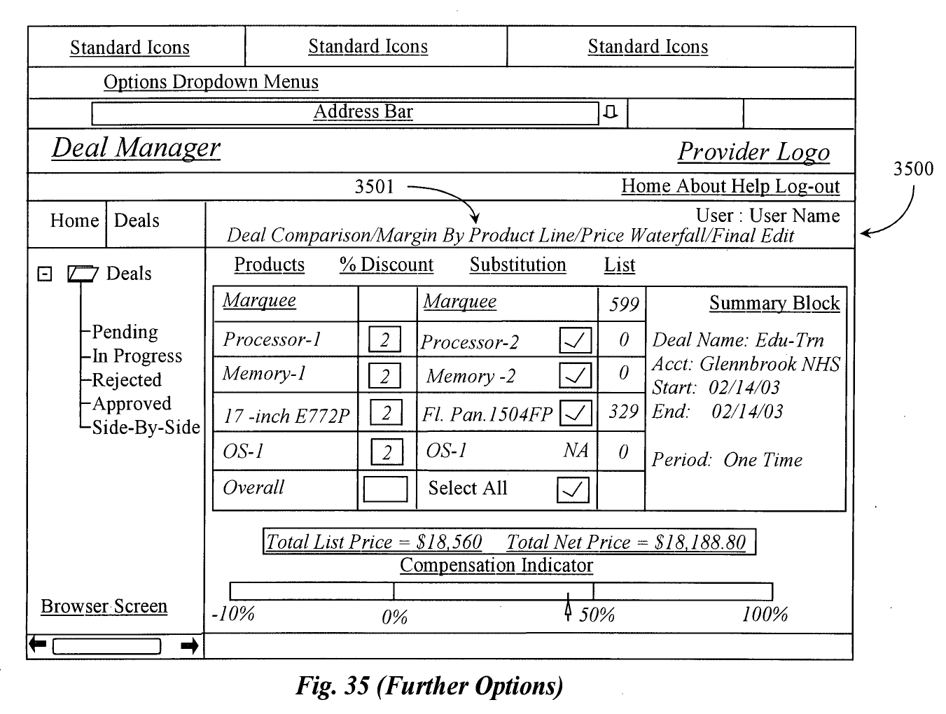

FIG. 35 is a plan view of a screen 3500 illustrating some other options available to a user through the deal management interface. Screen 3500 illustrates the previous example of the education/transaction deal previously described above in several examples. In this example, screen 3500 is similar to screen 3000 of FIG. 30 showing a validated up-sell scenario. In this case, screen 3500 has an array of selectable options 3501 provided immediately above the larger window area. Options 3501 include a deal comparison option, which when activated would call up screen 3400 described with reference to FIG. 34 for example. Other listed options in array 3501 provide graphical representation of a scenario-related, goal-based attribute or of a general goal-based attribute attached to a specific product or product line. This is accomplished through graph and chart generation and display based on most current statistical and other information.

Selecting Margin by Product Line, for example, may, in one case, cause generation of a bar graph (not illustrated) that displays the percentage of margin achieved in one product line compared with that of another product line or other product lines. The attribute margin can be constrained to product line in general, products specifically related to compared scenarios, and so on. Margin can also be compared among general products by region in which the products are distributed. There are many possibilities. Selecting price waterfall may call up a line graph (not illustrated) illustrating the % margin at specific pricing levels of a specific product offered to a specific customer or customer channel. Pricing levels for the offered product can include list levels, promotional levels, channel discount levels, competitor levels (margin if our product offered at competitor price), customer negotiated levels (actual negotiated price), and so on. These graphical reorientations aid in deal analysis before a sales agent get embroiled in the final negotiated deal with a client giving the agent a better understanding of how to optimize the negotiating process. The last listed option in array 3501 is a Final Edit option, which provides a screen for final deal editing before generation of a proposal.

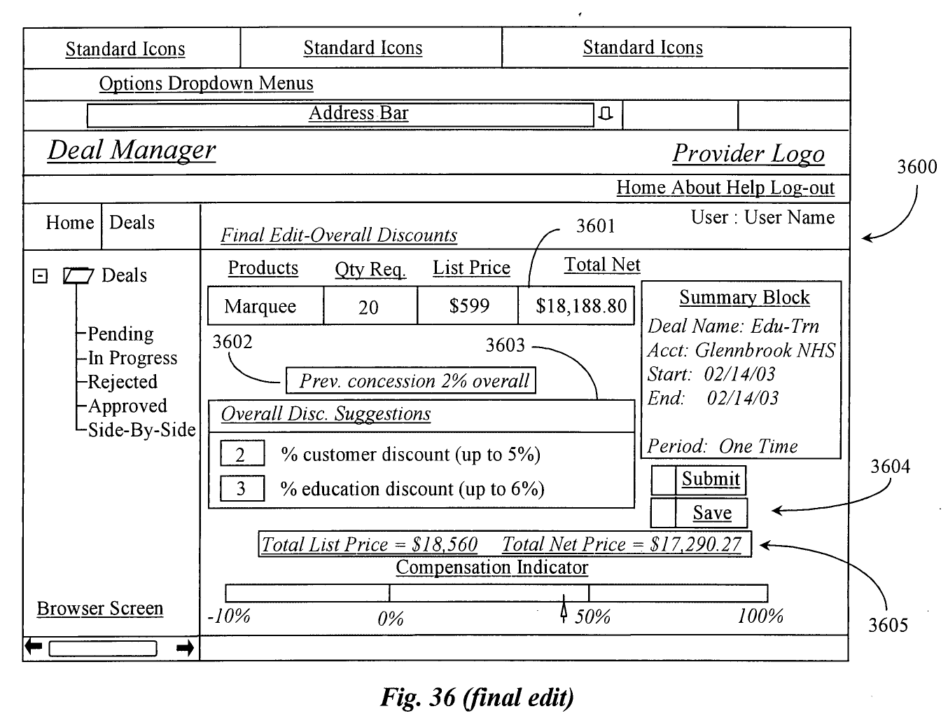

FIG. 36 is a screen 3600 illustrating an interface for performing final deal edits according to an embodiment of the present invention. Screen 36 refers back to the substitution deal previously described in numerous examples above for education/transaction. Screen 3600 displays a deal summary block 3601 located near the top of the larger window area. Summary block 3601 lists the product Marquee (system), Requested Qty. of 20 systems, at a list price of $928.00 per system (with the up-sell flat-panel substitution). The total net price for the order is $18,188.80 after discount.

Screen 3600 has a discount concession block 3602 displayed in the larger window area that informs a user of the overall discount already conceded to. A discount suggestions block 3603 is provided and displayed in the larger window area of screen 3600. Block 3603 has two categories of discounts listed as customer discount and education discount (channel discount). Each category specifies the maximum discount allowed for the deal. Each discount category has a field entry box for inputting an additional discount percentage amount.

An overall discount of 2% for the customer and channel is already conceded. Therefore, the user can add 3% to the customer category and 4% to the channel category to arrive at the lowest possible discount price for the marquee system in the up-sell situation. In this case the user has applied an additional 2% to the customer category and an additional 3% to the channel category thereby lowering the total net price to the customer to $17,290.27 as is illustrated in a pricing block 3605, which displays the total list price along with the new net price after the additional applied discounts.

In one embodiment of the present invention a cookie-based tracking system could be conceived that would enable an administrator to statistically track the behavior of a sales agent operating through the deal management interface. The system could be detailed enough in terms of the information provided in cookie exchange to provide the administrator with knowledge of, for example, an agent that continually offers a maximum available discount for a preponderance of his or her transacted business. Such information can then be used to counsel sales agents in optimization behaviors that would increase the agent productivity in terms of revenue and profit. In another embodiment, administrators may manually logon and navigate to deals histories through the administrative login of the deal management interface and analyze selected agents deals that have been conducted. An automated tracking system could be used to alert an administrator to “look into” a certain agents deal history due to less than optimum use of the tools provided by the interface.

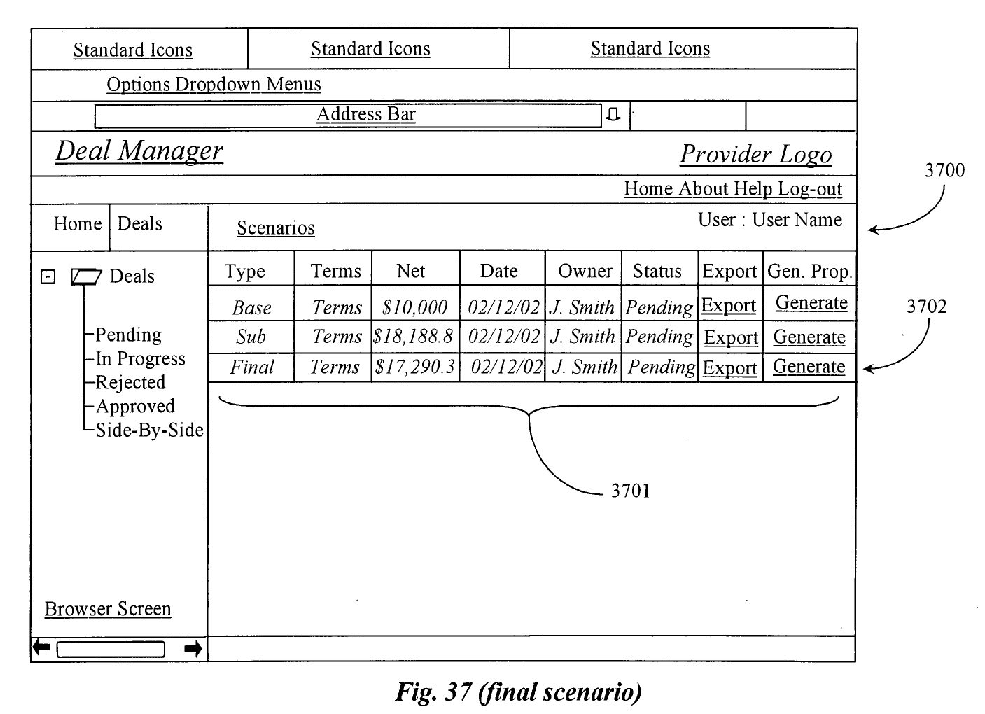

FIG. 37 is a plan view of a screen 3700 displaying an updated list of scenarios. Screen 3700 is identical to screen 3100 described with reference to FIG. 31 above except for an addition of a final scenario 3702 representing the edited scenario of FIG. 36 defined herein by the last row from the top containing the summary information of the final edit. An array of columns and rows 3701 contain all the scenario summary information, attributes defined by columns and seal scenarios defined by rows.

It is noted herein that the labels Base, Sub. And Final in the Type column and the label Terms duplicated in the Terms column are interactive and selectable options bring up an associated screen containing more detailed information as previously described in examples above. Similarly, the interactive options for Export and Generate are also provided. A user is not bound to select the final scenario for generating a proposal, as the base and substitute scenarios may still be editable. It is noted however that a final scenario representing a refined version of an earlier scenario may be saved as a read only file to prevent further edit assuming that it is the best scenario to propose to a client.

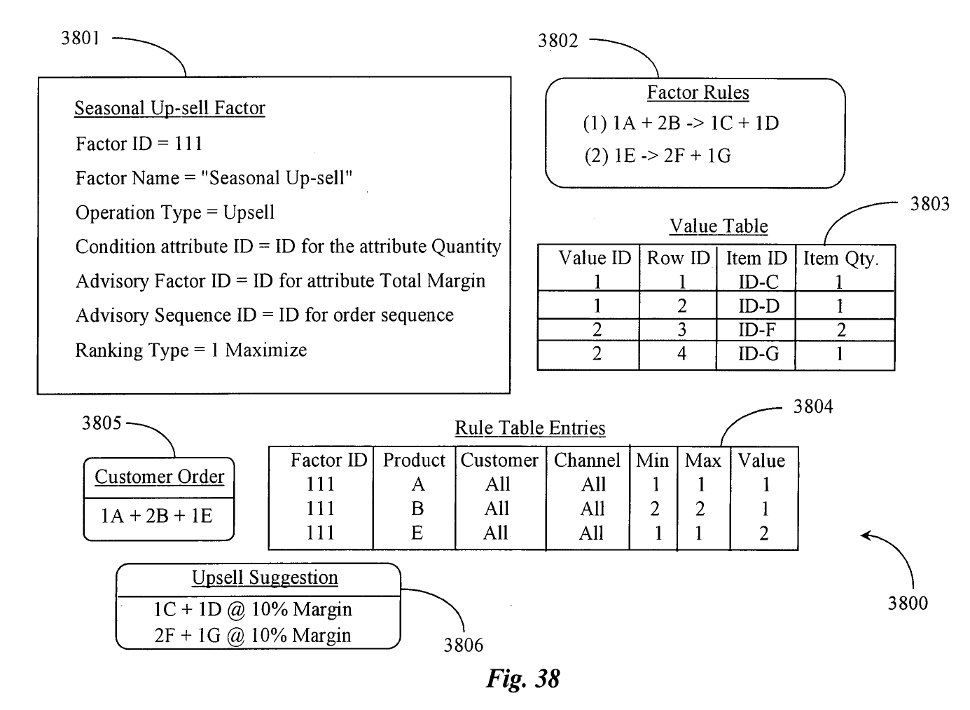

FIG. 38 is a block diagram 3800 illustrating a relationship between an advisory factor 3801 and associated rules according to an embodiment of the present invention. Advisory factor 3801 is illustrated herein as a logical compilation of required components. A user creates advisory factors through a price manager interface analogous to the price management portion of software application 1414 described with reference to FIG. 1 above.

Factor 3801 is of the type up-sell and has a name of “Seasonal Up-sell”. Each factor has an identification (ID) number that will associate the factor to the factor rules that apply. In this example, factor 3801 has an ID number of 111. When created, factors can be assigned sequential numbers. A previous unrelated factor might have an ID of 110 and a next created factor would have an ID then of 112. There are many possible identification schemas that could be implemented.

The name of this particular factor is Seasonal Up-sell as previously described. Each factor has an operation type identified. In this case the operation type is up-sell. Each factor has at least one condition attribute ID. In this case the selected attribute is quantity therefore the ID number applied will be the same as an ID assigned to the attribute quantity. In actual practice quantities may be expressed as absolute amounts or as a quantity range having a minimum and a maximum boundary. The latter is most common and easier to match with incoming requests.

The advisory factor has an ID number additional from its general factor ID number. This is an advisory factor ID number. This number will determine the factor attribute-based goal. In this case the advisory factor ID is equal to the attribute ID for total margin meaning that the return values of the factor will rank according to total margin. By using 2 factor IDs, all of the advisory factors can be isolated efficiently from all of the standard pricing factors. For example, an administrative view of factors could be tuned to display only advisory factors of attribute type maximize total margin.

Each created advisory factor refers to a factor order sequence associated with the factor. In a preferred embodiment an up-sell factor is contained in an item sequence, which has an associated order sequence for calculating totals. Therefore a factor definition refers to an advisory sequence ID, which is equal to an ID assigned to the order sequence. The up-sell factor definition also specifies a ranking type, which can be set to maximize or minimize depending on the goals of the enterprise and the attribute ID for the advisory factor. For example, if the attribute ID were the ID for total margin, then the ranking type would be set to maximize (total margin). This means that the values (product substitute candidates) returned after running the advisory sequence are ranked in importance according to maximized total margin.

The introduction of advisory factors into pricing scenarios gives rise to additions in the table that defines a price factor header. A new column is added for naming the advisory factor. A next column is added to specify the value data type associated with advisory tuples listed in the advisory column.

Under the advisory factor column for example the name of the column is the name of the particular advisory factor like seasonal up-sell. Listed there under in rows are the advisory factor ID, the item sequence ID containing the advisory factor, the order sequence ID containing the advisory ranking factor, and finally the ranking setting. The adjacent column simply specifies the character expression of the associated tuples whether it is a number or alphanumeric character. All are numbers in this case.

Advisory rules are created for advisory factors. An advisory rules table lists a value ID, which is a number. A value ID is the value of the up-sell rules so that all of the rules having the same value ID form a single up-sell. Additional tuples listed are row ID (number), item ID (number), item quantity (number), transaction type (Varchar2), transaction ID (number), date of last update (date), author of last update (Varchar2), creation date (number) and author (number).

Diagram 3800 includes some exemplary factor rules illustrated in a block given the element number 3802. These are up-sell rules. There are 2 illustrated rules rule (1) and rule (2) that describe possible up-sell product mappings. For example, quantity 1 of item A+quantity 2 of item B maps to quantity 1 of item C+quantity 1 of item D. So original products A and B of the quantities indicated can be up-sold to replacement products C and D of the quantities indicated.

Rule (2) states that quantity 2 of item E can be up-sold to quantity 2 of item F quantity 1 of item G. E is the original item requested and items F and G are the up-sell items. Up-sell rules have a quantity attribute that can be an absolute quantity or a quantity range.

A rules value table 3803 is illustrated in this example and provides parameters of the factor rules for the replacement or up-sell products associated with the rules listed in block 3802. For example, rule (1) specifies 2 up-sell product C and D so 2 rows will be used to table a value ID of 1 (rule 1), a row ID of 1 for product C and 2 (next row) for product D. Row 1 specifies the item ID for product C and the quantity attribute 1. Row 2 specifies the item ID for product D and the quantity attribute 1. The next row in value table 3803 is reserved for a next rule or rule (2) in this instance. Rule (2) has a value ID of 2, the first product F specified in rule (2) has a row ID of 3 (the first row associated with the rule). An item ID is specified for up-sell product F along with the allowable replacement quantity attribute of 2. The next row (4) of rule (2) specifies an ID for an up-sell product G and the allowable quantity. A third rule would begin the next row down or row 5 and so on until the table has all of the rules for up-sell products.

A table of rule entries 3804 is provided and specifies the factor ID of am up-sell factor or 111 in this case. Entries table 3804 also specifies the original products of the up-sell, in this case products A and B (rule 1) and product E (rule 2) are specified in the factor. The factor entries apply to all customers for all products and all channels for all products. Minimum and maximum order quantities are specified for all 3 products A, B, and E. For example, an original order quantity must be a minimum of 1 and a maximum of 1 for product A, a minimum of 2 and a maximum of 2 for product B and a minimum of 1 and a maximum of 1 for product E. Note that there are 2 rules covering the original product entries; rule 1 covering products A and B, and rule 2 covering product E. The values in the value column specify which rule applies from block 3802. Value 1 specifies rule 1 and value 2 specifies rule 2.

Assuming a customer request comes in for 1A+2B+1E, illustrated herein by an order block labeled 3805, both rules (1) and (2) will fire. If order 3805 did not include product E then only rule (1) will fire. If the order only contained product E then only rule (2) will fire. In a preferred embodiment of the present invention the quantity attribute of the original request must match for fall within the quantity attribute listed for the products requested in the rules table entries or the rule will not fire.

After firing the up-sell rules, in this case rules (1) and (2) that apply to up-sell factor ID 111 for the request, the pricing server returns a list of data structures, which at minimum list all of the available up-sell substitution products, their quantities and the % of profit margin achieved by recalculating the substitutions in the order sequence using the substitution product line item price parameters instead of those of the original products. The new scenario can be saved along side of and compared to the original base scenario.

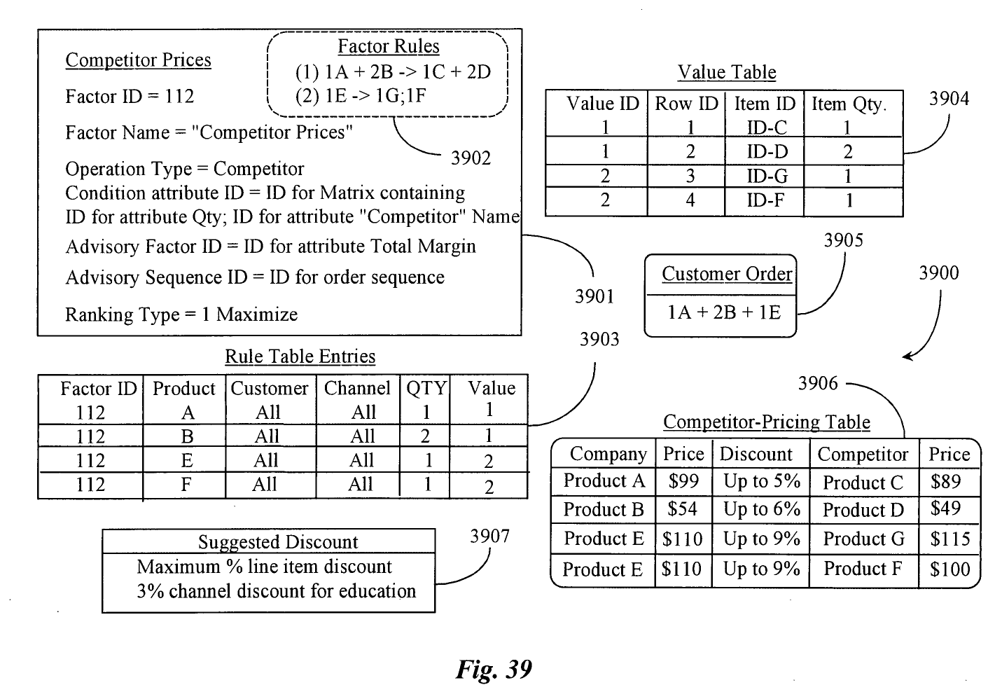

FIG. 39 is a block diagram 3900 illustrating a relationship between an advisory factor 3901 and associated rules according to an embodiment of the present invention Advisory factor 3901 is a competitor factor that invokes a return of competitor offered products that correspond to originally requested company offered products. Factor 3901 in this example is named “Competitor Prices”. Factor 3901 has a factor ID number of 112. The operation type is competitor.

Factor 112 has a condition attribute ID that is an ID number assigned to an attribute matrix containing the ID for the attribute quantity, and an ID assigned to the attribute competitor name. The advisory factor ID of factor 112 is the ID for the attribute total margin in this example. An advisory sequence ID for the factor 112 specifies the ID for the correct order sequence. The ranking type is set to 1 or maximize. Factor 112 operates in the same fashion as the up-sell factor 111 described further above, and in fact uses the same rule-based architecture. The only differences are that the competitor factor must have a pre-defined attribute “competitor name” and returns only a list of competitor products and prices that can be compared with the matching original products and prices, the list ranked by some ranking factor.

A factor rules block 3902 illustrated herein as a dotted rectangle block has 2 rules listed that apply to factor 112. Rule (1) states that a request for a quantity of 1 of product A+quantity 2 of product B maps to a quantity of 1 of a competitor product C+a quantity of 2 of a competitor product D wherein the competitor name is known.

Rule (2) states that a request for a quantity 1 of product E maps to a quantity of 1 of a competitor product G or a quantity 1 of a competitor product F wherein there are 2 separately identified competitors one for product G and one for product F. It is noted herein that the attribute competitor name can contain more than on competitor name associated with possible matching products. In one embodiment there would be 3 rules actually written in table 3902 rule (3) stating that a request for a quantity 1 of product E maps to a quantity 1 of a competitor product F wherein the competitor name is known. For sake of simplicity rule (2) will have two product variables of G and F (two different competitor products).

A rules entry table illustrated herein as table 3903 specifies the factor ID of 112 for this particular competitor factor, specification of products A, B, and E of the associated factor rules, and application of the rules to all customers and all channels. Table 3903 also specifies the quantity attribute for each requested product 1 for product A, 2 for product B, and 1 for product E. Table 3903 also lists the values of each row. For products A and B the value is 1 or rule (1) and for product E the value is 2 or rule (2).

A value table illustrated herein as value table 3904 lists the values of the competitor products. For example, a value ID column a row ID column, an item ID column, and an item quantity specification column are provided to specify values for each competitor product in the factor rules that apply. The values of each product occupy a row of the table. Therefore, row 1 contains a value ID of 1 (rule 1), a row ID of 1, an item ID for competitor product C of rule 1 and a quantity value of 2. A second row contains a value ID of 1 (rule 1) a row ID of 2, an item ID for competitor product D of rule 1, and the quantity attribute value of 1.

The next or third row starts with the values associated with rule 2. For example, a third row has a value ID of 2 (rule 2), a row ID of 3, an item ID for competitor product G of rule 2, and an item quantity of 1. The last or fourth row has a value ID of 2 (rule 2), a row ID of 3, an item ID for competitor product G of rule 2, and an item quantity of 1. Note there are 4 rows covering only 2 rules. This is because a row is reserved for each different competitor product. If there were 3 rules in factor rules block 3902 then the value ID of the fourth row would be 3 instead of 2.

Assuming a customer request illustrated herein as a request 3905 containing of a quantity of 1 of company product A+a quantity of 2 of company product B+a quantity of 1 of company product E, both rules for factor 3901 will fire. If request 3905 did not contain product E then only rule 1 will fire. If request 3905 contained 4A+2B+1E then only rule 2 will fire.

The returned values are organized, in this example, as a competitor-pricing table illustrated herein as table 3906. Table 3906 provides the company products prices and maximum discount percentage allowed along with the corresponding competitor products and competitor prices. In a preferred embodiment the quantities of the corresponding products (requested and mapped to quantities) are also listed although they are not illustrated in this example. A user receives table 3906 for informational purposes in deal preparation. The goal is that knowing the corresponding competitor products and price structures will aid the agent in optimizing the deal through discount application if necessary.

Under the column company are the company products of the original request A, B, and E. It is noted that product E is listed twice because it maps to 2 separate products that could be provided by 2 separate competitors. Likewise there may be more than one comparable competitor product that corresponds to product E wherein the competitor name is the same (offered by the same competitor). Under the column price, product A is shown to list at $ 99 and has an allowable discount structure of up to 5% overall. The corresponding competitor product is product C at a list price of $89. Product B of which 2 were requested lists at $54 each and can be discounted up to 6% each. Corresponding competitor product D of which 2 would be considered in terms of pricing according to the mapped quantities lists at $49.00 each. Product E is listed at $110.00 and can absorb a discount of 9%. Corresponding competitor product G lists for $115. Product F also corresponds to product E independently from product G and lists at $100.00.

A user can run any number of test orders using the item and order sequences associated with factor 3901 wherein differing discount percentage values are input for certain products to gain comparison with a virtual order of the competitor products. Each test order is validated for maximum profit margin according to the ranking factor contained in the order sequence.

If the maximum discount percentages were applied to the requested products, the total net price for the request would be $295.67. The competitor scenario, any existing competitor discounts have been figured in culminates to a net competitor pricing of $302. Therefore, a user bid can be crafted to just come in under the competitions scenario using the maximum line item percentage discount structure to its fullest. However, if the competitor scenario is altered using product F for reference instead of G, then the total net price of the competition scenario is $287, which still falls under the company price for an order.

At this point an optional suggestion may occur that enables an agent to apply an additional channel discount. For example, a discount suggestion information block 3907 may be delivered to the user wherein it is suggested that an additional 3% discount over the entire order be given as a channel discount for the customer channel education. In this case, the maximum allowable is 3% overall. If a user elects to apply the maximum 3% education discount, then the final company net price will be $286.80, which is just under the competitor scenario of $287.00.

Of course there are other factors for an agent to consider when pricing against a competitor such as quality issues, service issues and other like differences between company and corresponding competitor products. Therefore, this scenario wherein an agent simply applies all available discounts to “beat a competitors prices” is certainly not default behavior. In this case, the system suggested the additional 3% discount available, which may have been overlooked by the agent. It may be that the overriding “system” rule for competitor pricing is to use the available discount structure to a fullest advantage by default to remain competitive if possible especially if there are no appreciable quality differences between the competing products.

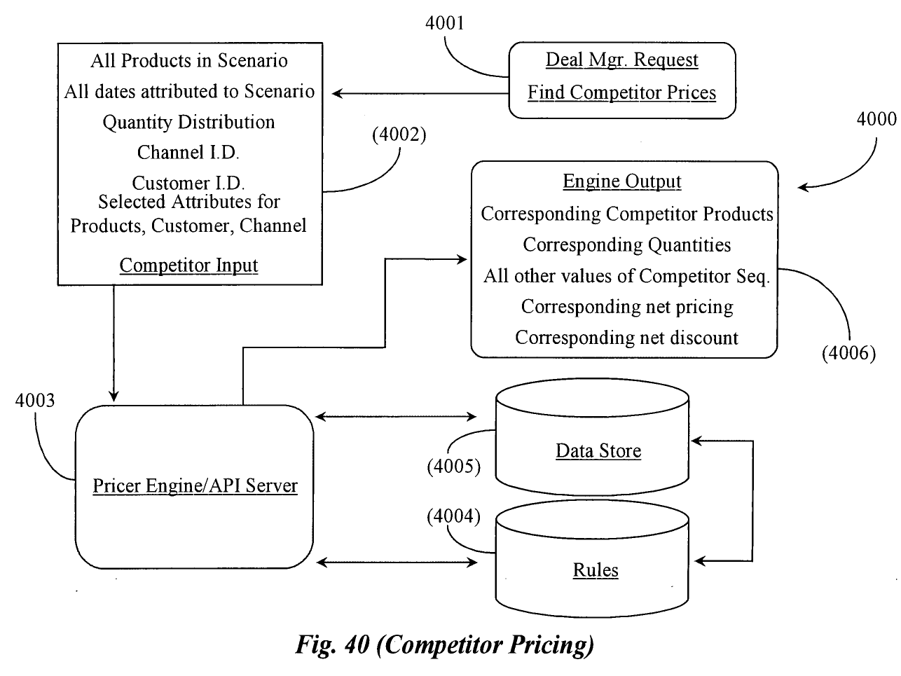

FIG. 40 is a block diagram 4000 illustrating processing of a competitor request according to an embodiment of the present invention.

Diagram 4000 is similar to diagram 2500 described with reference to FIG. 5 above except that it represents a different advisory factor process. An agent working on a deal for a customer first initiates a deal manager request 4001. It may be assumed that a basic scenario for the customer request is available. Request 4001 is for finding competitor product and pricing equivalents to company product and pricing parameters for the customers requested products. The request input parameters are illustrated herein as Competitor Input list (4002). List 4002 includes identification of all of the original products of the customer scenario. List 4002 contains all of the applicable dates of the scenario like order date, shipping date, or multiple shipping dates if required.

In the case of a contract order having multiple shipping periods or exact dates then the product distribution quantities for each shipping date is required. List 4002 includes a channel ID and a customer ID. List 4002 also contains all of the selected attributes for any of the products, for the identified customer, and for the identified customer channel. Product attributes for products might be line item discount percentages allowed. Attributes for customer and for customer channel may also include discount percentage allowances.

At step 4001, the pricer engine receives the request either directly or through an API depending on the location and platform of the user. The engine processes the request by accessing rules from a rules base illustrated herein as rules base 4004. The rules map to data held in repository (Data Store) 4005 as illustrated herein by a double-bracketed arrow associating the two repositories.

The pricing engine access the rules from rules base 4004 associated to the competitor factor found in the item sequence used for calculating the base scenario and fires the applicable rules. The engine (server portion) returns the data structures about corresponding competitor products and pricing according to the ranking factor and ranking factor attribute. Engine output is illustrated in this example as engine output (4006). Output 4006 contains at least identification of the corresponding competitor products along side the requested counterparts and the corresponding quantities that must be ordered.

All other returned values of the competitor sequence such as corresponding net pricing and net discount structures, order totals and so on are calculated. The ranking value result is also provided. The user can see all of the competitor products and pricing available. The default order sequence is used to calculate a virtual competitor order based on the competitor information As previously described, the user can then edit the original order to more closely compete with a competitor scenario.

It is noted herein that calculation of the order parameters of the competitor scenario is not done for product replacement purposes, but only to provide input that the agent can use to fine tune the original order scenario. In one embodiment system suggestions may be sent to an agent giving further input to the agent for optimizing the original order. For example, the system might send the agent a popup alert to concede an additional percentage of overall discount because of the know VIP status of the client. In this case system intelligence matches the final edit order results to the competitor scenario and accesses a general rule, which might be that customer XYZ always receives pricing that at least matches competitor pricing for all transactions. Another alert could be a script containing information of a quality or service nature to use in convincing the client to go ahead even if the discount for a certain product did not render the item competitive to a competitor corresponding product. An example might be a company monitor has a guaranteed lifetime service or replacement contract whereas a corresponding competitor monitor of equal quality only has a limited contract for service. The agent would be prompted to point the information out to the customer if there was a question of why is your monitor more expensive than your counterparts monitor.

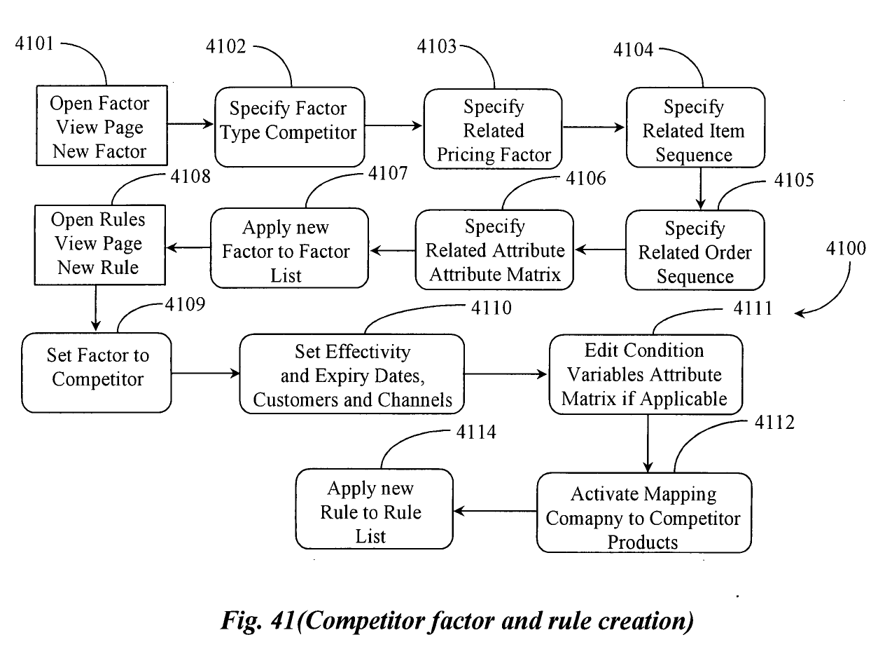

FIG. 41 is a process flow diagram illustrating steps for factor and rule creation according to an embodiment of the present invention. At step 4101 a user opens a factor view page in a pricer manager interface and selects create new factor. A screen with an entry field and a number of drop-down fields will appear. Before beginning selection of input parameters, the user will provide a factor name in a provided name entry box near the top of the interface. The name might be competitor YZX inc. At step 4102 a user selects the factor operation type from a provided drop down menu adapted for the purpose with all of the applicable selection options. In this example the factor operation type selected is competitor. A competitor factor is used in an item sequence and does not take input from a from factor. Therefore a from factor need not be specified.

At step 4103 the user operating on the same interface selects a related pricing factor from a drop down menu of applicable pricing factors. The selected factor will be the “comparison factor” of the returned data structures containing the pricing information. In this case the pricing factor is base price. Therefore, the products returned for comparison will be listed along with their base prices.

At step 4104 the user must specify the related item sequence from a list of operation type sequences. The sequence is a competitor sequence in this example. If the type of operation were up-sell then an up-sell item sequence would be specified. The user then specifies an order sequence related to the item sequence at step 4105 from a drop down list adapted for the purpose. The item sequence contains the competitor factor and the order sequence contains the ranking factor. At step 4106 the use will specify a related attribute matrix from a list of available matrices. If a related attribute matrix is not already created then the user may create one for the purpose. At step 4107 the user applies the created factor to the list of pricing factors. In one embodiment the factor ID number is the next available number of the list.

At step 4108 the user having created and saved the advisory factor navigates to the rules view page and selects create new rule, which will be a competitor rule. The pricing rules page can be accessed from a navigation tree provided and adapted for the purpose. The rules creation interface has at least one drop down menu for selecting the factor name, which has already been created so the new factor will appear in the factor list. Therefore, at step 4109 the user selects the “competitor Apple” factor from the list. The rules creation page also has an entry field for entering an “effective” date (the date the rule becomes useable) and a next entry field for entering an “expiry” date (the date the rule expires) if applicable. Subsequent entry fields are provided for specifying the customers and channels that the rule applies to. At step 4110 the user enters the creation date, expiry date and specifies the customer application and the channel application typing the information into the appropriate entry boxes.

At step 4111, the user edits the condition variable attribute matrix if applicable. The selected or created matrix of step 4106 should appear in the field box. At step 4112 the user provides active mapping from company to associated competitor products that will be identified in the rule. This step uses a mapping interface that is equally divided into 2 separate fields of “your company” and “your competition”. A user specifies the company products and quantities one at a time on the company side, and then specifies the corresponding competitor products and their quantities on the other side of the interface.

In one embodiment, the user can copy and paste the products from an available product list listing all of the companies and competing products. An interactive “ADD” icon appears on both sides of the interface for adding new company and corresponding competitor products and quantities. Step 4112 is an ongoing step, which may also include adding the latest pricing figures based on the comparison factor. In this case the comparison factor is base price.

In another embodiment to add pricing to the products the user might perform a database query to get latest pricing according to, in this case the base price factor. Another option is that the prices are fetched by the pricing engine without requirement of them being listed in the rule. At step 4113 the user is finished creating the new rule and saves the rule to the list of rules. It is noted herein that in one embodiment advisory rules are actively separable from other rules for display and review.

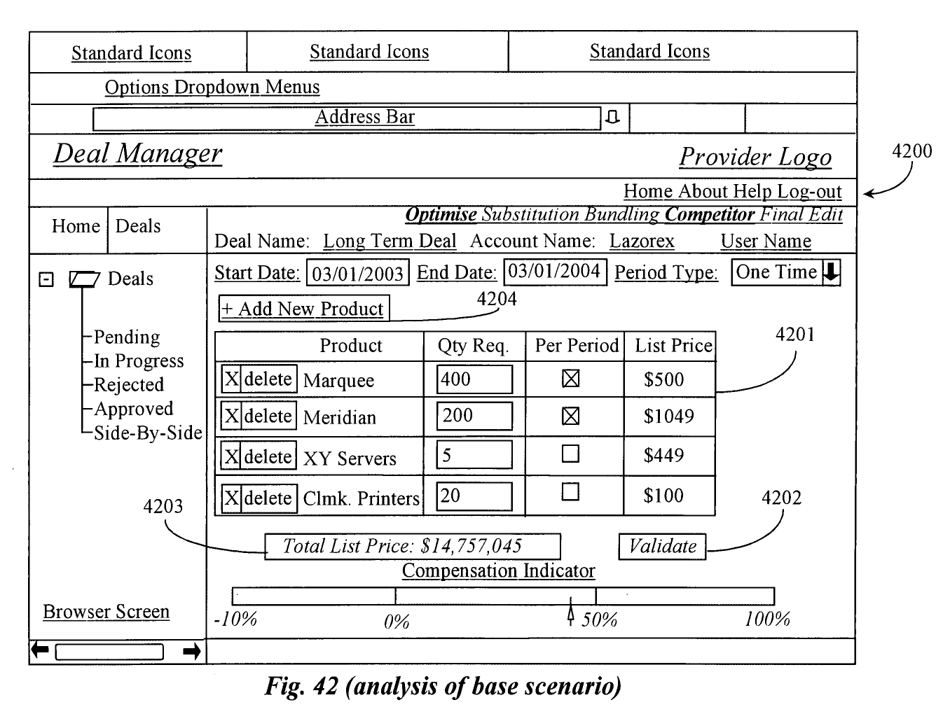

FIG. 42 is a plan view of a screen 4200 for analyzing a base scenario according to an embodiment of the present invention. Screen 4200 is analogous in function to screen 2600 described with reference to FIG. 26 and has most if not all of the same components and options. In one embodiment screen 4200 is the same screen as screen 2600 although there are some differences in component layout. For convenience in preserving drawing space some of the elements of FIG. 42 having counterpart elements in FIG. 26 do not necessarily occupy the same positions of FIG. 26 with respect to the positioning of these elements illustrated herein.

In this example a different deal scenario is being viewed. The base scenario being viewed in this example is a long-term deal associated with the account name Lazorex. The scenario for Lazorex is analogous to the configuration listed second from top in the deals view example of FIG. 17 of this specification.

Screen 4200 has a configuration details block 4201 displayed in the larger window area thereof. Block 4201 is equivalent in interactive function to block 2604 described with reference to FIG. 26. Block 4201 is divided into a product column, a quantity specification column, a period column, and a list price column. The products of this scenario are specified singly the Marquee system, a Meridian system, an XY server, and a Clearmark (Clmk) printer. In the quantity column the corresponding product quantities requested by a customer are listed as 400 Marquee systems, 200 Meridian systems, 5 XY servers, and 20 Clearmark printers.

The base scenario represented in this example is a contract deal with an analysis start date of Mar. 01, 2003 and an end date of Mar. 01, 2004. The analysis star and end date simply define an analysis period for which the contact will be looked at in hopes of optimizing some strategy. A dropdown menu labeled Period Type represents a period for analysis: In this example, the period type selected is One Time representing one period for this analysis.

The particular deal scenario of this example actually has a contract life of three years starting on Mar. 01, 2003 and ending on Mar. 01, 2006. The contract has monthly ship dates for the first two of the listed products and the first analysis period of one year of the contract might be performed just before finalizing the deal with the customer to make sure the deal is optimized according to planned product distribution over the projected monthly shipping periods for the next year. It is assumed in this example that the contract will be periodically analyzed during its life, perhaps one time per year or 3 times. It is noted herein that scrolling capability is provided both vertically and horizontally so that a user can view all of the contract shipping periods.

Referring back to block 4201, to the left of each product listing is an interactive delete icon for removing the associated product from the scenario assuming that the contract has not already been finalized. In some cases, contract deals are re-negotiated after they have been initiated and therefore, products may still (in edit mode) be added or removed from the configuration even after the contract has been accepted. An interactive icon 4204 for adding new products is illustrated herein and adapted to enable product addition before or during the life of the deal. Similarly, a validation icon 4202 is provided to enable validation of the configuration and of any changes that may be made to the configuration before or after finalization.

Under the Per Period column in configuration block 4201 there is an entry check box associated with each listed product. It is noted herein that the first 2 listed products, the Marquee and the Meridian have their period boxes selected indicating that the total quantity value listed in the quantity requested column will ship each period (each month) throughout the life of the contract, which is three years in this example. Note that the remaining products of configuration 4201 do not have their period boxes selected. The remaining product quantities (5 servers, 20 printers) do not have a specific distribution strategy and can be provided any time during the life of the contract, preferably within the first month or two of the contract.

Working out the math for the quantities requested for all of the products, the total list price 4203 of the contract scenario is $14,757,045. That is 400 of item 1 the Marquee, 200 of item 2 the meridian shipped each month for 3 years and a one time shipment of 5 servers and 20 printers during the contract.

It is noted herein that the options Optimize and Competitor are bolded in the array of options at the top of the larger window of screen 4200. These are the next to options that will be described further below. For the sake of not duplicating screen 4200 for illustration both options are highlighted in one screen although in actual practice a user would navigate back to screen 4200 to perform the second option.

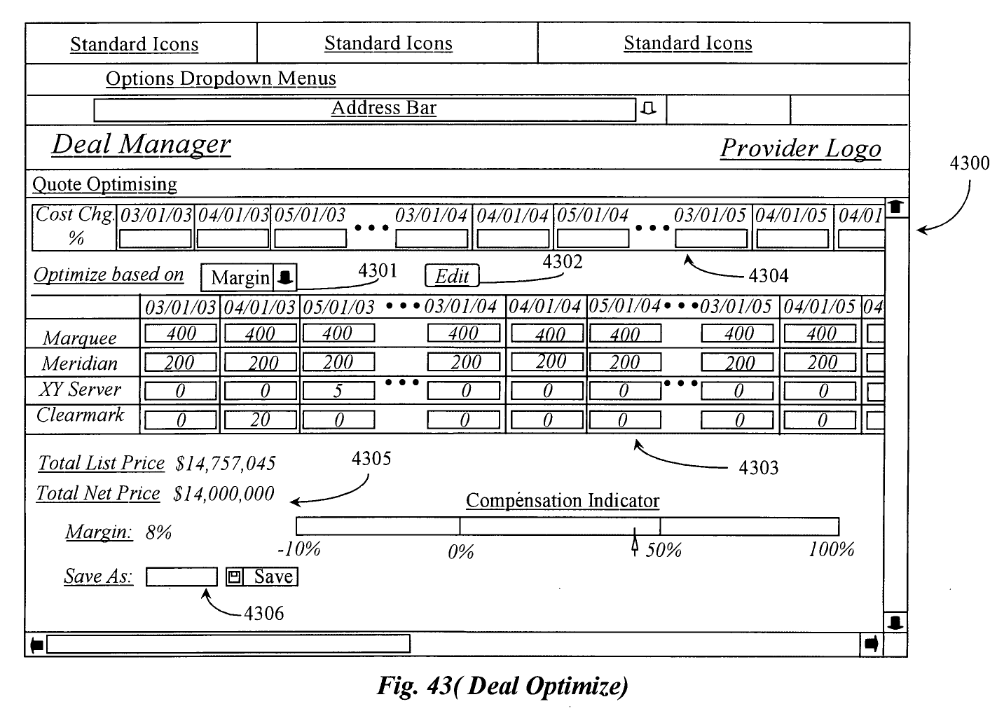

FIG. 43 is a plan view of a screen 4300 illustrating an optimization of product distribution strategy for a specific period analyzed. Screen 4300 is displayed as a result of selecting the optimize option illustrated in screen 4200 of FIG. 42. Executing an optimization command sequence, also termed a maximize command sequence by the inventor returns results, which are based on a particular ranking factor attribute selected for the execution of the command. The goal-based attributes can be % of profit margin, % of revenue, % of cost, etc. wherein the command sequence is adapted to optimize a product distribution strategy related to a particular deal scenario over multiple shipment periods of products associated with the deal. The maximize command is a type of advisory factor that requires a set of input parameters similar to those required by the other described advisory factors.

As previously described other advisory factor options like up-sell or cross-sell sequences use a ranking factor to maximize or minimize result values (data structures) returned to a user according to goal-based attributes like profit margin or revenue (typically maximized) or some other attribute like company cost or customer budget (typically minimized). Like these advisory factors, a maximize command uses an item sequence and an order sequence and a ranking factor related to the configurations scenario, but the goal is not to return replacement products for an up-sell scenario or to provide competitive analysis data, but to figure out an optimum product distribution strategy for a scenario having multiple product shipping periods. The purpose of this is to optimize product distribution during the contract according to a goal-based attribute related to the contract order. This maximize command applies specifically to product distribution strategies in this regard.

In this example, a product distribution display block 4302 is displayed showing the results of product distribution optimization displayed as a result of command execution. A dropdown menu 4301 is provided in the larger window of screen 4300 to enable selection of a goal-based attribute forming the premise of the command. The attribute that was selected in this example is margin. Dropdown menu 4301 has an associated label “Optimize based on”. . . which available attribute is selected from the menu, in this case margin.

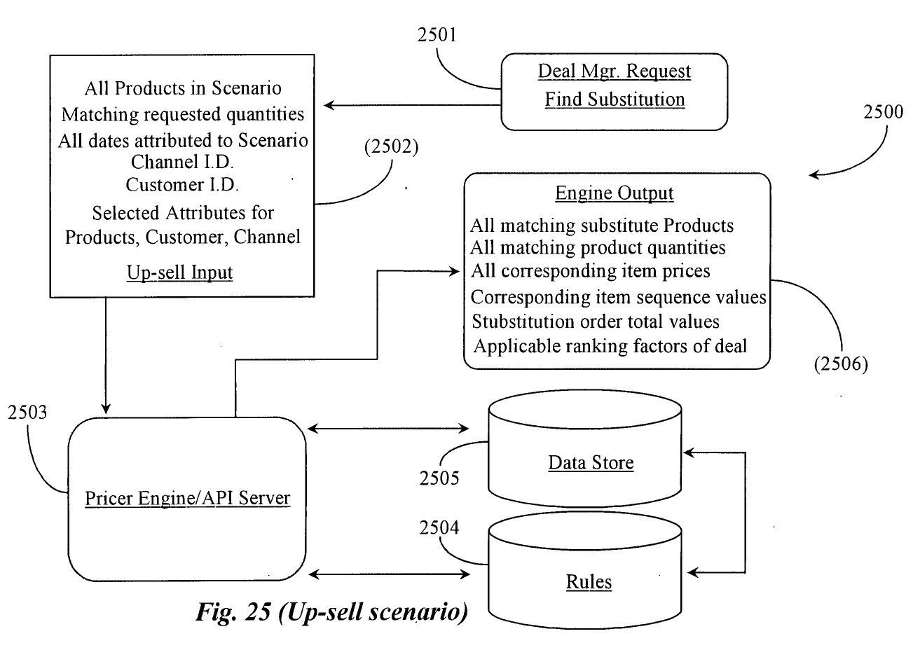

A pricing engine analogous to engine 2503 of FIG. 25 performs the product distribution optimization calculations. The minimum required data input to the engine for product distribution optimization is as follows;

A set of part numbers and their quantities.

A customer.

A channel.

A price factor (ranking factor) on which the goal is based.

A pricing sequence which contains the ranking factor.

Indication of whether to maximize or minimize the goal.

The start date and end date of each period of product distribution.

The minimum and maximum quantities for each period for each item.

The day in the period on which the price calculation is based.

The engine calculates the optimum distribution and provides at least;

The products and re-distributed quantities for each period.

The values (i.e. % of margin) of the factors in the item and order sequence for each period.

When the pricing engine receives the request with action type=MAXIMIZE, it calculates for each part for each period, the value of the ranking factor. Based on whether the goal is to maximize or minimize, the period with the optimal value is determined. If more than one period produced the same value for the ranking factor, the product quantity is evenly distributed among those periods.

In this case, a value information block 4304 is displayed near the top of the larger window area of screen 4300. Bloc 4304 provides cost change data for each considered period the analysis covers. For example, the maximize command based on margin might evaluate the projected cost percentages of providing each product for each covered period. The period having the lowest cost % to the company for providing that product in that period will be the best period for shipping those products. Constraints like minimum and maximum quantities might also be applied so that maximum quantities of parts are distributed to the optimum periods while minimum quantities of what is left over are distribute starting in the least optimum period. As an example assume that a 5 period distribution of a product A must be calculated wherein the overall quantity of A is 20 and the maximum quantity for each period is 5 with no minimum quantity. Also assume that the distribution strategy is based on maximizing profit margin against cost of delivery. If the 5 periods are found to be ranked say from period 1 (most optimum) gradually down to period 5 (least optimum) then the product distribution parameters might look like the following.

Period 1 part number A, quantity 5.

Period 2 part number A, quantity 5.

Period 3 part number A, quantity 5.

Period 4 part number A, quantity 5.

Period 5 part number A, quantity 0.

The engine has placed maximum products into all of the more optimum periods using the maximum quantity constraints thereby avoiding and shipment of product in the least optimum period where the cost would be comparatively highest and the margin therefore comparatively lowest among the periods.

PricerRequestAPI

The maximize command and engine response process are explained using the following pseudo code. One with skill in the art will recognize the process described herein from reading the code.

public void setMaximizerFlag(String flag)

where flag: specifies maximize or minimize

public void setMaximizerFactor(String factorName)

where factorName: an item level factor on which the maximization is based.

public void setEachPeriod(String periodId, Date startDate, Date endDate, Date priceDate)

where periodId : unique id to identify the period. It can be used only in APIs to locate this period.

startDate: beginning date of that specific period

endDate: ending date of that specific period

priceDate: a date in the given period on which the calculations will be based on.

public void setMultiplePeriods(Vector periodIds, Vector startDates, Vector endDates, Vector priceDates)

where periodIds: contains a vector of unique ids to identify the periods.

startDates: contains a vector of start dates.

endDates: contains a vector of end dates.

priceDates: vector of dates on which the calculations will be based on.

An element in a vector should have corresponding values in the same index of the other vectors.

public void setItemMinMaxForPeriod (String periodId, String partNo, String itemPath, String minQty, String maxQty)

where

periodId: unique id of the period defined in the setEachPeriod or setMultiplePeriods API.

partNo: part number of the item

itemPath: item path of the item

minQty: mininum allowed quantity for the item in the period.

maxQty: maximum allowed quantity for the item in the period.

Not specifying values to minQty or maxQty will be considered as no limit for the quantities for the item in the period.

Validations at the API Side

Values of maximizerFlag, maximizerFactor, periodId, startDate, endDate, priceDate and partNo should not be empty.

Start date should not be after the end date.

Period needs to be set before the item min, max are set.

Quantities should not be negative and the max qty should be equal/greater than the min qty.

Items in the periods should exist in the order.

Accumulated minimum quantities of an item over periods should not exceed the quantities specified for that item in the order.

PricerResponseAPI

public Vector getDatesForPeriod(String periodId)

where periodId—Id of a period that uniquely find the period.

returns—a vector contains startDate, endDate and priceDate of the period.

public Hashtable getDatesForAllPeriods( )

returns—a hashtable whose key is period id and the value is a vector contains startDate, endDate and priceDate of the period.

public Vector getItemFactorsForPeriod(String periodId, String partNumber, String itemPath)

where periodId—Id of a period that uniquely find the period.

partNumber—part number of an item

itemPath—item path of the item

returns—a vector of CxPriceAPIFactor object that contains information about the factor name, factor type, from factor name, factor value, and post value of the specified part number.

public Hashtable getItemFactorsForAllPeriods(String partNumber, String itemPath)

where partNumber—part number of an item

itemPath—item path of the item

returns—a hashtable whose key is period id and the value is vector of CxPriceAPIFactor object that contains information about the factor name, factor type, from factor name, factor value, and post value of the specified part number.

public CxPricerAPIFactor getItemFactorForPeriod(String periodId, String partNumber, String itemPath, String facName)

where periodId—Id of a period that uniquely find the period.

partNumber—part number of an item

itemPath—item path of the item

facName—factor name whose value is requested

returns—CxPriceAPIFactor object that contains information about the factor name, factor type, from factor name, factor value, and post value of the specified part number.

public Hashtable getItemFactorForAllPeriods(String partNumber, String itemPath, String facName)

where partNumber—part number of an item

itemPath—item path of the item

facName—factor name whose value is requested.

returns—a hashtable whose key is period id and the value is CxPriceAPIFactor object that contains information about the factor name, factor type, from factor name, factor value, and post value of the specified part number.

public Hashtable getAllItemFactorsForPeriod(String periodId)

where periodId—Id of a period that uniquely find the period.

returns—a hashtable whose key is item path of the part number and the value is a vector of CxPriceAPIFactor object that contains information about the factor name, factor type, from factor name, factor value, and post value of the part number.

### EXAMPLE OF CXPRICERAPIREQUEST

```
<PricerRequest>
    <Action>Maximize</Action>
    <Date>03-28-2003</Date>
    <PricingSchemeName>schemeName</PricingSchemeName>
    <PricerQueryRequest>
      <Channel>
        <ChannelId>SALES_REPRESENTATIVE</ChannelId>
        <ChannelType>Leaf</ChannelType>
      </Channel>
      <Customer>
        <CustomerId>AmeriNet</CustomerId>
        <CustomerType>Leaf</CustomerType>
      </Customer>
      <OrderSequenceId>SimpleOrder</OrderSequenceId>
      <ItemSequenceId>SimpleItem</ItemSequenceId>
      <PriceableItem>
        <PriceableItemId>10.4</PriceableItemId>
        <PriceableItemPath>Products Root:GEMS-
          IT:CLINICAL:CLINICAL_BU:CONFIGURED:DASH
          3000/4000:DASH 3000/4000 BASE MONITOR:DASH
          3000/4000 DISPLAY:10.4</PriceableItemPath>
        <PriceableItemQuantity>50</PriceableItemQuantity>
      </PriceableItem>
      <PriceableItem>
        <PriceableItemId>10.4</PriceableItemId>
        <PriceableItemPath>Products Root:GEMS-
          IT:CLINICAL:CLINICAL_BU:CONFIGURED:DASH
          3000/4000:DASH 3000/4000 BASE MONITOR:DASH
          3000/4000 DISPLAY:10.4</PriceableItemPath>
        <PriceableItemQuantity>40</PriceableItemQuantity>
      </PriceableItem>
      <PriceableItem>
        <PriceableItemId>GERMAN</PriceableItemId>
        <PriceableItemPath>Products Root:GEMS-
          IT:CLINICAL:CLINICAL_BU:CONFIGURED:DASH
          3000/4000:DASH 3000/4000 BASE MONITOR:DASH
          3000/4000 LANGUAGE:GERMAN</PriceableItemPath>
        <PriceableItemQuantity>30</PriceableItemQuantity>
      </PriceableItem>
      <PriceFactor>
        <Name>Ranking Factor</Name>
      </PriceFactor>
      <MaximizerFlag>Maximize</MaximizerFlag>
      <Period>
        <StartDate>Date1</StartDate>
        <EndDate>Date2</EndDate>
        <PriceDate>Date3</PriceDate>
        <priceableItem>
            <PriceableItemId>10.4</PriceableItemId>
            <PriceableItemPath>Products Root:GEMS-
              IT:CLINICAL:CLINICAL_BU:CONFIGURED:DASH
              3000/4000:DASH 3000/4000 BASE MONITOR:DASH
              3000/4000 DISPLAY:10.4</PriceableItemPath>
            <PriceableItemMinQty>1</PriceableItemMinQty>
            <PriceableItemMaxQty>3</PriceableItemMaxQty>
        </priceableItem>
      </Period>
      <Period>
        <StartDate>Date4</StartDate>
        <EndDate>Date5</EndDate>
        <PriceDate>Date3</PriceDate>
      </Period>
      <PriceableItem>
        <PriceableItemId>10.4</PriceableItemId>
        <PriceableItemPath>Products Root:GEMS-
          IT:CLINICAL:CLINICAL_BU:CONFIGURED:DASH
          3000/4000:DASH 3000/4000 BASE MONITOR:DASH
          3000/4000 DISPLAY:10.4</PriceableItemPath>
        <PriceableItemQuantity>10</PriceableItemQuantity>
        <Attribute>
          <Name>Sales Discount</Name>
          <Value>20</Value>
        </Attribute>
      </PriceableItem>
      <PriceableItem>
        <PriceableItemId>GERMAN</PriceableItemId>
        <PriceableItemPath>Products Root:GEMS-
          IT:CLINICAL:CLINICAL_BU:CONFIGURED:DASH
          3000/4000:DASH 3000/4000 BASE MONITOR:DASH
          3000/4000 LANGUAGE:GERMAN</PriceableItemPath>
        <PriceableItemQuantity>1</PriceableItemQuantity>
        <Attribute>
          <Name>Sales Discount</Name>
        <Value>10</Value>
        </Attribute>
        </PriceableItem>
    </PricerQueryRequest>
</PricerRequest>
```

### EXAMPLE OF CXPRICERAPIRESPONSE

```
<PricerResponse>
    <Header>
      <Status>0</Status>
      <OrderLevelErrors />
      <ItemLevelErrors />
    </Header>
    <Quote>
      <Period>
          <StartDate>Date1</StartDate>
          <EndDate>Date2</EndDate>
        <LineItemInfo>
          <Id><![CDATA[ 12FT NORTH AMERICAN ]]></Id>
          <ItemPath>
            <![CDATA[ Products Root:GEMS-
              IT:CLINICAL:CLINICAL_BU:CONFIGURED:DASH
              3000/4000:DASH 3000/4000 BASE MONITOR:DASH
              3000/4000
              POWER CORD:12FT NORTH AMERICAN
              ]]>
          </ItemPath>
          <Qty><![CDATA[ 1 ]]> </Qty>
          <Factor>
          <Name>
            <![CDATA[Global Base Price ]]>
            </Name>
          <PostVal>
            <![CDATA[ 0.00000000 ]]>
            </PostVal>
          </Factor>
          </LineItemInfo>
        <LineItemInfo>
          <Id><![CDATA[ MASIMO ]]> </Id>
          <ItemPath>
            <![CDATA[
          Products Root:GEMS-
            IT:CLINICAL:CLINICAL_BU:CONFIGURED:DASH
            3000/4000:DASH 3000/4000 BASE MONITOR:DASH
            3000/4000 SPO2:MASIMO
            ]]>
          </ItemPath>
      <Qty>
      <![CDATA[ 1 ]]>
        </Qty>
      <Factor>
        <Name>
          <![CDATA[ Global Base Price ]]>
          </Name>
        <PostVal>
          <![CDATA[ 0.00000000 ]]>
          </PostVal>
        </Factor>
      </LineItemInfo>
  </Period>
  <Period>
    |
    |
    |
  </period>
  <Period>
    |
    |
    |
  </period>
  </Quote>
</PricerResponse>
```

In information block 4303 only the products XY server and Clearmark printer are considered for re-distribution. For each period within the analyze period of one year of this three year contact, the Marquee and Meridian systems retain their equal quantities for each period. This could be because all of the periods for these products are ranked the same, or because the products are purposely exempted from consideration to optimize. However, product XY server of which there are a total of 5 requested is distributed exclusively for shipment in the period of May 01, 2003. All of the other periods contain no quantities for shipment, however the maximum quantity constraint for the period May 01, 2003 must be 5 or greater for XY server. The optimum period for shipping the Clearmark printer is in period Apr. 01, 2003. This assumes that the maximum quantity constraint for the printer for that period is equal to or greater than 20 each.

Total pricing information 4305 is provided and lists a total list price for the entire contract at $14,757,045 and lists a total net price after discounts as $14,000,000. An overall profit margin for the contract is displayed as 8%. It is assumed that the optimization performed in this example occurred before the contract was presented. As such a save function illustrated herein as save function 4306 includes a data entry box for entering the name of the new scenario and a save action button for saving the named scenario to a list of scenarios.

In one embodiment, optimization is performed at times while a contract is in force. For example, on a three year contract with multiple products shipped monthly, an agent may want to perform an optimization scenario with respect to product distribution just before each year of the contract begins, or perhaps bi-annually to insure that goals for the enterprise are being met during the periods analyzed.

In one embodiment, a multiple product long-term contract can be optimized per period based on a threshold goal of the client receiving a 2% discount over a major competitor's prices as a condition of continuing business with the enterprise. In this case, each period would be analyzed using the competitor factor as if each separate period were a one-time order. This can be set-up automatically if the current competitor and company pricing structures are updated frequently or on an ongoing basis. If the applicable products and quantities for any period come in at less than 2% below the current competitor prices would have cost the customer then an automated alert would be sent to the agent and the agent would make up the discrepancy by lowering the pricing for that particular period. An alert status bar, not illustrated, is provided at the bottom of the deal manager interface for the purpose.

In another embodiment a customer might agree to continue business on a long-term deal is it is assured that the customer will receive at least a 20% discount off of the current list pricing of the products in each period. In this case each period is recalculated using the pricing that is current on the day of re-calculation. An alert bar at the bottom of the deal manager interface warns an agent when a recalculation of the shippable order per a period works out to a price to the customer, which is less than 20% off of the current list price. When the agent receives the alert, the fixed price can be reduced to make up the difference. The re-calculation and correction would, of course occur before invoicing the customer.

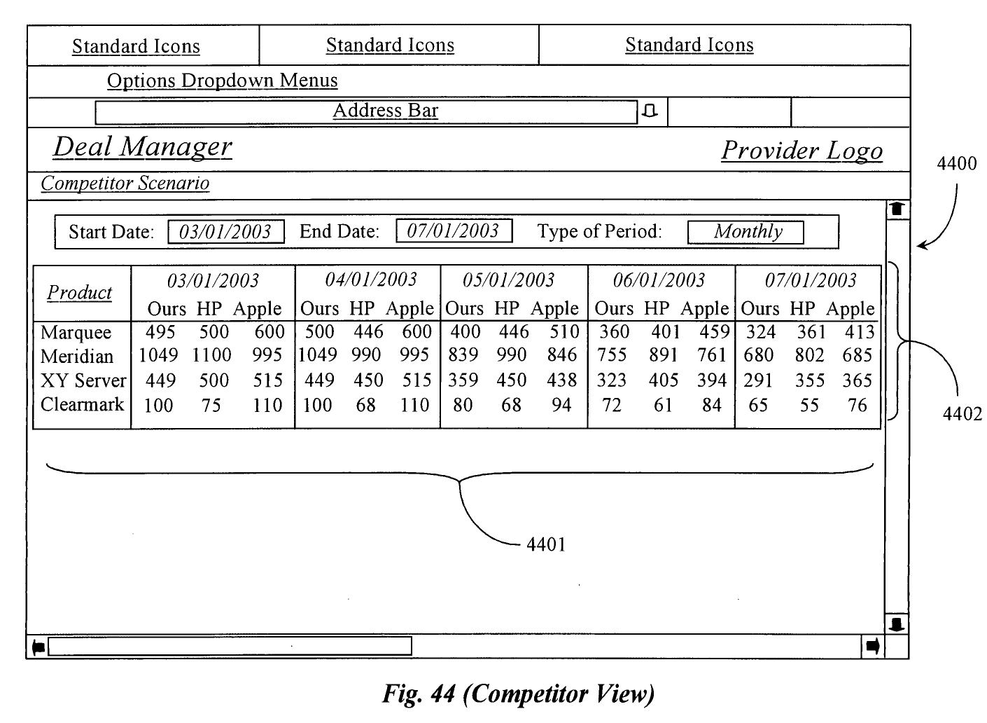

FIG. 44 is a plan view of a screen 4400 illustrating a competitor pricing view 4401 of a portion of a long-term contract. View 4401 comprises monthly period representations from Mar. 01, 2003 to Jul. 01, 2003 that are visible within the immediate screen. A scroll function is provided both horizontally and vertically to enable a user to scroll to any data outside the viewable area. In this case the analysis period is a 7-month period. View 4401 contains rows 4402 for listing the prices associated with the offered product. In this case, the price comparisons are with 2 competitors. Of course if the current time period was period Apr. 01, 2003, then any future pricing parameters are just predicted parameters. Therefore, the real usefulness of this competitor view is in real time as pricing is calculated per period and for historical analysis purposes. Therefore view 4401 is more likely a view when the current time is just before or after Jul. 01, 2003. Periodic real time competitor pricing can be used to insure that the enterprise is remaining competitive over a long term contract whether a customer is aware of the comparison details or not.

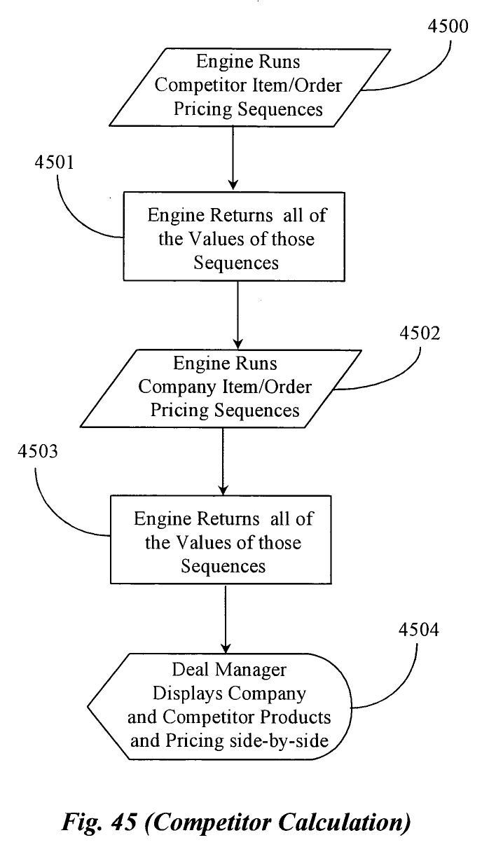

FIG. 45 is a process flow chart illustrating calculation steps for calculating a competitor sequence. At step 4500 a pricing engine analogous to engine 2503 of FIG. 25 runs the competitor item and order sequences based on the competitor list pricing and any known discounts the competitor may be currently offering such as a temporary promotional discount for example. At step 4501, the pricing engine returns all of the values of those sequences for all of the applicable products in the period analyzed based on the information known on the day of calculation.

At step 4502 the pricing engine runs the company item and order sequences for the company offered products of the period, which are the products that the customer is buying during the period. At step 4503 the pricing engine returns all of the values of those sequences. At step 4504 the values are displayed in the deal manager interface side-by-side. That is to say that the agent can see the current company item prices and order totals along side the competitor item prices and order totals. It is noted herein that for a set of items for one shipment period, not all of them may have competitor equivalents. Therefore, order totals that have been calculated using competitor prices will likely also have company items priced along with them. In this way the agent can see what effect on the order totals that any competitor products have. The total discount and margin would be figured as if the company were selling its own item at the current competitor price. The totals can then be compared with the original product order totals. Comparison details can be viewed at a number of different levels.

The deal management interface of the present invention can be used to optimize product distribution strategies based on a number of differing goals. It can be used to optimize up-sell substitution options, cross-sell additions, and to remain competitive in quoting by creating competitor scenarios. Pricing factors (including advisory factors), pricing rules (including advisory rules), attributes, attribute matrices and other pertinent information can be accessed for display through the deal management interface depending on the level of authorization granted the user. The deal manager interface may be integrated with the pricer manager interface as a single application, which presents differing views and capabilities to a logged-in user according to authorization granted. In another embodiment the two applications are separate interfaces but linked together strategically by hyperlink, the applications able to share and synchronize data.

The methods and apparatus of the present invention are in a preferred embodiment Web-based and accessible from remote network locations.

The methods and apparatus should be afforded the broadest possible scope under examination according to the many possible use embodiments. The spirit and scope of the invention should be limited only by the claims that follow.

What is claimed is:

1. In an automated pricing system for calculating pricing for items and item orders, the pricing system having a server node for serving pricing information, a pricing application for calculating the pricing information served, and a data repository for storing at least one pricing data model and rules for manipulating the model, a software application for creating, monitoring, and optimizing deals comprising:
a graphical user interface for accessing and directing the application;
a set of advisory factors having rules and attributes associated thereto;
a set of related calculating sequences for calculating results using at least one of the advisory factors in sequence; and
at least one ranking factor for optimizing results returned by the set of calculating sequences.
characterized in that a user operating through the graphical user interface initiates a set of calculation sequences related by factor to one or more possible options associated with a deal, the calculation sequences cooperating to return a list of data structures for user consideration, the list of data structures ranked according to one or more goal-based attributes.

2. The software application of claim 1 wherein the software interface is accessible through the Internet network using a Web-browsing application.

3. The software application of claim 1 wherein each advisory factor within the set of advisory factors emulates a possible option for optimizing a deal.

4. The software application of claim 1 wherein the set of advisory factors include an up-sell factor, a cross-sell factor, a competitor factor, and a maximize factor.

5. The software application of claim 1 wherein the set of calculation sequences include an item sequence and an order sequence, the item sequence containing an advisory factor and the order sequence containing the at least one ranking factor, which performs the ranking according to a goal-based attribute.

6. The software application of claim 1 wherein the set of calculation sequences include at least one advisory sequence that is not an item or an order sequence.

7. The software application of claim 1 wherein the goal-based attributes for ranking include revenue-based goals, profit margin-based goals, cost-based goals, inventory-based goals, budget-based goals and competitive-based goals.

8. The software application of claim 1 wherein the at least one ranking factor can be set to optimize or minimize according to a goal-based attribute.

9. The software application of claim 1 wherein the returned list of data structures represents possible up-sell product substitution options ranked to maximize revenue or margin for an enterprise.

10. The software application of claim 10 wherein the returned list of data structures include complete item and order pricing information for each substitution option.

11. The software application of claim 1 wherein the ranking factor is used to distribute product quantities over multiple shipping periods of a contract order according to a goal-based attribute.

12. The software application of claim 1 wherein the returned list of data structures represents possible cross-sell product addition options ranked to maximize revenue or margin for the enterprise.

13. The software application of claim 1 wherein the returned list of data structures represents corresponding competitor products and pricing along side of enterprise products and pricing, the data structures ranked according to most competitive products.

14. The software application of claim 1 wherein the returned list of data structures is a product distribution strategy over multiple shipment periods of a contract the distribution strategy ranked by maximizing revenue, margin, or by minimizing cost of provision of the products for each period.

15. The software application of claim 1 wherein the graphical user interface enables displayed side-by-side value comparison of two or more scenarios resulting from one or more factor sequences executed to return data structures, the data structures optionally selected to create the scenarios being compared.

16. The software application of claim 16 wherein the graphical user interface supports request and generation of graphics of the form of graph and chart representations of various compared scenarios.

17. The software application of claim 1 wherein the deals are contracts with multi-shipping periods, which are monitored for one of competitor pricing parameters per shipping period per item having competitor pricing data or monitored for product distribution optimization per item per shipping period, the product distribution strategy ranked according to a goal-based attribute.

18. In an automated pricing system for calculating pricing for items and item orders, the pricing system having a server node for serving pricing information, a pricing application for calculating the pricing information served, and a software application for creating monitoring and optimizing deals, a method for optimizing the parameters of a deal scenario comprising steps of:
(a) through a graphical user interface, highlighting the deal scenario;
(b) through the same interface, activating a deal optimization option from a menu of options provided for the purpose;
(c) executing an advisory factor command as a result of the selection of step (b);
(d) using the correct item and order sequences, calculating at least one separate scenario according to the factor rules; and
(e) displaying the at least one calculated scenario in the graphical user interface for consideration of further options.

19. The method of claim 19 wherein in step (a) the deal scenario has at least the items of the scenario, the prices of the items, the quantities of the items, and the order totals of the scenario.

20. The method of claim 19 wherein in step (a) the graphical user interface is accessible through the Internet network using a Web-browsing application

21. The method of claim 18 wherein in step (a) the deal scenario is one of a one time order or a contract order with complete pricing parameters for item, and order totals including discounts.

22. The method of claim 18 wherein in step (b) the deal optimization options include one of optimizing product distribution, substituting up-sell products, adding cross-sell products, finding bundle products, and finding competitor products and pricing.

23. The method of claim 18 wherein in step (c) the advisory factor is one of an up-sell factor, a cross-sell factor, a competitor factor, or a maximize factor.

24. The method of claim 18 wherein in step (c) the advisory factor is contained in the associated item sequence and returns results that are ranked by a ranking factor used in the associated order sequence.

25. The method of claim 18 wherein in step (c) the advisory factor is used in it's own advisory sequence containing only advisory factors.

26. The method of claim 18 wherein in step (d) the separate scenario is the highest ranked of more than one scenario returned from calculation.

27. The method of claim 18 wherein in step (d) the correct item and order sequences are defined for item as the one containing the advisory factor and for order as the one containing the ranking factor.

28. The method of claim 18 wherein in step (c) the advisory factor is up-sell and in step (d) the calculated scenarios represent different scenarios of up-sell possibilities.

29. The method of claim 18 wherein in step (c) the advisory factor is cross-sell and in step (d) the calculated scenarios represent different scenarios of cross-sell possibilities.

30. The method of claim 18 wherein in step (c) the advisory factor is competitor and in step (d) the calculated scenarios represent the original scenario using applicable competitor products and pricing.

31. The method of claim 18 wherein in step (c) the advisory factor is maximize and in step (d) the calculated scenarios represent product distribution strategies over multiple shipping periods.

32. The method of claim 18 wherein in step (d) a ranking factor is included in the order sequence, the ranking factor for ranking results according to a specified goal-based parameter.

33. The method of claim 18 wherein in step (e) further options include product editing, discount editing, final editing and saw scenario.
